(19) United States
(12) Patent Application Publication
(10) Pub. No.: US 2014/0114838 A1
(43) Pub. Date: Apr. 24, 2014

(54) FINANCE UTILITY SYSTEM AND METHOD

(71) Applicant: THE BANK OF NEW YORK MELLON, New York, NY (US)

(72) Inventors: Antonio A. NUNES, New York, NY (US); Steven C. TROMBETTA, New York, NY (US); Corrie WAGNER, New York, NY (US); Douglas J. MACINNES, New York, NY (US); Joseph DELLER, New York, NY (US)

(73) Assignee: THE BANK OF NEW YORK MELLON, New York, NY (US)

(21) Appl. No.: 14/057,787

(22) Filed: Oct. 18, 2013

Related U.S. Application Data
(60) Provisional application No. 61/716,336, filed on Oct. 19, 2012.
(60) Provisional application No. 61/852,018, filed on Mar. 15, 2013.

(51) Int. Cl. G06Q 40/02

(52) U.S. Cl. CPC G06Q 40/025
USPC 705/38

(57) ABSTRACT

A method of tracking loans on behalf of a client of a financial services provider is implemented in a system comprising processor(s) configured to execute program module(s). The method includes storing, in a database, first loan data being received from the client and comprising custodian information identifying custodian(s) associated with a loan of the client, receiving a request from the client to reconcile loan data as of a designated date, and storing, in the database, second loan data being received from the custodian(s) and identifying loan(s) associated with the client and the designated date. The method also includes comparing the first and second loan data, and identifying any discrepancies from the comparing. The method further includes transmitting, in a format configured for displaying on an electronic display of one or more of the client and custodian(s), one or more of a result of the comparing and an identified discrepancy.

This application claims the benefit of U.S. Provisional Patent Application Ser. No. 61/716,336, filed on Oct. 19, 2012, and U.S. Provisional Patent Application Ser. No. 61/852,018, filed on Mar. 15, 2013, each of which is incorporated herein in its entirety by reference.

### BACKGROUND

This disclosure relates to a computerized system and method for providing comprehensive data management and analysis of market financing.

The current industry of market financing suffers from a number of limitations, which have drawbacks that may filter through to the housing and financial markets as a whole. While some of these limitations are related to the broader economy (e.g., related to the U.S. subprime mortgage crisis and the global economic crisis), others are more localized to the market financing industry, and may be associated with a lack of fluid access to market information. For example, perhaps as a response to the global economic crisis, there has been a concentration of market participation, with few key market participants. This has resulted in market stagnation, and a growth in government sponsored enterprises (GSEs). Additionally, there have been an unprecedented number of loan buyback requests in recent times, leading to resolution stalemates, and negative mark-to-market valuation, detrimental to investors and issuers.

Other issues in the present market finance industry include, for example, issues relating to lack of access to market information. For example, in present market financing solutions, difficulties in obtaining lien perfection information may lead to borrower confusion as well as foreclosure system delays. Additionally, an inability to access collateral and potential collateral associated with deals may promote a general unwillingness to invest (e.g., because potential investors would not want to deal with buyback requests, and similar remedial actions), and may result in an inability to verify representations and warrants associated with the deals. Further, a lack of industry standard documentation may result in investor confusion and inconsistencies across PSAs.

Among other things, the present disclosure provides improved computerized mechanisms ensure efficient access to market finance information.

### SUMMARY

This disclosure provides various embodiments and aspects of a system and method for supporting asset lifecycles in financial markets. Although in some embodiments the assets may be housing (e.g., providing a housing finance market utility), this disclosure may be applied to other asset classes. For example, the asset classes could be extended from housing (i.e., residential markets) to commercial markets. As such, the assets might include apartment buildings, condominiums, townhouse communities, retail locations, office space, and/or mixed usage. The asset classes could also move away from real estate into more diverse fields, such as but not limited to student loans, asset backed credit cards, and auto loans.

In an embodiment, a computer-implemented method of tracking loans on behalf of a client of a financial services provider is implemented in a computer system of the financial services provider comprising one or more physical computer processors configured to execute one or more computer program modules. The method includes storing, in a database associated with a memory device, first loan data, the first loan data being received from the client and comprising custodian information identifying one or more custodians associated with a loan of the client. The method also includes receiving, via the one or more physical computer processors, a request from the client to reconcile loan data as of a designated date. The method also includes storing, in the database associated with the memory device, second loan data, the second loan data being received from the one or more custodians and identifying one or more loans associated with the client and the designated date. The method additionally includes comparing, via the one or more physical computer processors, the first loan data and the second loan data, and identifying, via the one or more physical computer processors, any discrepancies from the comparing. The method further includes transmitting, via the one or more physical computer processors, in a format configured for displaying on an electronic display of one or more of the client and the one or more custodians, one or more of a result of the comparing and an identified discrepancy from the comparing.

According to another embodiment, a system for tracking loans on behalf of a client of a financial services provider includes one or more physical computer processors, at the financial services provider, the one or more physical computer processors configured to execute one or more computer program modules. The program modules are configured to store, in a database associated with a memory device, first loan data, the first loan data being received from the client and comprising custodian information identifying one or more custodians associated with a loan of the client. The program modules are also configured to receive, via the one or more physical computer processors, a request from the client to reconcile loan data as of a designated date. The program modules are also configured to store, in the database associated with the memory device, second loan data, the second loan data being received from the one or more custodians and identifying one or more loans associated with the client and the designated date. The program modules are additionally configured to execute, on the one or more physical computer processors of the computer system, one or more computer modules configured to compare, via the one or more physical computer processors, the first loan data and the second loan data, and identify, via the one or more physical computer processors, any discrepancies from the comparing. The program modules are further configured to transmit, via the one or more physical computer processors, in a format configured for displaying on an electronic display of one or more of the client and the one or more custodians, one or more of a result of the comparing and an identified discrepancy from the comparing.

The system and method of this disclosure further provides various capabilities as discussed more fully in the detailed description below.

### BRIEF DESCRIPTION OF THE DRAWINGS

Embodiments of the disclosure will now be described with reference to the accompanying drawings in which:

FIG. 1 schematically illustrates an infrastructure for a mortgage market operating model of the present disclosure;

FIGS. 2-14 illustrate exemplary views of a graphical user interface (GUI) accessible by issuers in the infrastructure of FIG. 1 utilizing a utility system associated therewith;

FIGS. 15-37 illustrate exemplary views of the GUI available to an investor in the infrastructure of FIG. 1, allowing the investor to monitor and provide oversight into their portfolio and the investments therein;

FIGS. 38-45 illustrate exemplary views of the GUI available to an investor representative in the infrastructure of FIG. 1;

FIGS. 46-56 illustrate exemplary views of the GUI available to a transparency agent in the infrastructure of FIG. 1;

FIGS. 57-61 illustrate exemplary views of the GUI available to a custodian in the infrastructure of FIG. 1;

FIGS. 62-70 illustrate exemplary views of the GUI available to an issuer in the infrastructure of FIG. 1 in some embodiments;

FIG. 71 illustrates an exemplary flowchart illustrating an embodiment of a method of tracking a variety of loans on behalf of a client;

FIG. 72 illustrates an exemplary view of a GUI available to an administrator at a financial services provider associated with the method of tracking the loans of FIG. 71;

FIGS. 73A-73B illustrate exemplary views of the GUI available to a client of the financial services provider associated with the method of tracking the loans of FIG. 71;

FIGS. 74A-74B illustrate exemplary views of the GUI available to a custodian of the loans associated with the method of tracking the loans of FIG. 71;

FIG. 75 illustrates a high level block diagram of an exemplary computer system which may be used to perform embodiments of the processes disclosed herein; and

FIG. 76 illustrates an embodiment of a networked computer system which may be used to perform embodiments of the processes disclosed herein.

### DETAILED DESCRIPTION

The market service system and method described herein may be implemented by a system that includes various physical computer processors and peripheral devices, such as memory devices, databases, and network interfaces, including the Internet.

As discussed in greater detail below, it may be appreciated that the solutions described herein may provide services to various participants throughout the asset lifecycle associated with a finance market. For example, an infrastructure may be established to support processes associated with origination through servicing, securitization of a security, and how a security has been managed as an asset after being purchased by a buy-side investor. It may be understood that a new infrastructure may fill in the gaps of a fragmented existing infrastructure (e.g., one that grew over time, initially from GSEs, before moving into the private mortgage securities market). Utilities implementing such solutions may attract private investment and private equity investors (buy-side investors). While the solutions described herein are with reference to mortgage backed security (MBS) asset classes, and in particular, those in the residential sector, it is understood that the solutions could be extended to commercial properties, as well as other asset classes, including but not limited to student loans, asset backed credit cards, auto loans, and other loan types. Among other goals of such solutions, it may it may be desirable to ease entry into the market to attract new originators, issuers, or investors. For example, data normalization and transparency may establish accountability based on the role that parties play in the asset lifecycle. Transparency may extended both to the users of such solutions (e.g., tracking the actions users of the infrastructure take, and how data is being accessed) as well as to the assets themselves (e.g., reporting the underlying collateral's performance and characteristics). As such, clear definitions of the rules defining the roles of users of the infrastructure may facilitate connectivity between participants in establishing a deal and resolving contingencies.

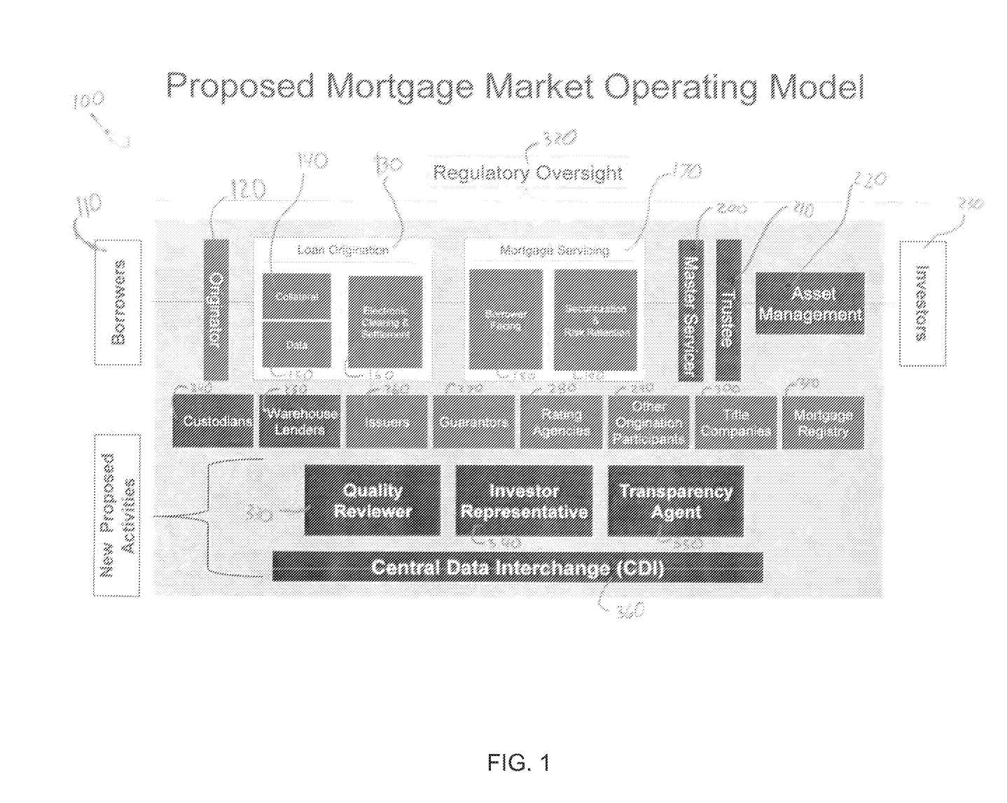

FIG. 1 outlines a mortgage market infrastructure 100, showing various entities engaged therewith through various regions of a loan and asset lifecycle. Specifically, in an embodiment borrowers 110, acting through an originator 120, may proceed through the process of loan origination 130. Such origination 130 may entail analysis of collateral 140 and application of document and data standards 150, as well as performance of electronic clearing and settlement 160. Once the mortgage issues, mortgage servicing 170 may be performed, including, for example, borrower-facing 180 and securitization and risk retention 190. As such, mortgage servicing 170 may include collateralization and allocation management. In some embodiments, the mortgage servicing 170 may be overseen by a master servicer 200 who may act in conjunction with a trustee 210. Specifically, it should be appreciated that a loan originated by an issuer can be serviced in-house, but the master servicer role, which provides oversight and ensures that servicing standards are being met, may be best executed by an independent third party. The trustee 210 may in turn be coordinating with an asset manager 220 who engages with investors 230. It may be appreciated that the investors 230 may be any individual or conglomerate investors, including, for example, asset managers or private equity firms, insurance companies, or real estate investment trusts. In some embodiments, each investor 230 may be a plurality of investors in a joint venture.

Other participants may variously play roles in the loan and asset lifecycle. For example, custodians 240, warehouse lenders 250, issuers 260, guarantors 270, rating agencies 280, other origination participants 290, title companies 300, and mortgage registrars 310 may each support the origination 130, servicing 170, and/or other features within the infrastructure 100. It may be appreciated that a regulatory entity 320 may engage in regulatory oversight of all aspects of the market infrastructure 100, including the participants therein.

To facilitate implementation of an updated infrastructure, and to solve some of the issues in the industry discussed above, infrastructure 100 may include access for entities in a number of new roles. It may be appreciated that the new roles may ensure clear accountability and independence within the transaction, in alignment with the investor's interests. As shown, a quality reviewer 330 may be available to review individual loans and verify compliance to established protocols (e.g., those in deal documentation). In some embodiments, the quality reviewer 330 may be unaffiliated with the originator 120. In reviewing the loans, the quality reviewer 330 may identify exceptions to established guidelines to allow the loan to proceed to approval. For example, the quality reviewer 330 may perform on going assessment of each loan, pulling in current information on factors such as credit score drift and additional liens on the property. In an embodiment, the quality reviewer 330 may perform ongoing analysis of assets and borrower trends, utilizing current market information (such as credit scores and property values). While in some embodiments the quality reviewer 330 may perform a limited review (e.g., automated data checks), in other embodiments the quality reviewer 330 may perform a more comprehensive review, including but not limited to re-underwriting individual loan files. The quality reviewer 330 may identify and investigate assets that do not appear to meet the set criteria (both prior to and following securitization) and may ensure that as the borrower 110's conditions fluctuate, current data is obtained to inform the investors 230. In some embodiments, the quality reviewer 330 may cooperate with the originator 120 in the loan origination 130, and may engage with the custodians 240, warehouse lenders 250, and issuers 260. It may be appreciated that the quality reviewer 330 may provide upfront valuation of loan attributes, which may reduce requests for buybacks later in the asset lifecycle. As an example, quality review by the quality reviewer 330 may identify where collateral does not match that which what was represented, so that the collateral may be removed prior to the deal closing.

In an embodiment, an investor representative 340 may enforce standards in a prescribed resolution process. For example, the investor representative 340 may act as an agent for the investors 230, enforcing repurchase obligations across documented courses of action. Besides for engaging with the investors 230, the investor representative 340 may also coordinate with the originator 120, custodians 240, issuers 260, and asset manager 220 to resolve a number of disputes, including but not limited to those pertaining to the mortgage servicing 170 (e.g., the borrower facing 180 and securitization and risk retention 190). It may be appreciated, however, that the investor representative 340 would be an independent entity separate from the originator 120 and the master servicer 200, so as to properly fulfill the representative role for the investors 230. In an embodiment, if issues regarding the collateral arise, then the investor representative 340 may guide the investors 230 by reviewing the associated loans, and raise the issues to the responsible parties. The investor representative 340 may further guide the investors 230 through the pre-defined courses of action for dispute resolution (including, for example, arbitration) to ensure resolution is met, and prevent stalemates.

Further, a transparency agent 350 may be an independent entity who may provide portfolio and program level trend reporting (e.g., customizable reporting based on loan-level information throughout the asset lifecycle), as described in greater detail below. In an embodiment, the transparency agent 350 may act as a data aggregator from various sources, gathering information across the deal elements, including the quality review, the monthly collateral performance, monthly payment information, and current market data, and may create actionable information based thereon. In an embodiment, the transparency agent 350 may create scorecards and/or trend analysis based on predefined rules and/or risk metrics across a portfolio of securities and/or loans. It may be appreciated that the transparency agent 350 may support the issuers 260, the investors 230, and the asset manager 220, as well as the quality reviewer 330 and the investor representative 340. Indeed, the quality reviewer 330, the investor representative, 340, and the transparency agent 350 may work together in ensuring that transparency and responsiveness of the infrastructure 100 is met.

It may be appreciated that the cooperation of the new participants (e.g., the investor representative 340 and the transparency agent 350) with the issuers 260 may be facilitated by a uniform issuance platform having consistent standards by private market participants and GSEs. In some embodiments, the standards established by GSEs may establish a baseline set of standards that could be deployed in the private market.

In an embodiment, a utility component coupled to a central data interchange (CDI) 360 may be implemented to support the infrastructure 100, including, for example, the uniform issuance platform. The utility may be configured to support various functions of the infrastructure 100, including but not limited to the loan origination 130 and the mortgage servicing 170, and may be implemented on one or more physical computer processors associated with the infrastructure 100. It may be appreciated that the utility and the CDI 360 may be operated on or over any type of computerized or electronic medium, including but not limited to dedicated hardware, a personal computer, a mainframe computer, a rack mounted server, a server, a workstation, or so on. The computerized or electronic medium associated with the infrastructure 100 may include one or more physical processors, and one or more physical memory devices, which may contain or link to one or more databases. In an embodiment, the computerized or electronic medium may utilize multi-processor configurations which, with proper programming, may be useful to improve processing speed.

In an embodiment, the utility may be configured to facilitate issuing securities to depositaries and supporting payment to depositories. The CDI 360 may be configured to provide a central data repository for loan level data, and may provide for storage of loan documents. In an embodiment, the CDI 360 may facilitate transfer of information regarding the asset life cycle to one or more of the participants, as well as assist those participants in performance of their roles (e.g., by supporting issuance and administration of securities). In an embodiment, the CDI 360 may offer a source for tracking asset ownership throughout a loan lifecycle. In some embodiments, the CDI 360 may facilitate access to lien perfection information, including tracking of such information. Additionally, the CDI 360 may be configured to support electronic clearing and settlement of e-mortgages. In an embodiment, the CDI 360 may be configured to receive, transmit, and transform data associated with the infrastructure 100.

In an embodiment, the CDI 360 may be configured to receive data from the participants in the infrastructure 100, aggregate it, and allow participants to access the data relating to their transactions. As such, implementing the CDI 360 may comprise standardizing data formats associated with the participants in the infrastructure 100. Implementation may also comprise performing quality analysis that verifies that a loan passes a standardized verification of attributes. The validation may be performed electronically, and may focus on confirming factors such as owner-occupancy and assets held. The validation may be established at loan origination, and may be refreshed throughout the lifecycle. If the validation is not indicated associated with the loan at any point in time during the lifecycle, closer scrutiny of the asset may be performed during processing of the asset. As described below, quality ratings and scores may be applied to the assets and associated securities, which may be impacted by the validation of the assets. In some embodiments, the validation at the CDI 360 may be tied to a tracking number or other identifier. For example, the Conference of State Bank Supervisors is expanding originator tracking via the Nationwide Mortgage Licensing System & Registry (NMLS) to include all individuals who are mortgage brokers, enabling each mortgage origination to be traced back to the individual loan. The NMLS tracking number identifies the broker involved, but does not track back to underlying information about the mortgage profile or other participants. In some embodiments, the CDI 360 could augment this by including additional identifying information about the loan, the other parties involved in its origination, and the loan's characteristics.

While the CDI 360 may vary across embodiments, in an embodiment the CDI 360 may be coupled to one or more memory devices. In some embodiments the one or more memory devices may be known types of solid-state memory, such as dynamic random access memory (DRAM) or flash memory, which stores information such as that formatted for storage in the one or more databases. The memory device(s) may be backed up by known redundant storage media, e.g., hard disk drives, solid state drives, optical media, tape media, or so on. In an embodiment, the one or more databases may include a structured database, which may be implemented, for example, as a Structured Query Language (SQL) database or other type of known database format that is compatible or desired to be used with the particular software programming approach used to implement the utility and/or the CDI 360. The database may form a central data repository for the infrastructure 100. A front end user interface for the utility, and a back end data management and analysis component, may utilize any appropriate programmatic language and/or markup language, including but not limited to Java, BASIC (or variants), C (or variants), extended markup language (XML), hypertext markup language (HTML), or combinations thereof.

In an embodiment the systems associated with the utility and the CDI 360 may utilize appropriate computer network interfaces using, for example, the Internet and TCP/IP communication protocols, or through a private network. In an embodiment, the utility and the CDI 360 may be configured to protect non-public personal information (NPPI), to prevent access by unauthorized parties and ensure the privacy and security of electronic data exchanged across the infrastructure 100. Such precautions may be taken in any number of known ways, including for example, security protocols based on Transport Layer Security (TLS), Secure Sockets Layer (SSL), or other data encryption mechanisms, such as Pretty Good Privacy (PGP), for example. As described in greater detail below, in some embodiments participants accessing the utility may utilize a graphical user interface, such as a web browser interface, for receiving and displaying data transmitted over the infrastructure 100. Such an interface may be implemented by any number of conventional input/output and/or display devices, including but not limited to a mouse, keyboard, touch screen, and so on. In an embodiment, a login screen may utilize user name and password identification, or other appropriate identifiers, to ascertain the role of a user, and their identity. It may be appreciated that by utilizing the CDI 360 as a central source of information about transactions, potential investors 230 may have access to the collateral details associated with available deals and their own portfolios, which may spur their decisions to invest in the deals, and bring private capital back into the market. In some embodiments, services not associated with a particular user may be obscured from the user interface, such that participants utilizing the utility may view only those services that they have access to.

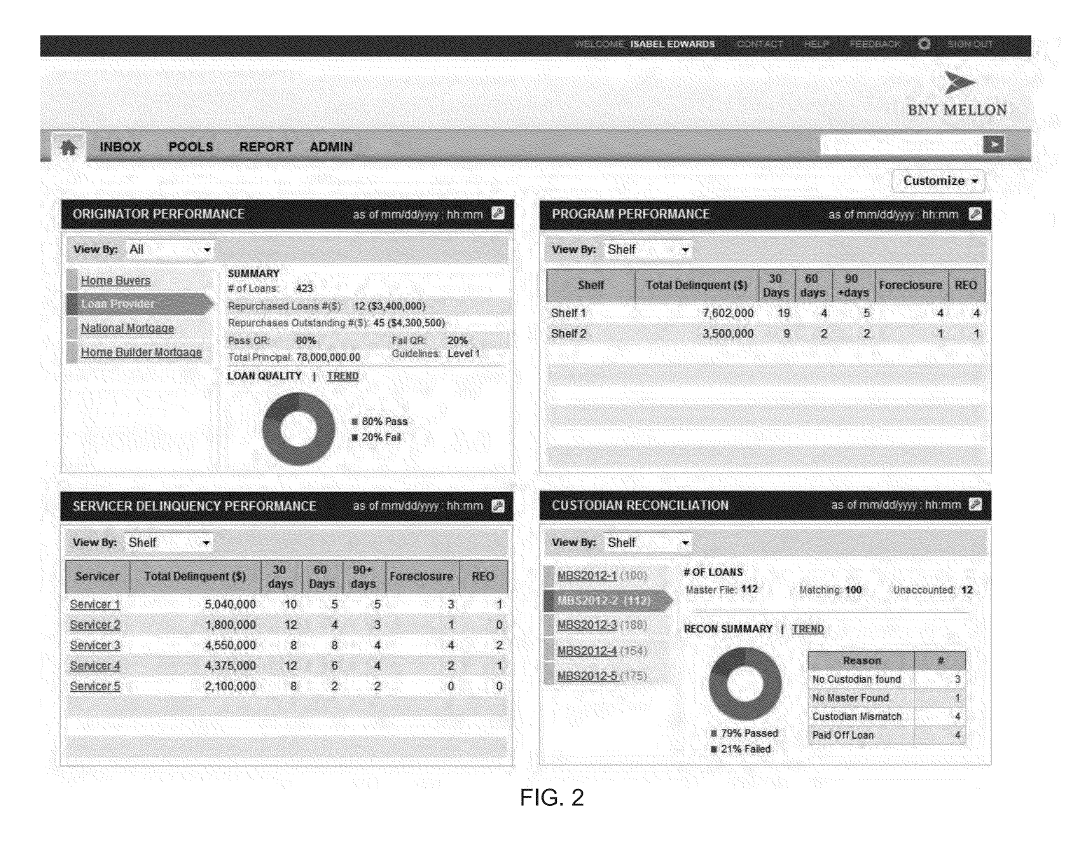

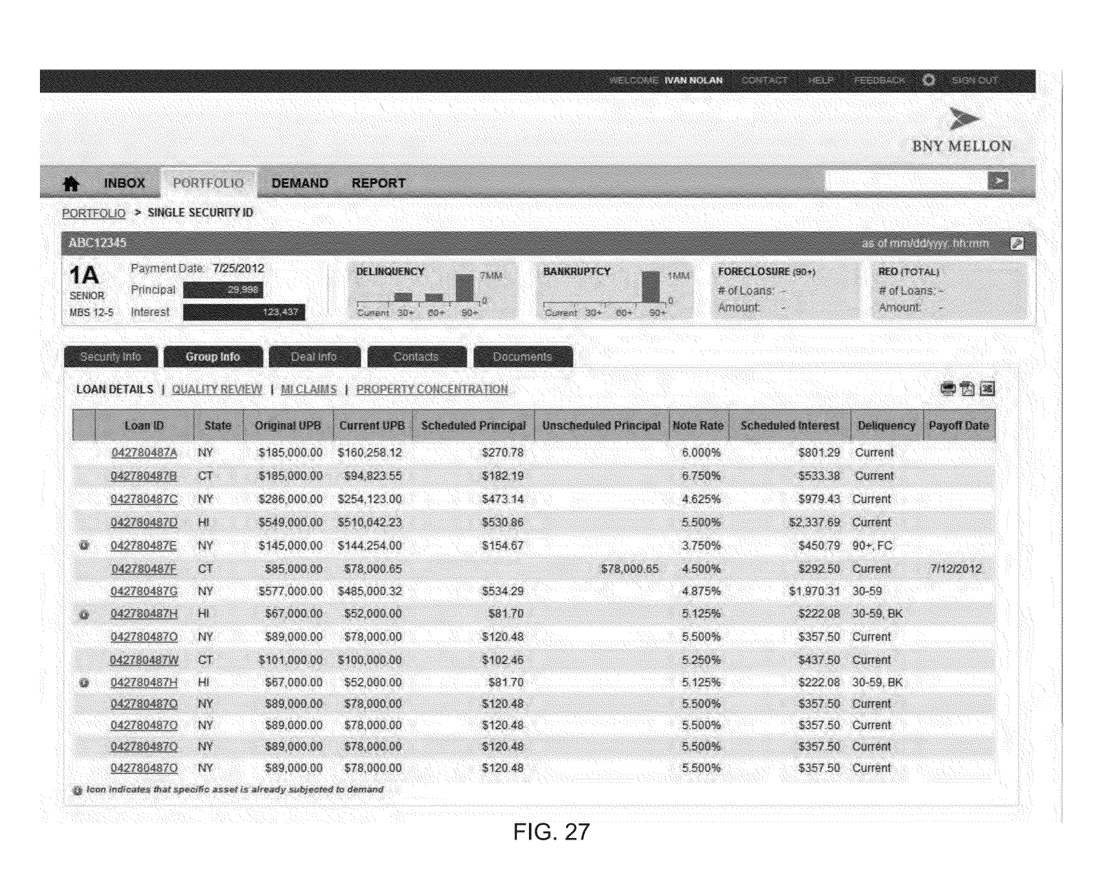

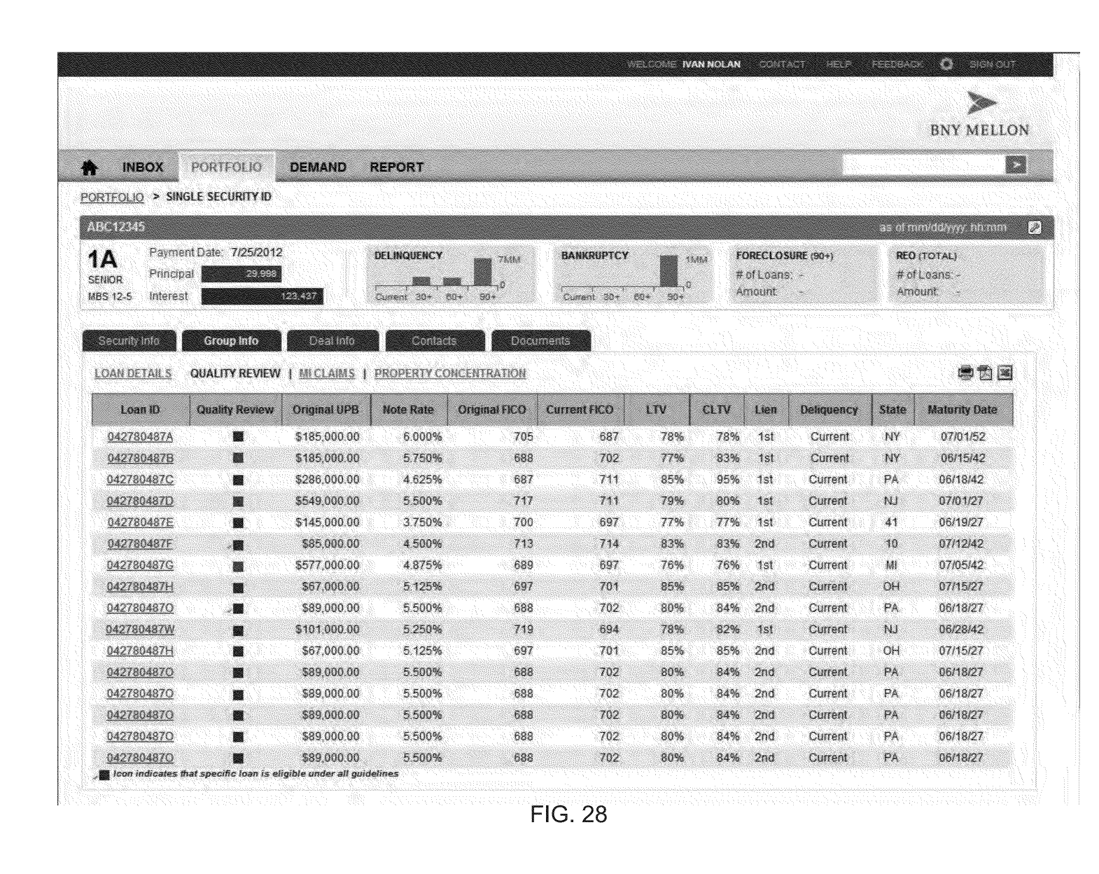

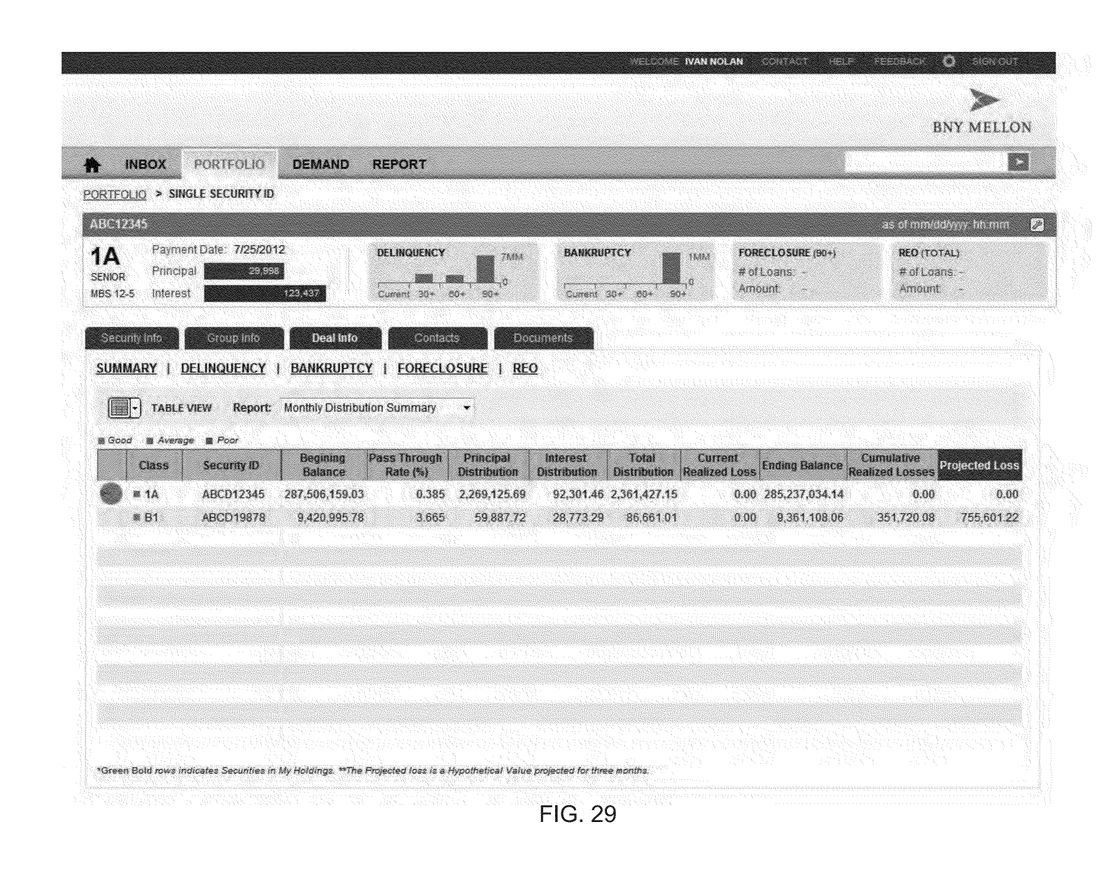

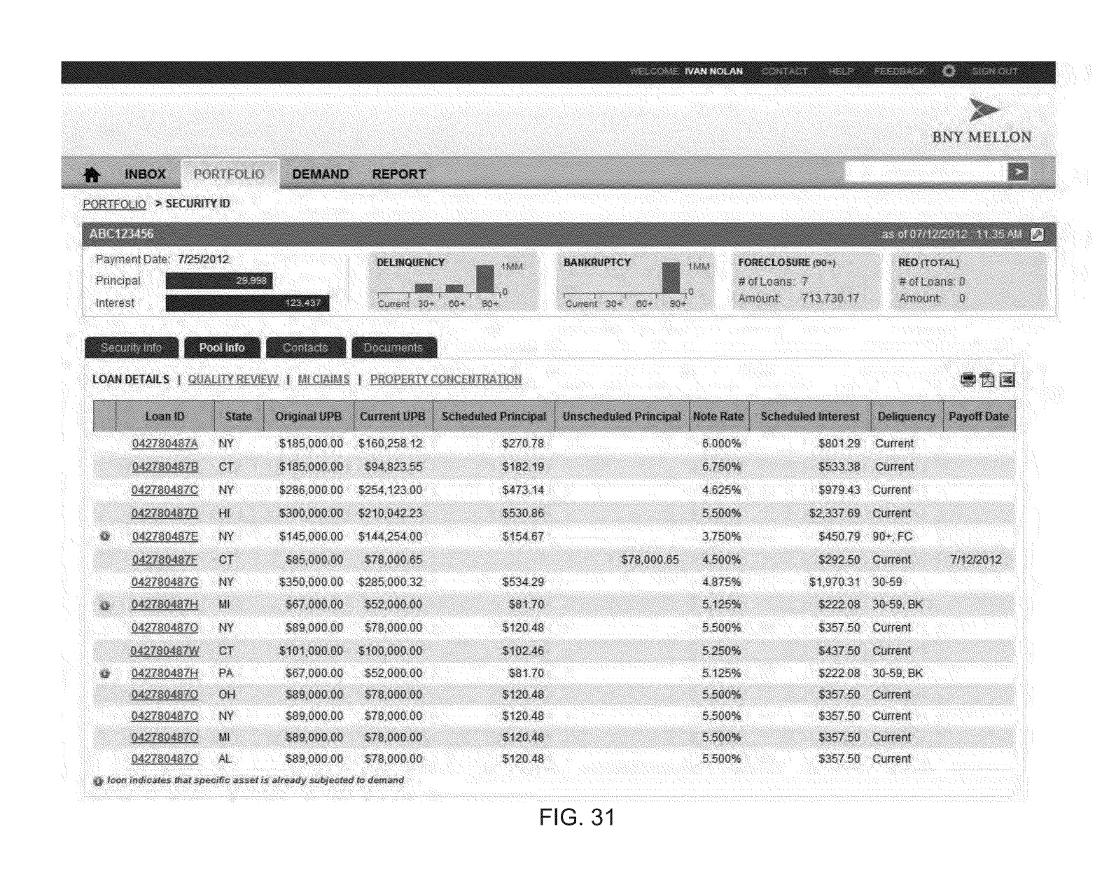

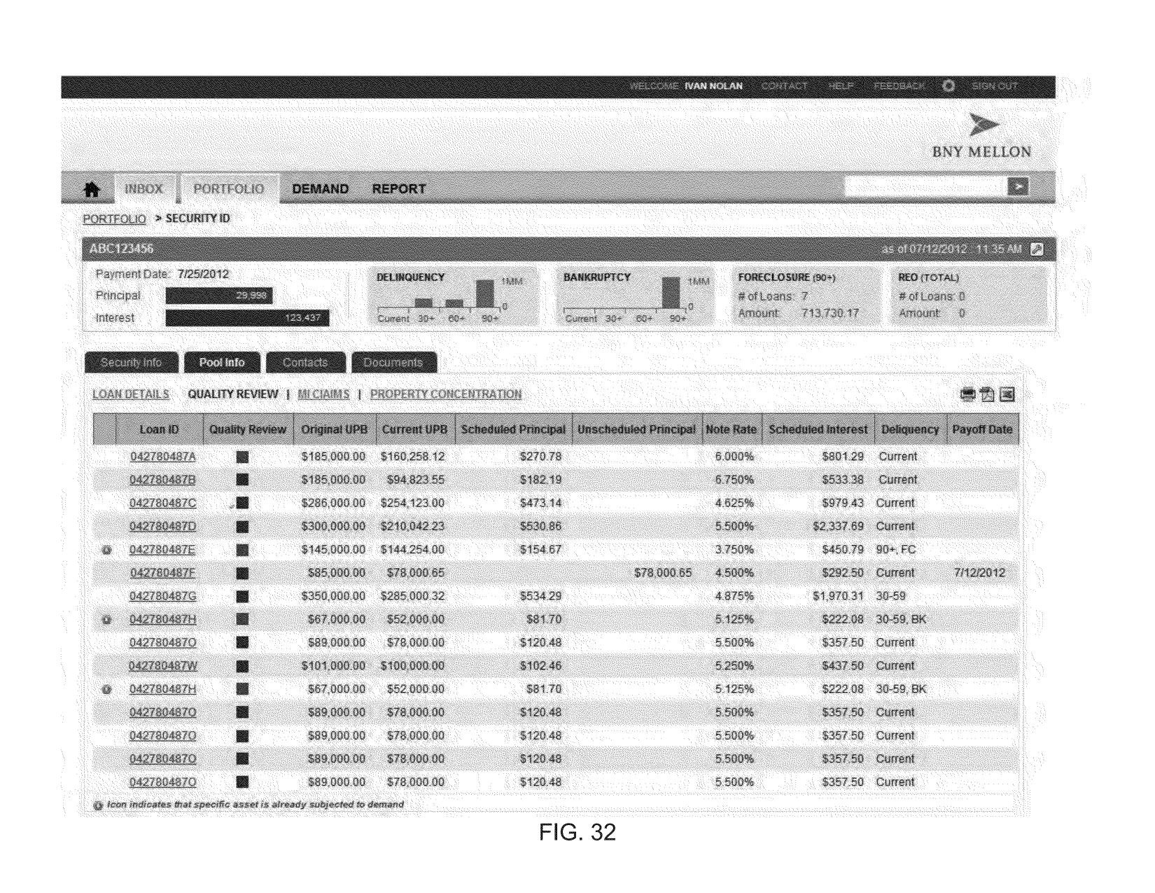

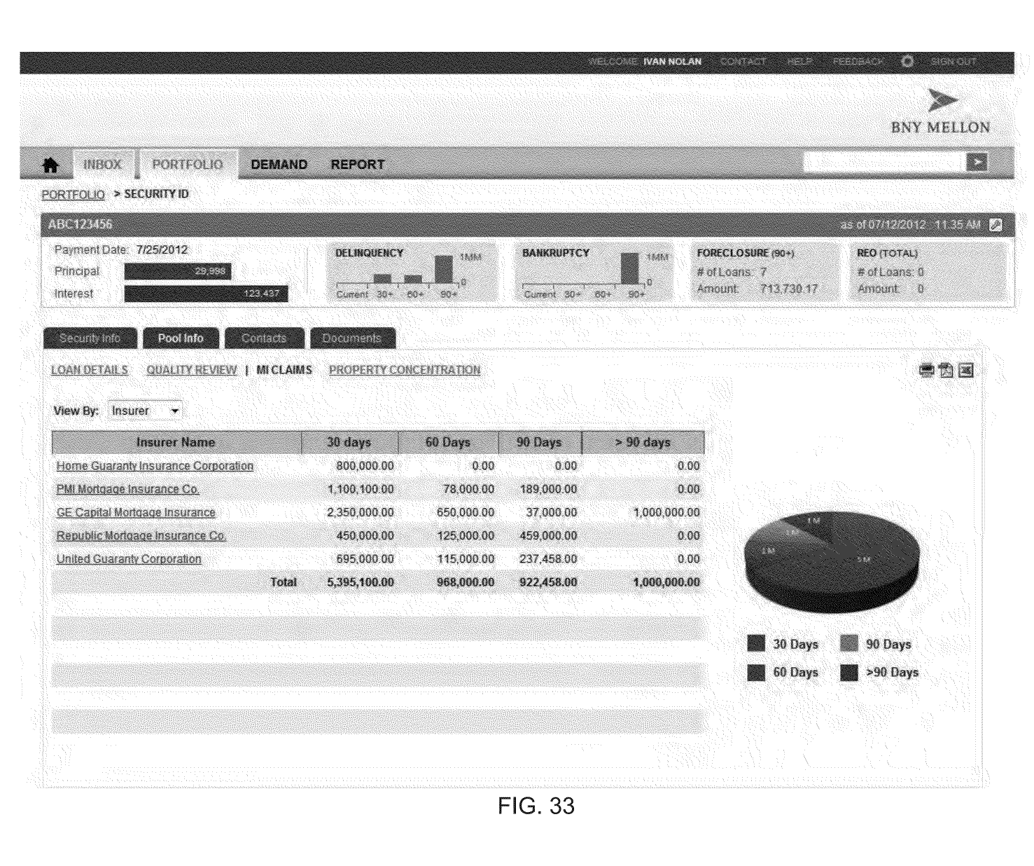

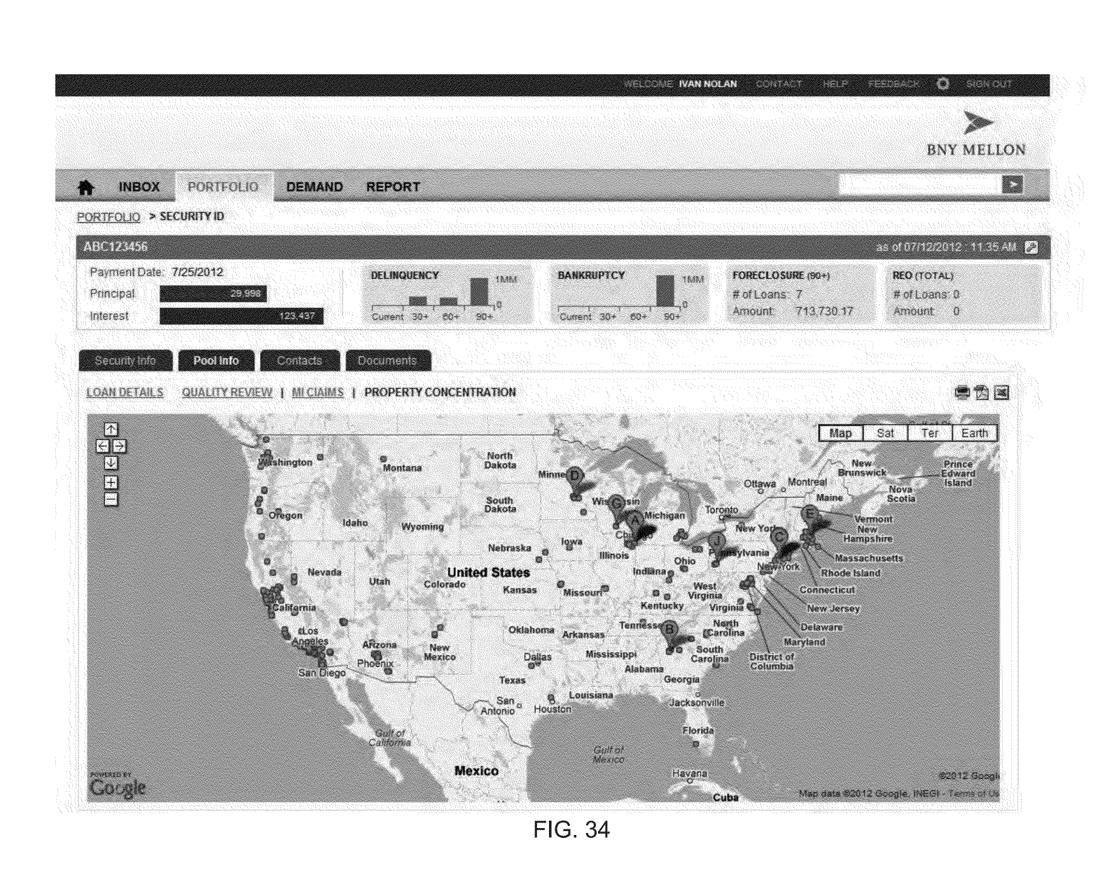

As noted above, in some embodiments the utility may comprise a graphical user interface provided over a computer terminal. FIGS. 2-56 depict various aspects of an embodiment of the graphical user interface, for several disparate user classes. These screens are not necessarily intended to convey precise information or formats of information available through the utility, but are merely representative of the types of displays and information presented therein that may be made available to system users. In an embodiment where the graphical user interface is presented over the interne, the graphical user interface may be generated by any suitable mechanism, including but not limited to via HTML, XML, Microsoft® SharePoint®, Adobe® Flash®, and combinations thereof. As shown, data may be presented both as text and graphically, and may make use of overlays and hotlinks to move between information displays and trigger computations associated with back end processing.

FIGS. 2-14 illustrate potential displays that may be associated with issuers 260, for example. Issuing entities such as issuers 260 may issue securities to depositories, and may desire information regarding their issuance portfolio. The issuer 260 may implement oversight of the originator 120 and the loan origination 130, as well as the master servicer 200 and the mortgage servicing 170. Specifically, the issuer 260 may desire tracking origination performance over time, as well as servicer performance associated with the securities issued by the issuer 260. Further, the issuer 260 may manage communications with the investor representative 340 on disputed loans. The issuer 260 may pool loans to create the base for security issuance. The issuer 260 may also utilize performance and risk metrics provided by the transparency agent 350, as well as cooperate with the investor representative 340 to track outstanding repurchase requests.

FIG. 2 illustrates a dashboard for the issuer 260, which may summarize key information at a higher level, so that senior level workers can know key activities being undertaken in their area. For example, in the illustrated embodiment the dashboard illustrates originator performance, program performance, servicer delinquency performance, and custodian reconciliation details. In an embodiment, each performance metric may be viewed at the shelf, warehouse, wholesale, or retail level, or combined. In an embodiment, the dashboard may serve as a home page, which may be accessed from any page of the utility GUI (e.g., by clicking on the home image).

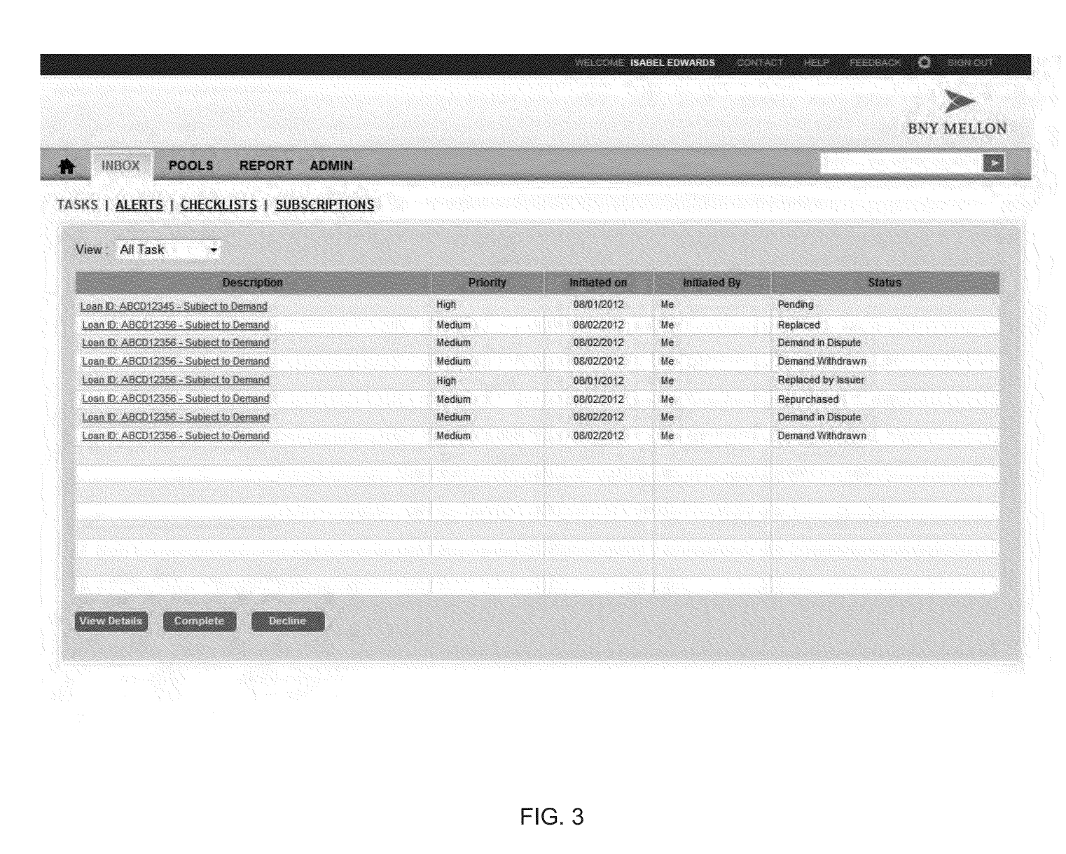

The issuer 260 may have access to an inbox, illustrated in FIG. 3, showing associated tasks, which may be filtered by showing all tasks, or only those initiated by the issuer 260. The priority of each task, as well as the current status may also be indicated. It may be appreciated that the inbox may be accessed by clicking “Inbox” on any page of the utility's GUI (including from the homepage dashboard).

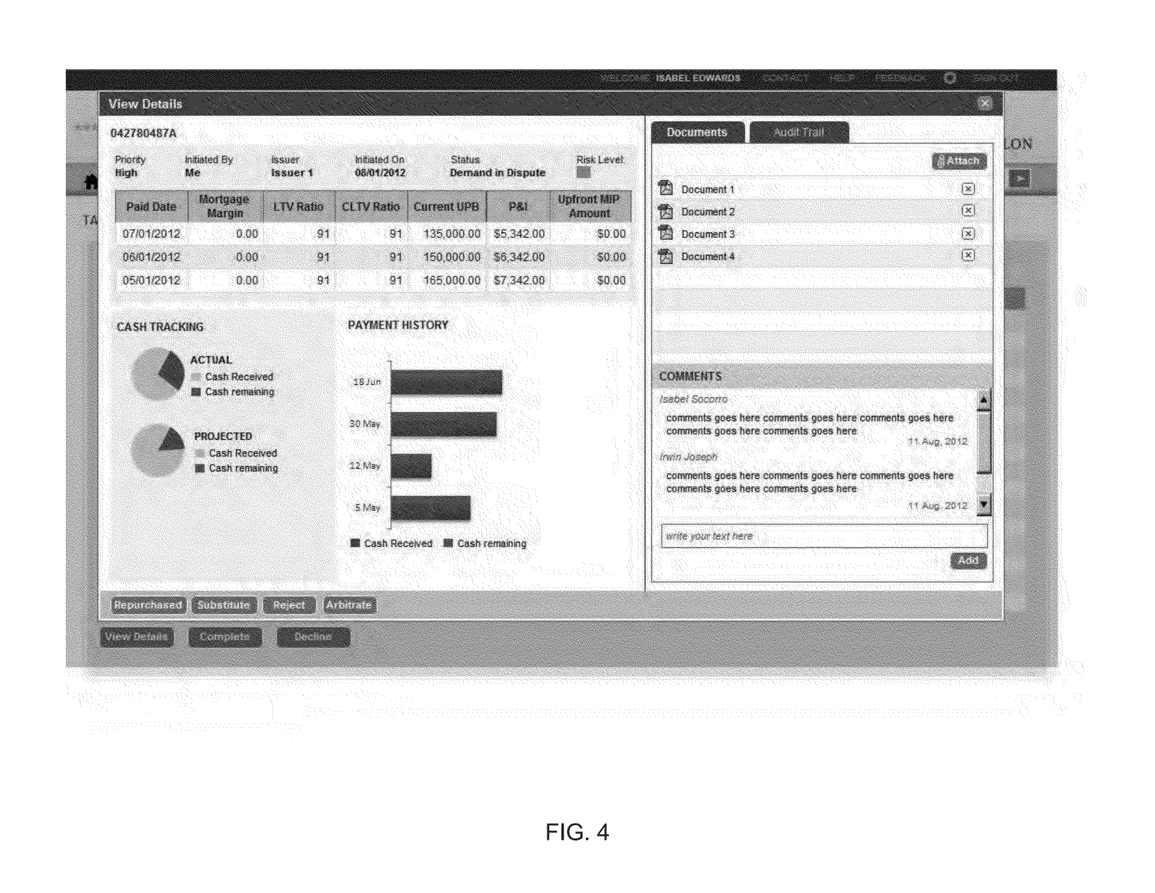

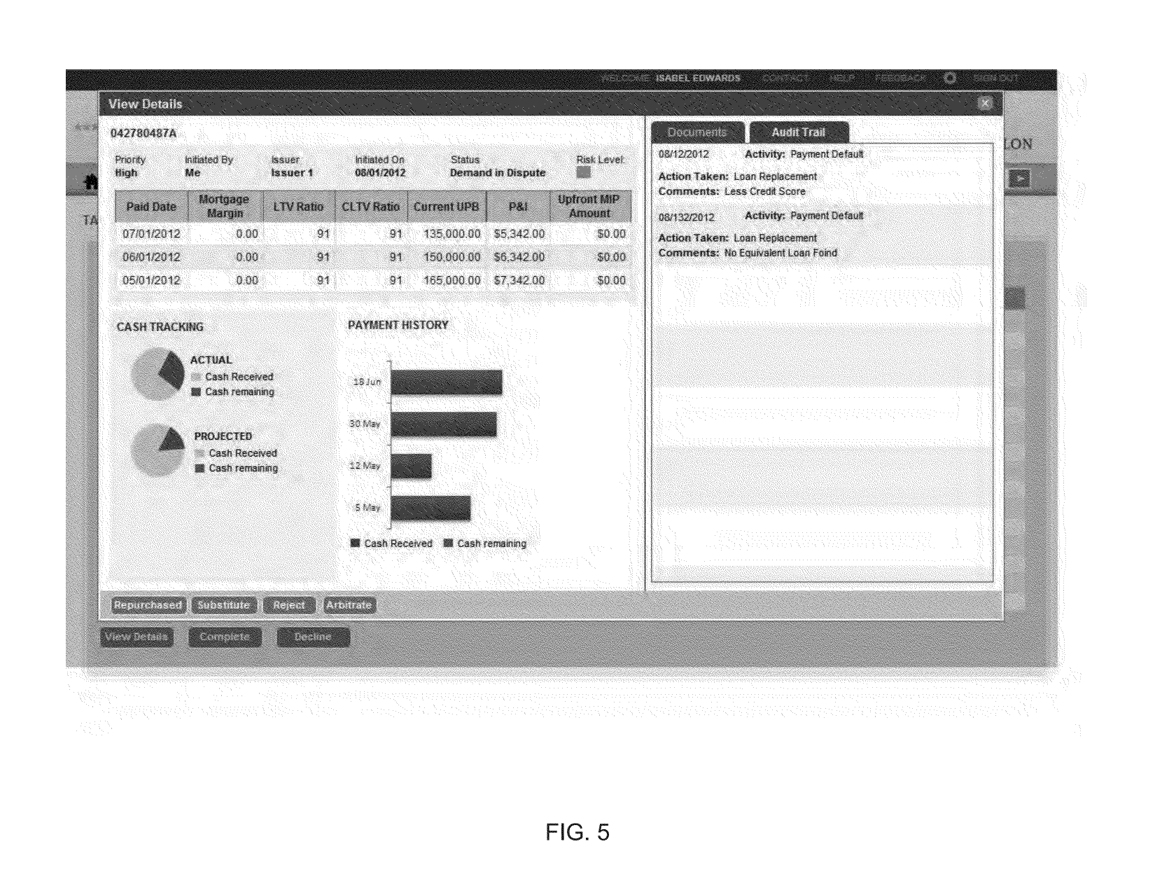

By selecting any of the tasks (e.g., by clicking on the loan ID in the description column), details associated with the loan may be presented, as shown in FIG. 4. As shown, payment data, cash tracking, and payment histories may be presented, as well as providing access to documents associated with the identified loan. An audit trail may also be accessed by selecting the “Audit Trail” tab, as shown in FIG. 5, which may show actions taken in response to various contingencies.

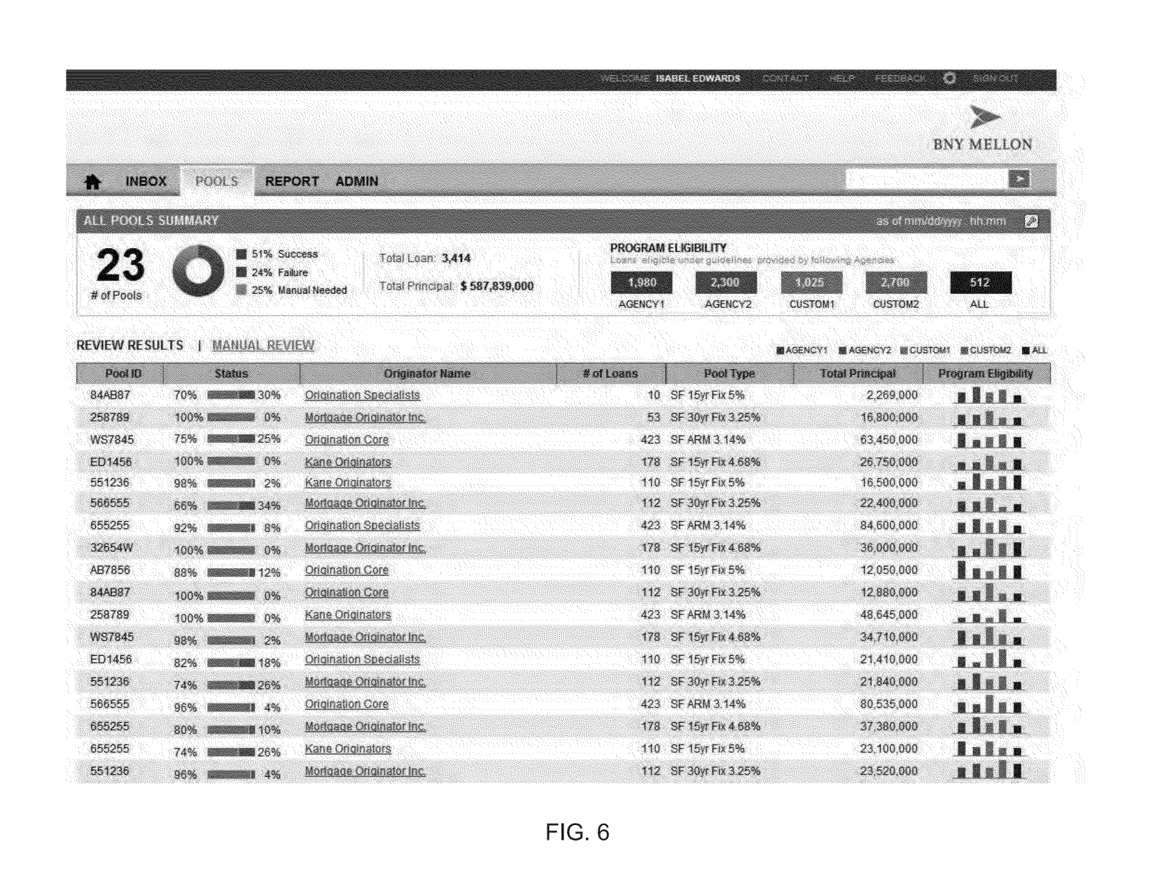

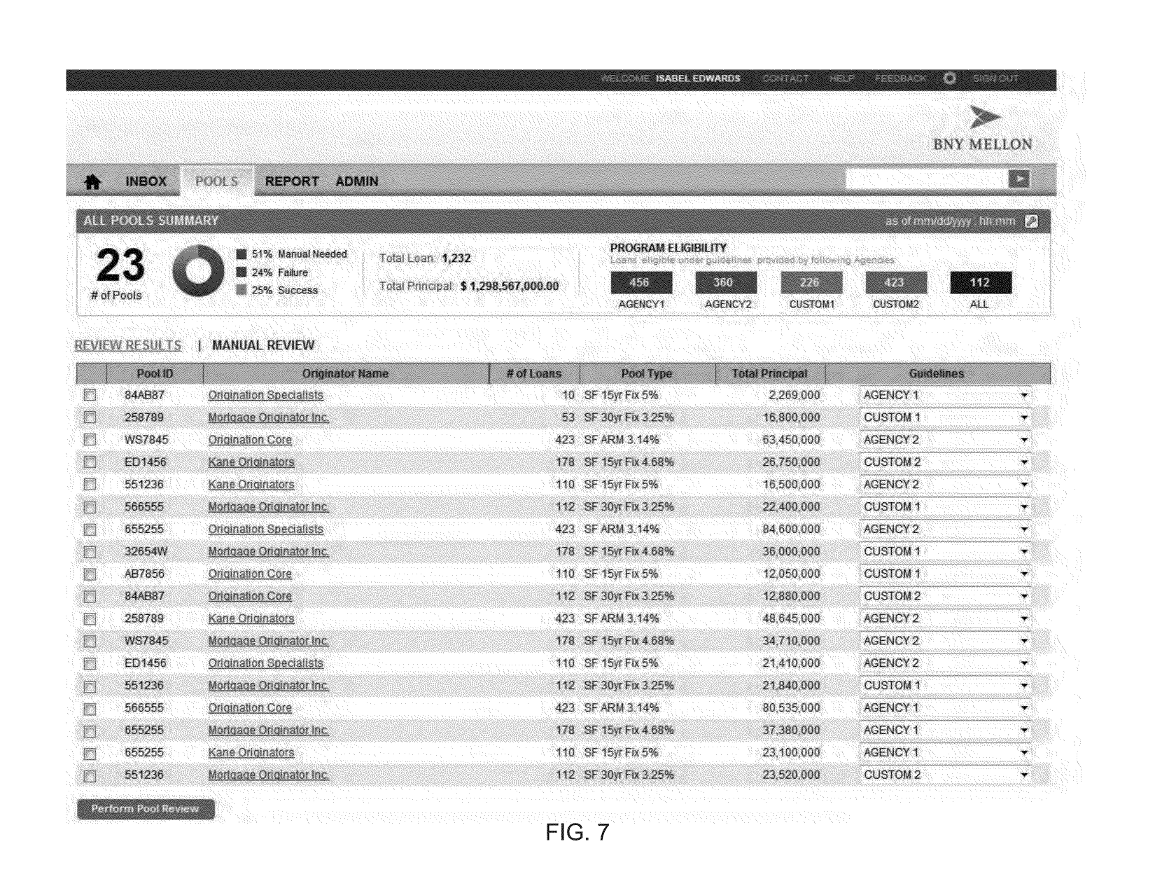

Exiting out of the detail view of the inbox, the issuer 260 may select “Pools” from the main selection bar, and may view a summary of all associated pools of loans, such as that illustrated in FIG. 6. As shown, a success rate across all pools may be illustrated, as well as a status within each pool. For example, program eligibility which each of a number of agencies may be graphically represented, with each agency having a corresponding identifying color, as well as an additional “All” designator. By clicking “Manual Review,” the utility may be configured to allow for selection of associated guidelines, as shown in FIG. 7.

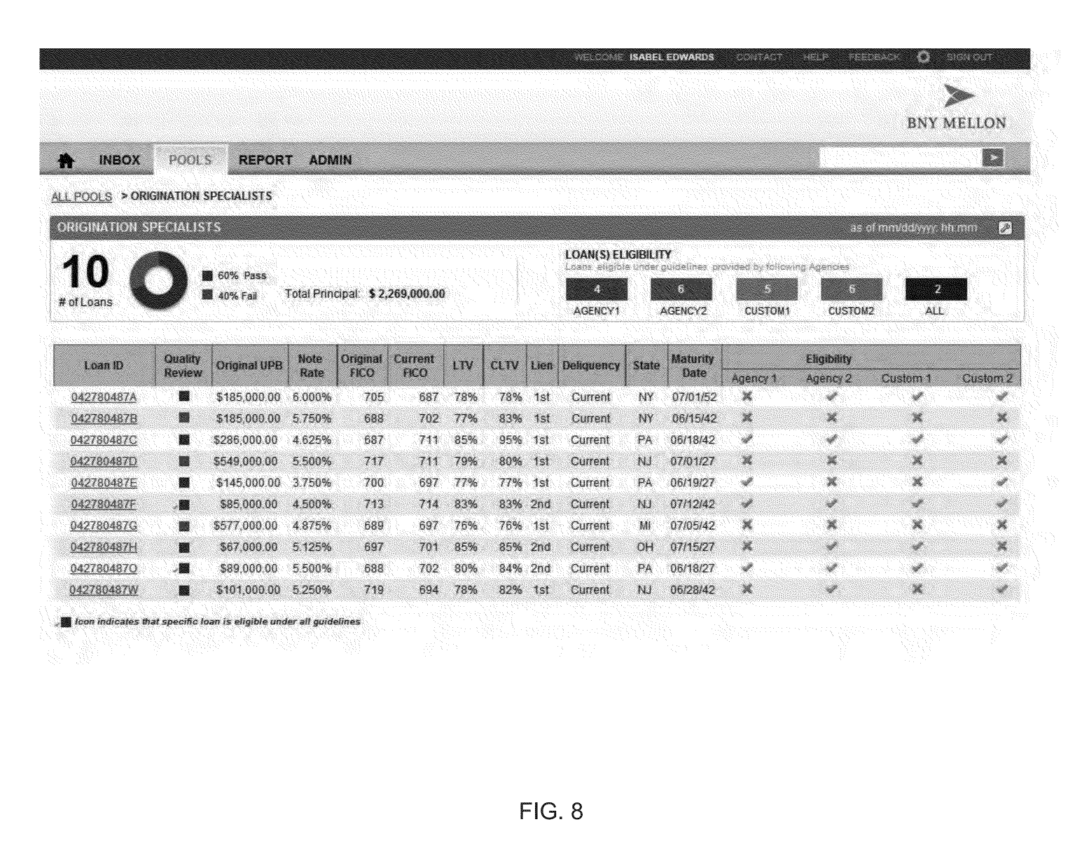

As shown in FIG. 8, by selecting an originator name in the pool view, information associated with that originator 120 may be viewed. For example, the “Origination Specialists” is shown as having a certain pass rate, with eligibility across a plurality of agencies depicted. Each of the loans originated may also be illustrated in summary form, as well as a passing or failing indicia under quality review.

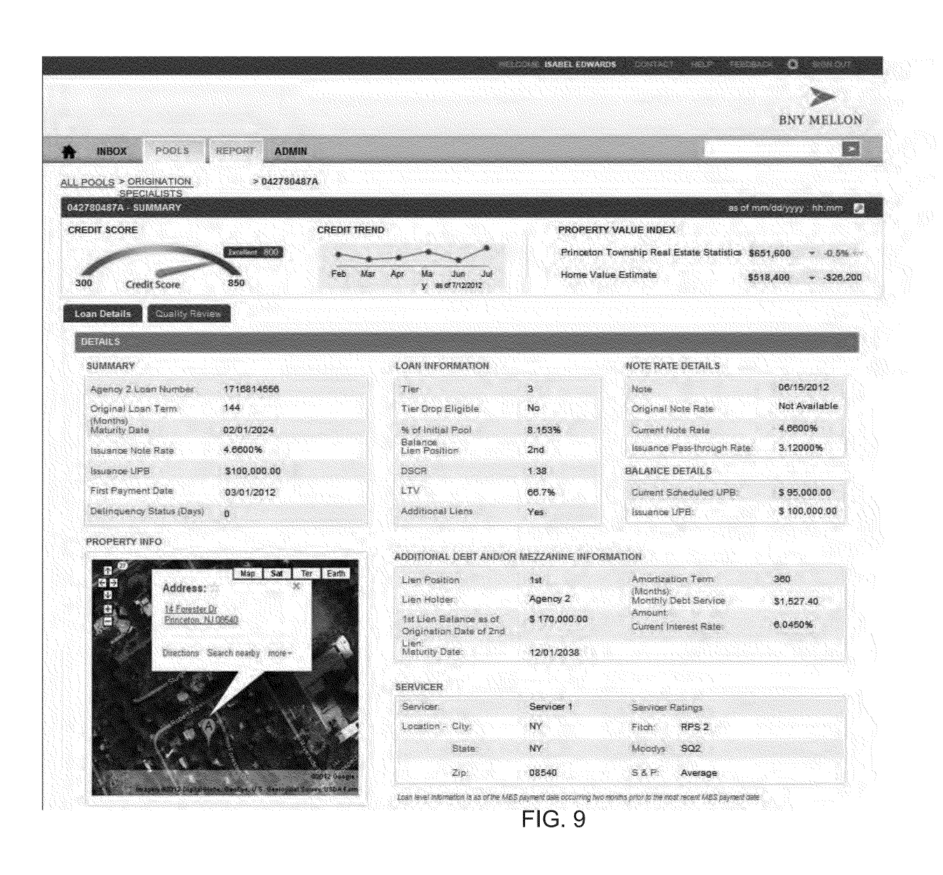

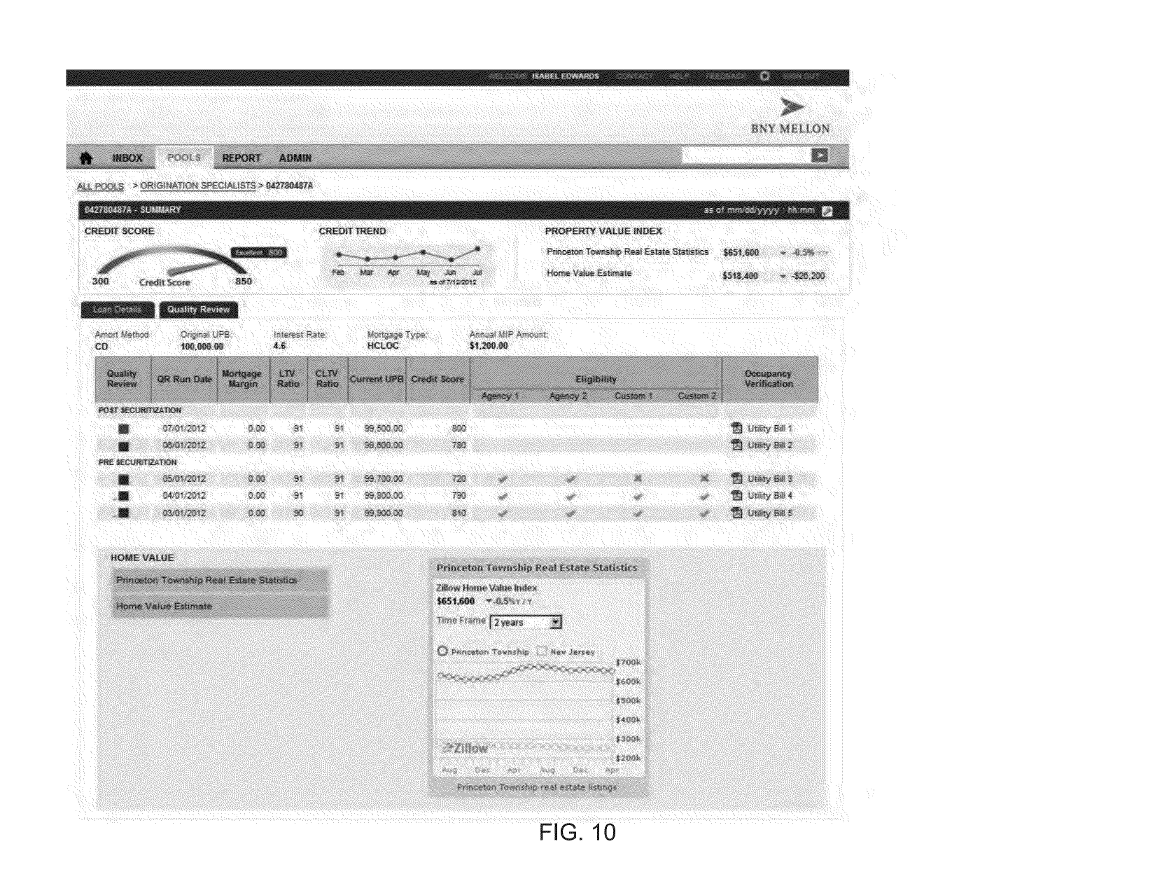

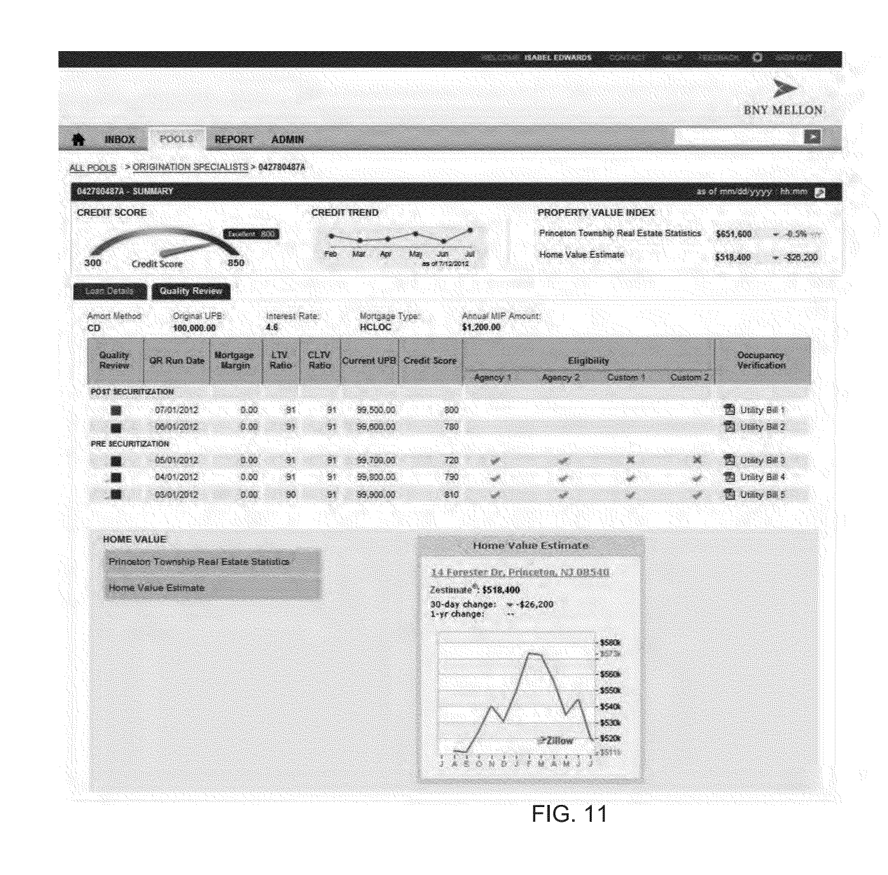

By selecting one of the loans, information reading that loan may be viewed, as depicted in FIG. 9. Such information may include, for example, the credit score of the applicant, the property that is the subject of the loan, the market performance associated with the property, and similar information. By selecting “Quality review,” performance metrics regarding the loan and the subject property may be viewed, including information regarding the local property market (as shown in FIG. 10) and information regarding the subject property's own value (as shown in FIG. 11).

It may be appreciated that report generation may be performed by the issuer 260 (e.g., by selecting “Report” on the main selection bar of the GUI, which may compile various reporting metrics for transmission to other participants or format for printing or other storage or distribution.

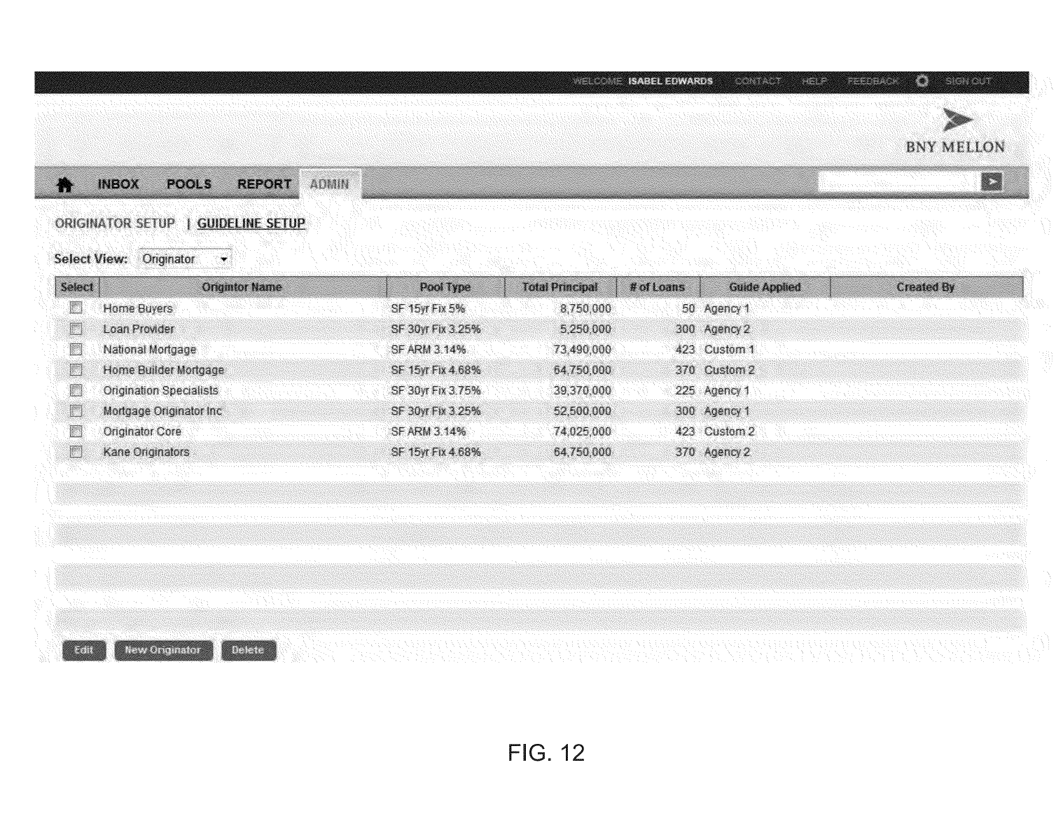

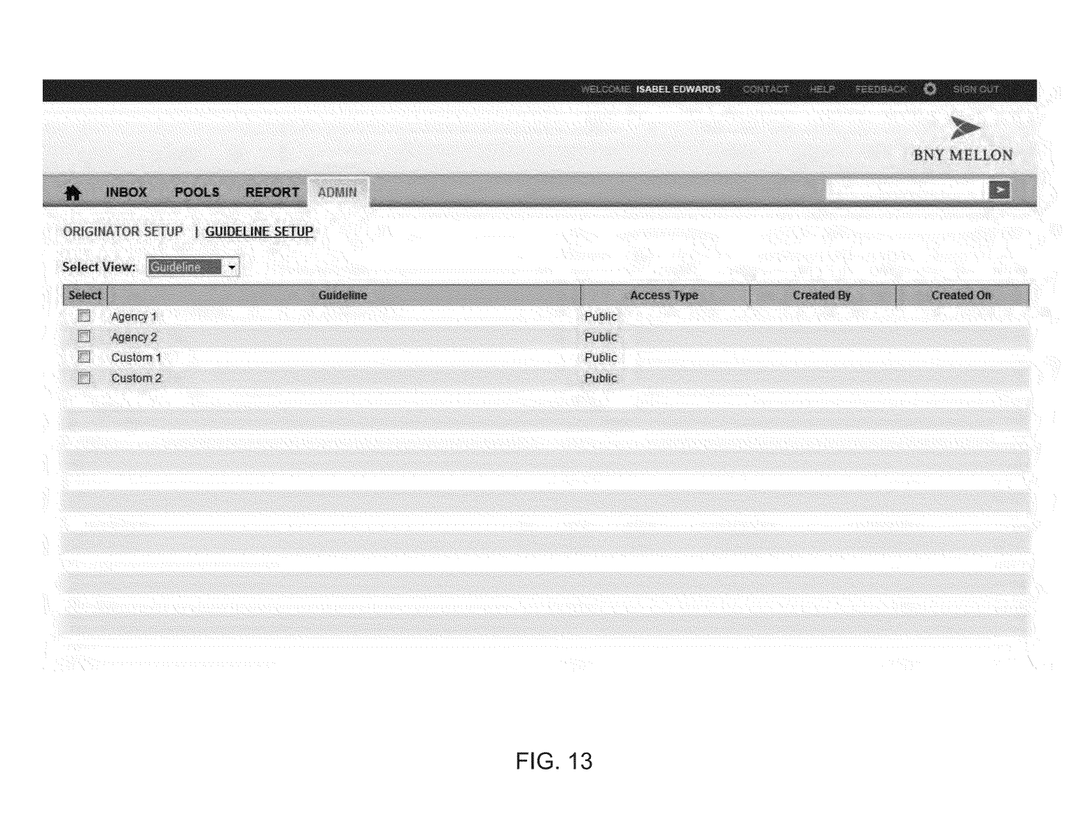

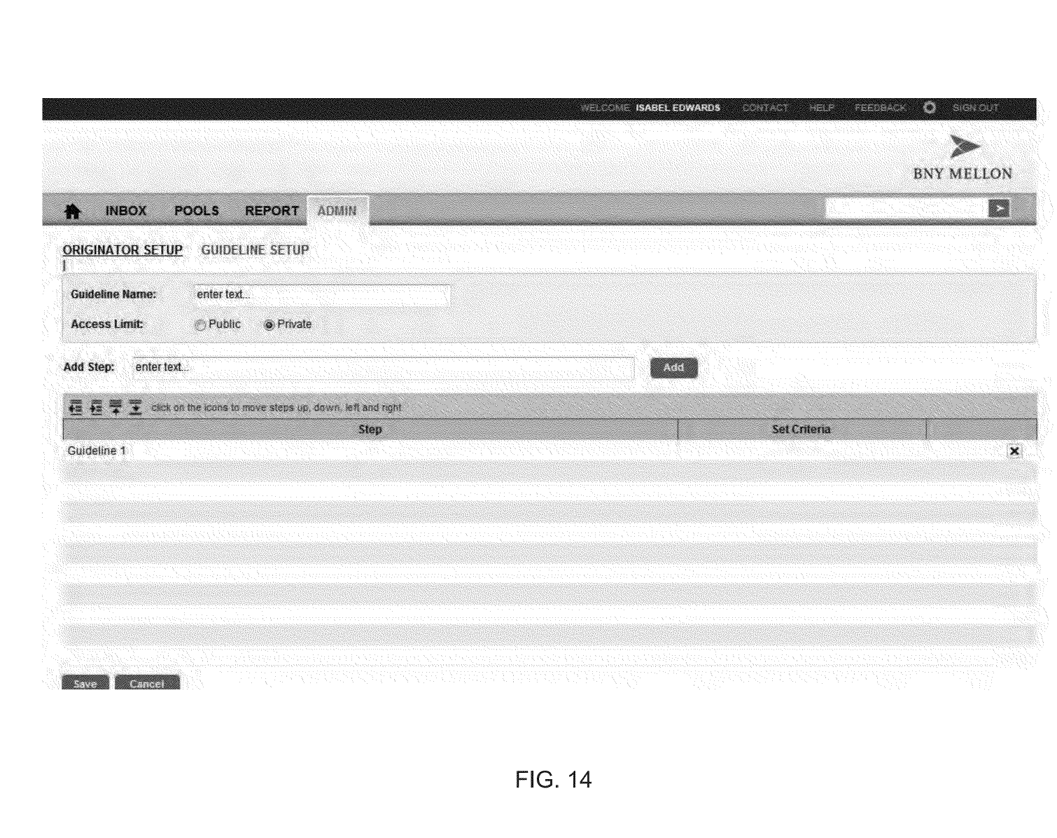

By selecting “Admin” on the main selection bar, various issuance administration tasks may be performed, as shown in FIG. 12. For example, the issuer 260 may set up new originators 120, or modify details associated with the pools they are responsible for. The originator setup may view originators or guidelines as the basis for originator administration, as further shown in FIG. 13. Further, additional guidelines may be added, or existing guidelines may be modified, by selecting “Guideline Setup,” which may facilitate addition of guideline steps, as shown in FIG. 14.

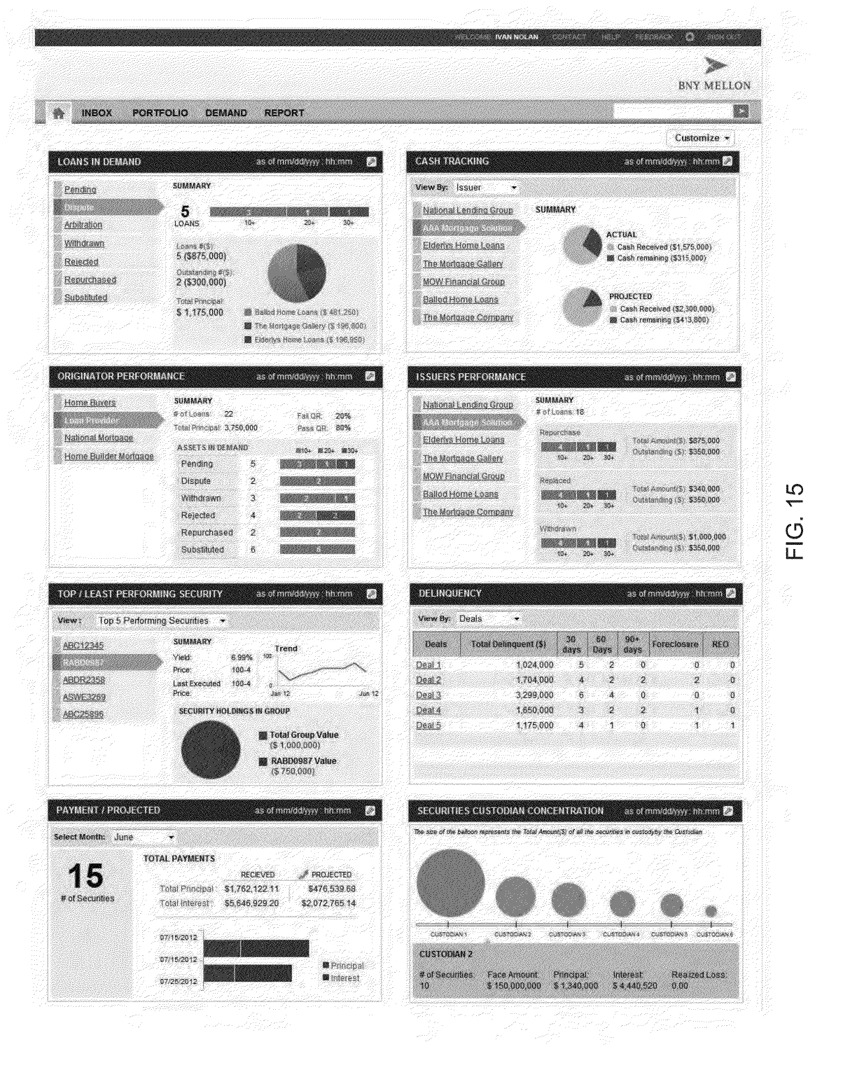

FIGS. 15-37 illustrate exemplary views of a GUI available to an investor 230, allowing the investor 230 to monitor and provide oversight into their portfolio and the investments therein. Specifically, the investor 230 may desire tracking performance and risk exposure across entities. The investor 230 may also desire access to portfolio metrics provided by the transparency agent 350 and the investor representative 340.

FIG. 15 illustrates a dashboard having a summary of key analytics associated with the investments of the investor 230. For example, the status of loans in demand, and a tracking of cash (either by issuer, deal, or custodian) may be displayed. Additionally, the performance of issuers and originators may also be summarized, as shown. In an embodiment, the dashboard may also include a tracking of the top performing securities, and a tracking of the bottom performing securities. Also shown may be delinquency, either by deal or by servicer. Further illustrated may be a history of past payments, as well as a projection of future payments, by month. Finally, the illustrated embodiment of FIG. 15 shows that a concentration of securities associated with a particular custodian may be displayed, which may facilitate balancing decisions.

While the investor 230 may also have an inbox available through the GUI, it may be appreciated that the inbox may in some embodiments be similar to that of the issuer 260, or may be simpler, allowing for receiving and sending messages associated with account management or questions regarding investments.

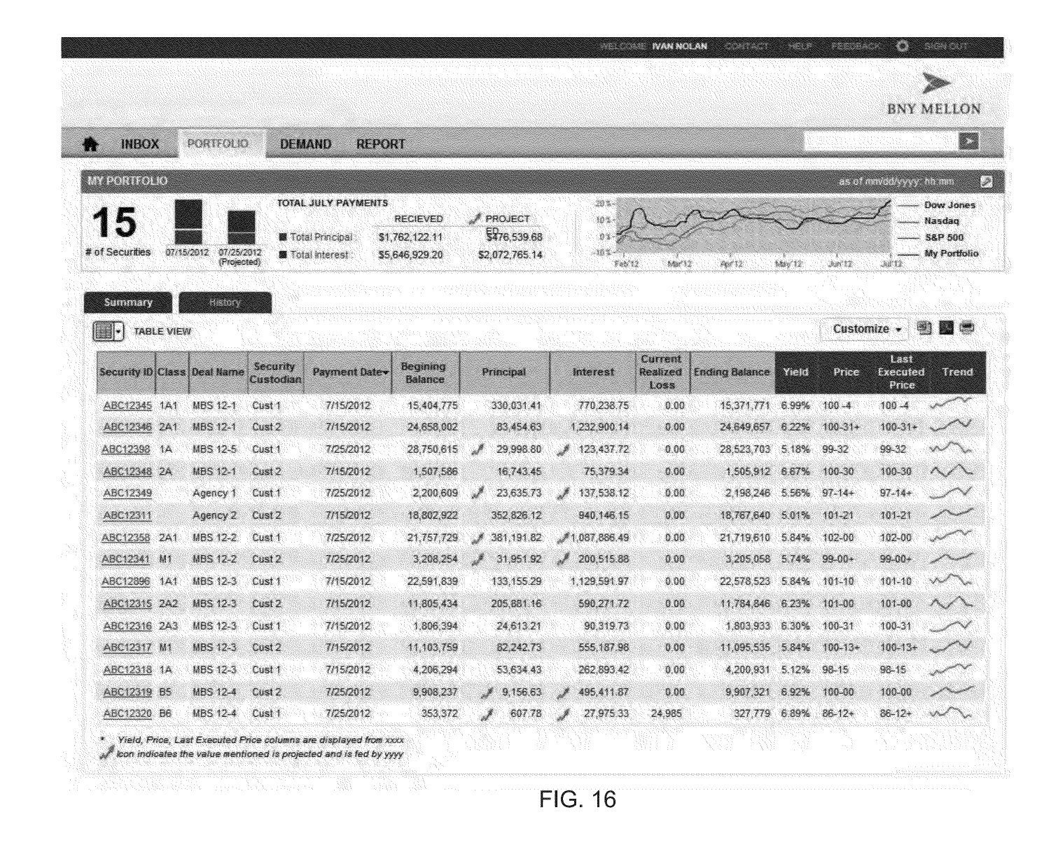

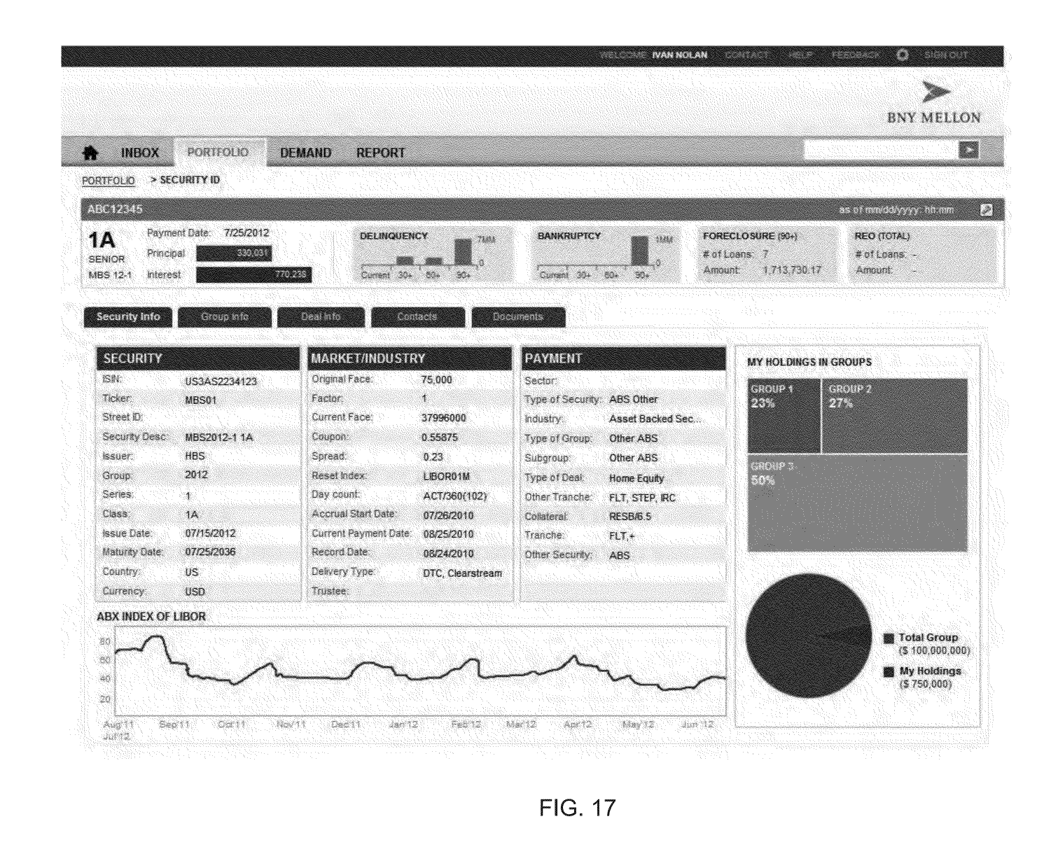

As shown in FIG. 16, the portfolio of the investor 230 may be available by selecting “Portfolio” from the main selection bar of the GUI. In an embodiment, the display may illustrate performance tracking of each of a number of securities in the portfolio, as well as a comparison to various market indexes. In an embodiment, each of the securities may be listed by identifier, with information related therewith displayed alongside. By selecting one of the securities, details about that security may be displayed, as shown in FIG. 17. The information regarding the security, including how that security fits into different groups or the portfolio as whole of the investor 230, may be provided in a number of views.

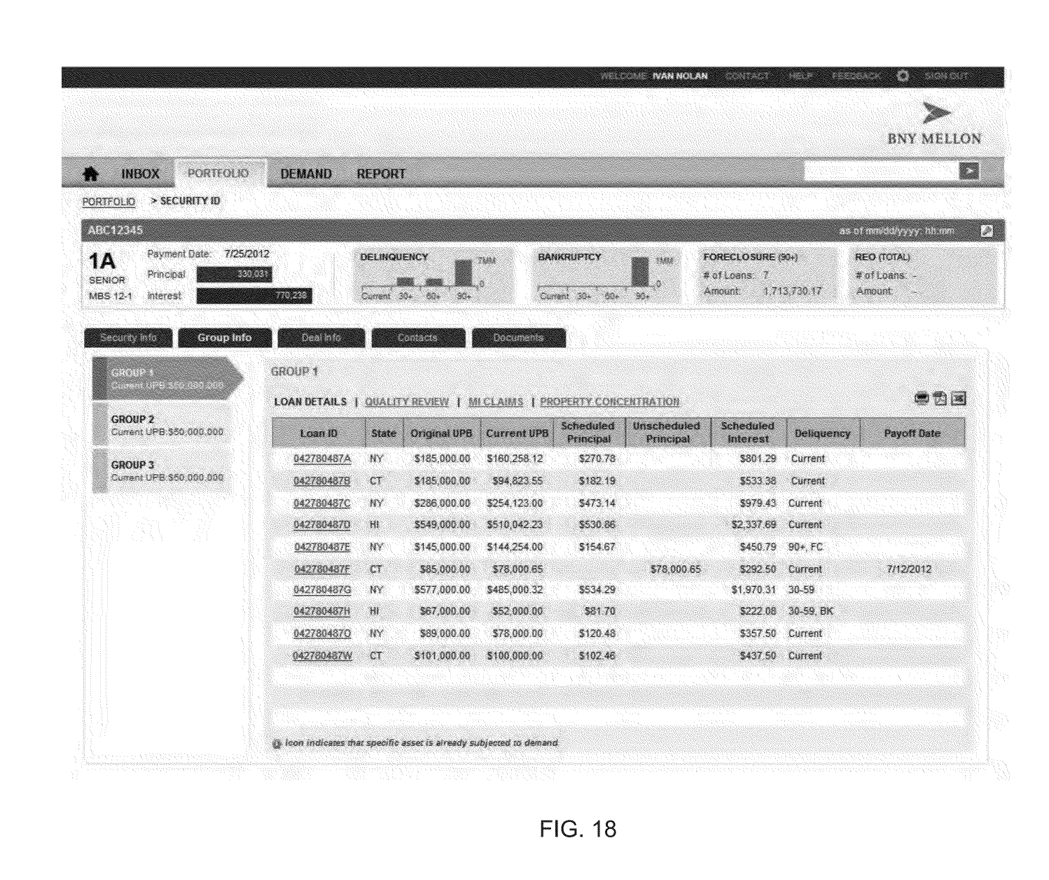

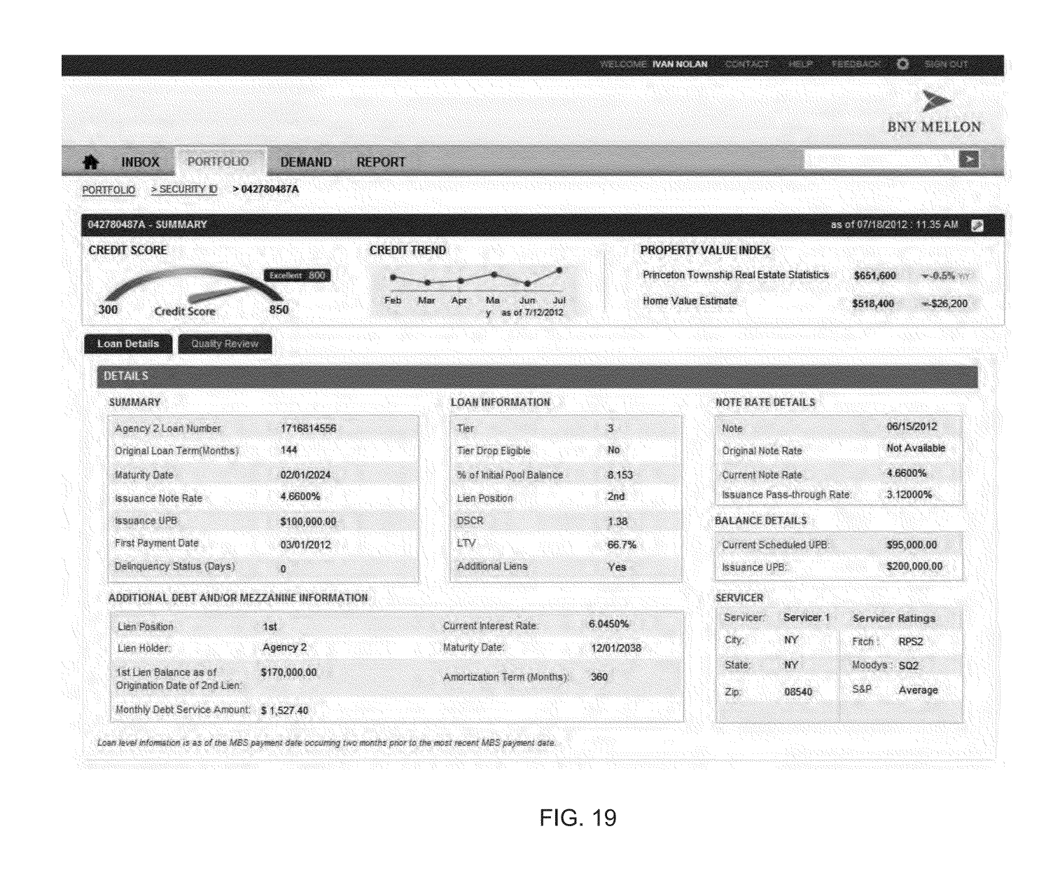

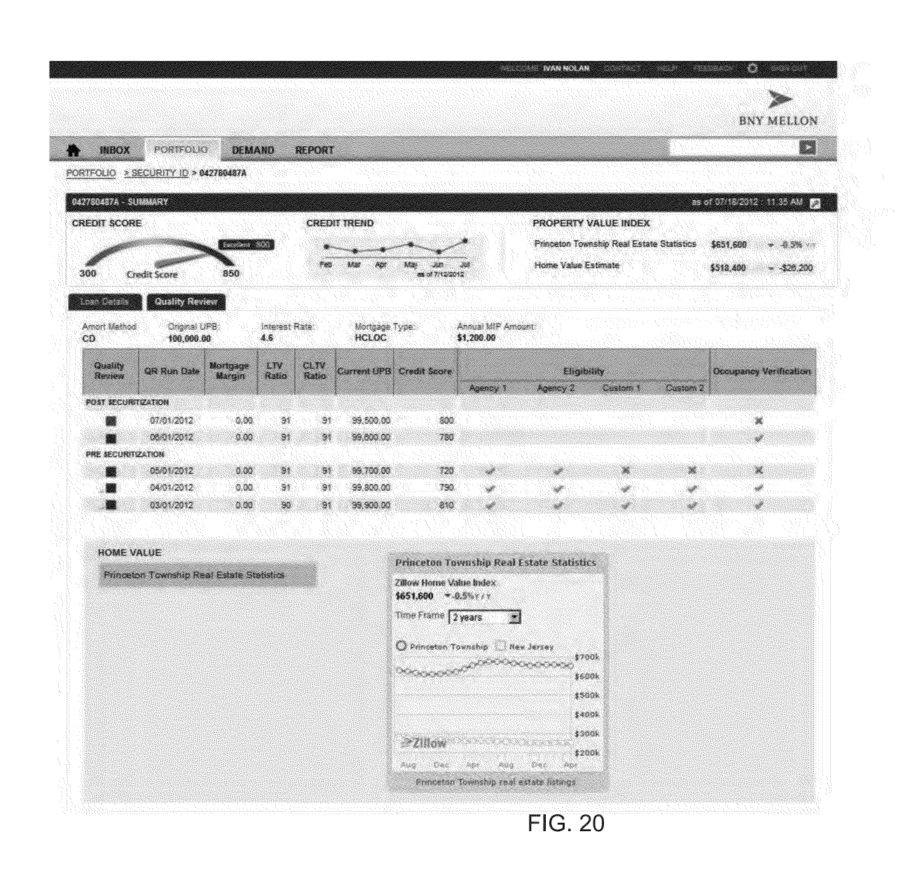

Group information may also be displayed, by selecting “Group Info” in the sub-menu bar of the security information screen, as illustrated in FIG. 18. The group information may show the constituent loans within each group, and allow for display of further information associated therewith. As shown in FIG. 19, by selecting any of the individual loans in the group, information regarding that loan may be viewed, including a credit rating of the borrower, and performance metrics associated with the property value. In an embodiment, such loan information may be the same as or similar to those presented to the issuer 260. A quality review screen, illustrated in FIG. 20, may also be viewed by the investor 230, showing performance of the collateral, as well as allowing comparison to the surrounding region.

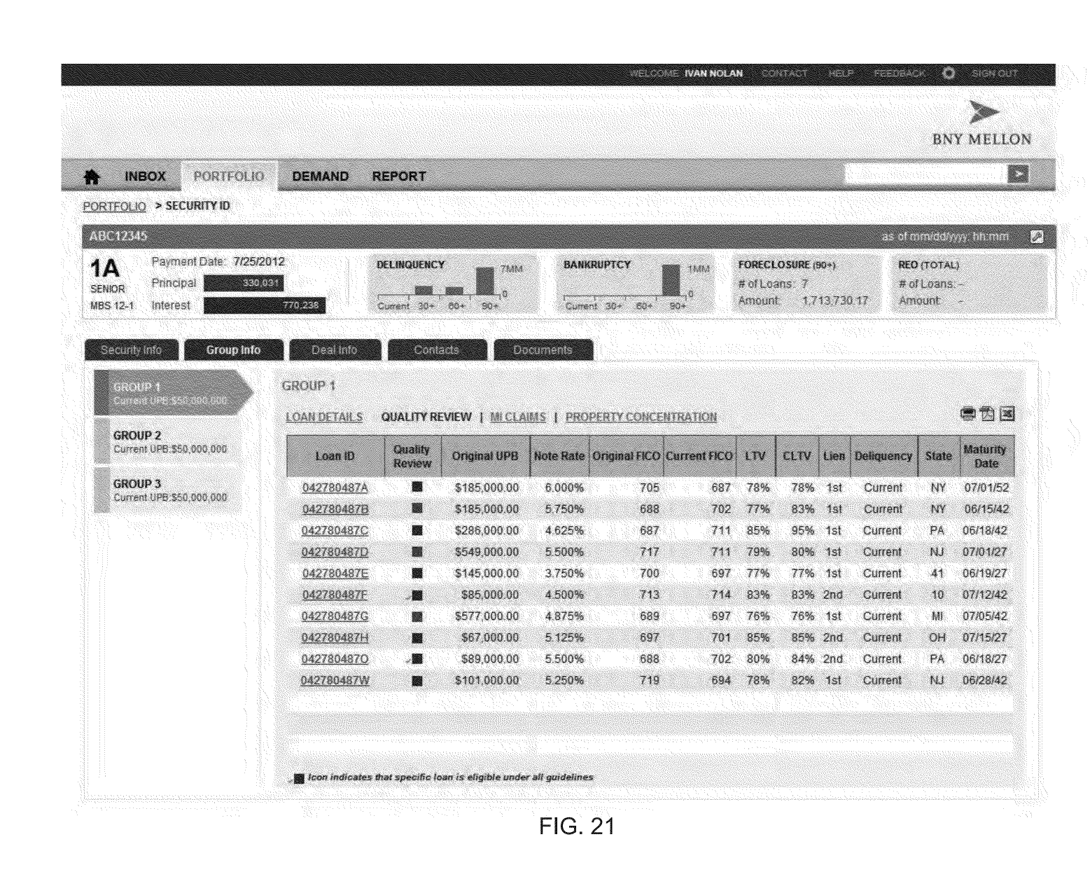

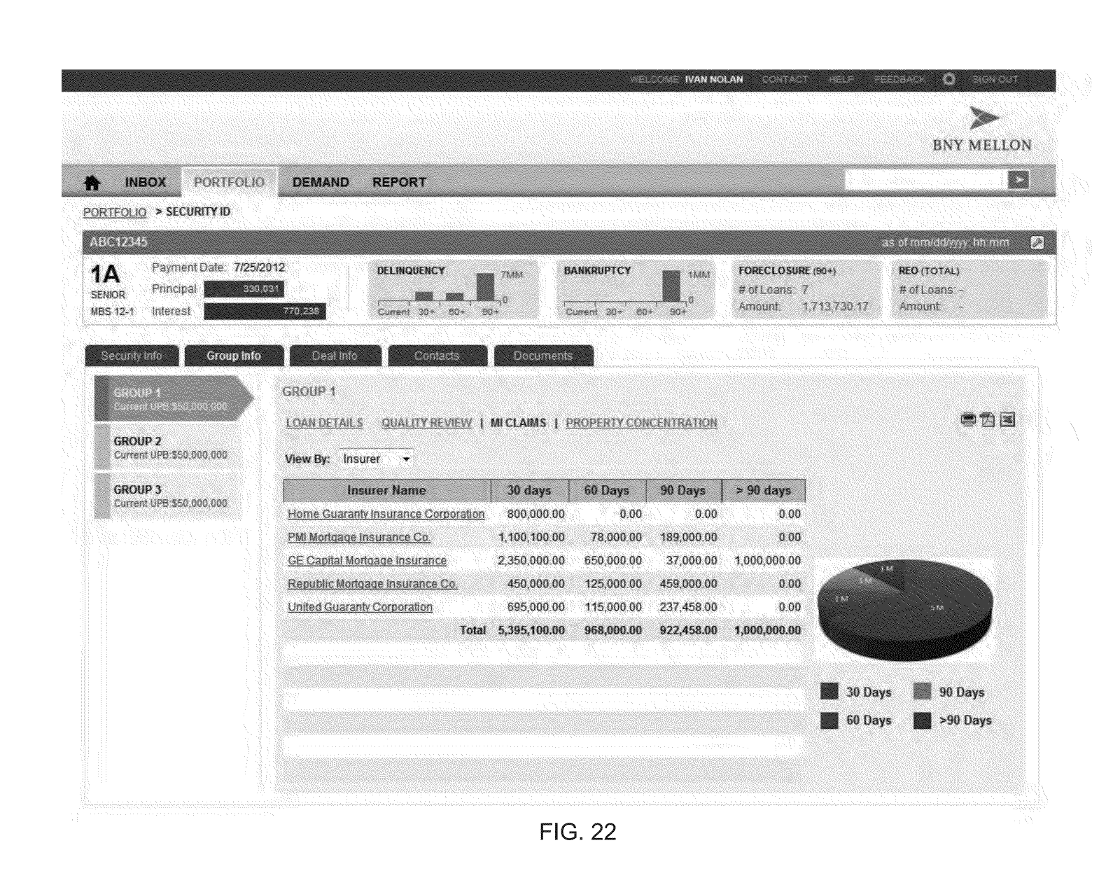

Returning to the group information screen (e.g., of FIG. 18), the investor 230 may be able to review quality information associated with the loans, as shown in FIG. 21. In an embodiment, the quality may be color coded, which in an embodiment may be ascertained by compliance with eligibility guidelines. The group information section may also facilitate review of mortgage insurance information, by selecting “MI Claims” from the Group Info submenu. Such a display is illustrated in FIG. 22. In some embodiments, the mortgage insurance claims may be displayed based on insurer or based on issuer. Additionally, the staleness of the claim and the value associated therewith may also be displayed.

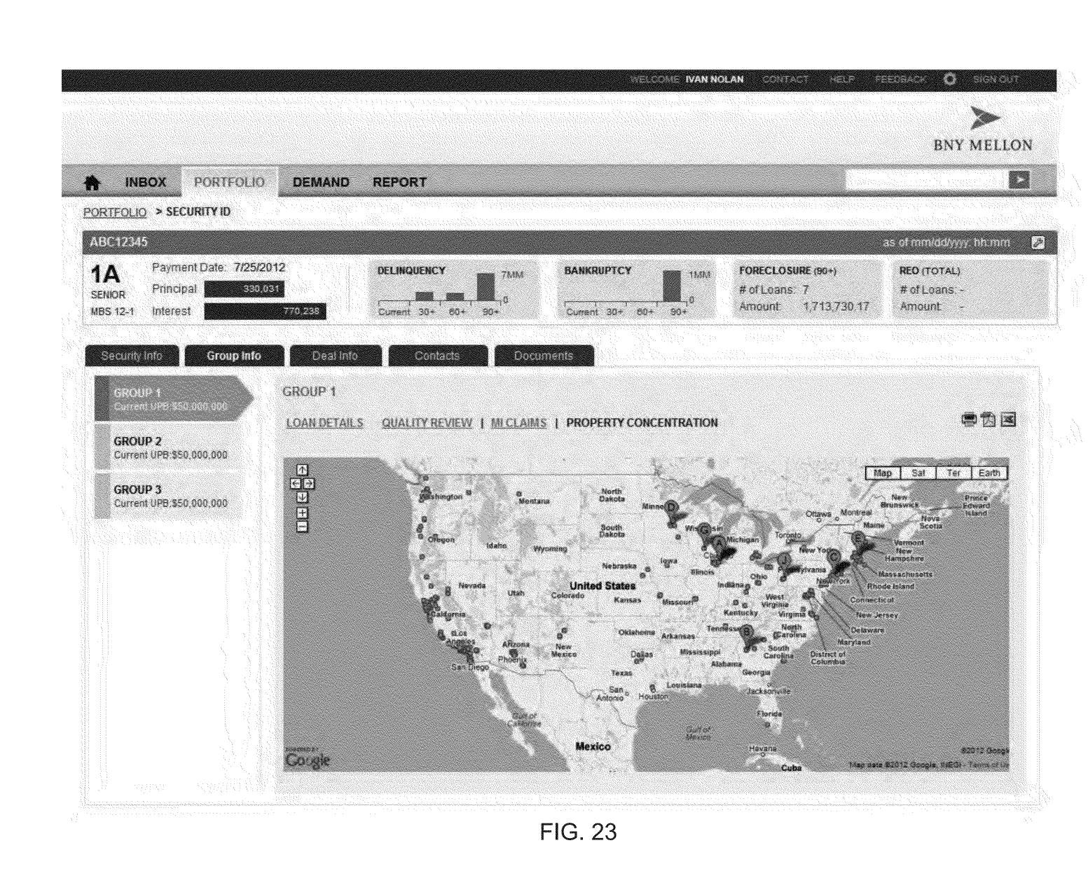

Group information may also allow for a graphical representation of the concentration of properties subject to the loans in the group. For example, by clicking the “Property Concentration” sub-menu, the display may show a map highlighting locations of the subject properties, as illustrated in FIG. 23. In an embodiment, clicking any given property may provide more information about that property, and may facilitate returning to associated displayed regarding that property and the surrounding region. The property concentration may be plotted or mapped by any appropriate plotting or mapping module, and may vary across embodiments.

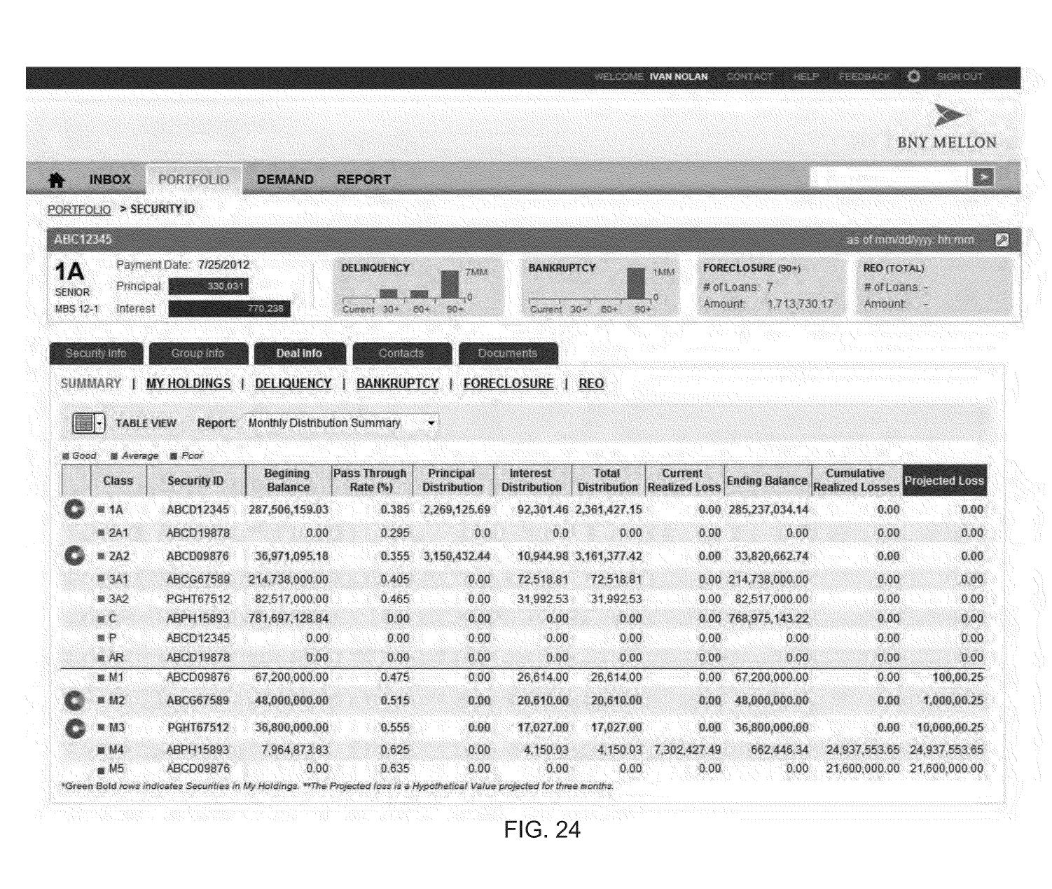

Returning to the security ID submenu, deal information may also be displayed. For example, as shown in FIG. 24, data and metrics associated with various deals may be illustrated, including in an embodiment a graphical representation of whether the performance is good, average or poor. In an embodiment, such metrics may be color coded using a Red, Amber Green convention, which may illustrate the overall health of the deal. In some embodiments the reports may be displayed as a monthly distribution summary. In an embodiment, principal distribution details and/or interest distribution details may alternatively be viewed.

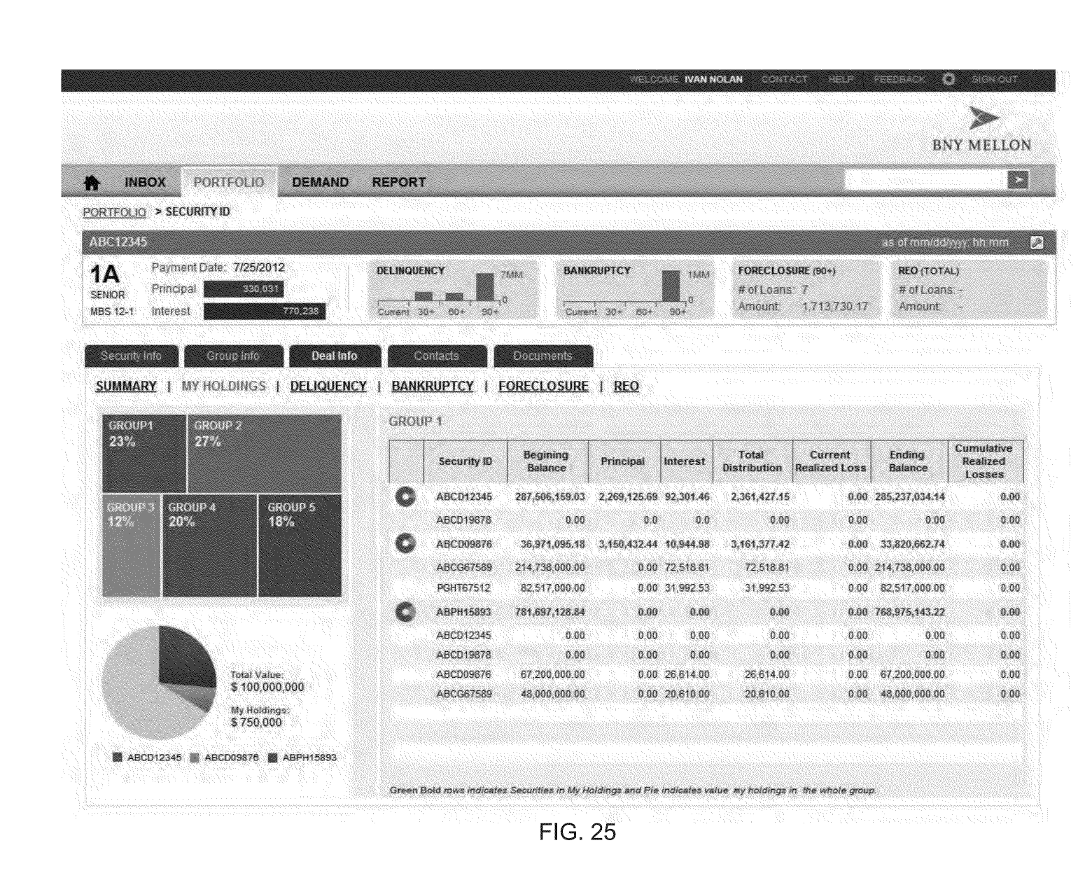

As shown in FIG. 25, in the deal information submenu, an analysis of the current holdings of the investor 230 may be displayed. As shown, a graphical representation of the deal holdings associated with each group may be viewed, as well as details of the securities associated therewith. Other metrics may also be available in some embodiments, including analysis of delinquency, bankruptcy, foreclosure, and Real Estate Owned (REO) information.

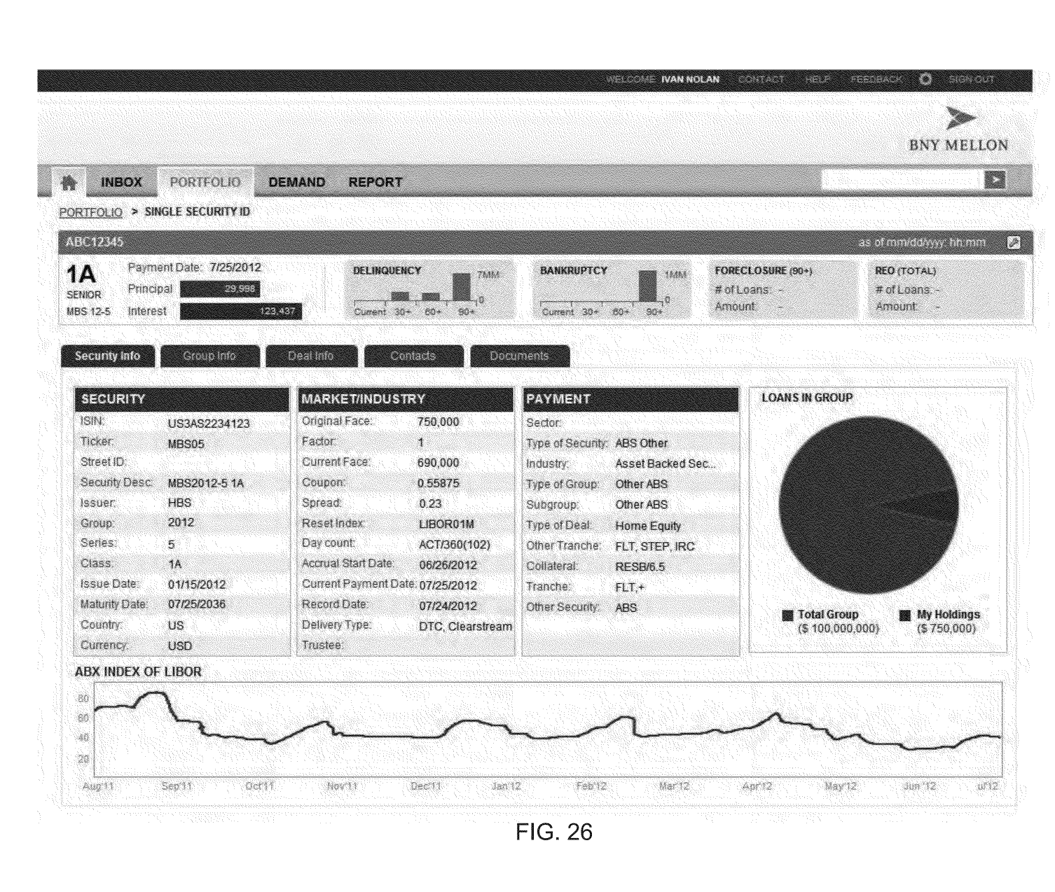

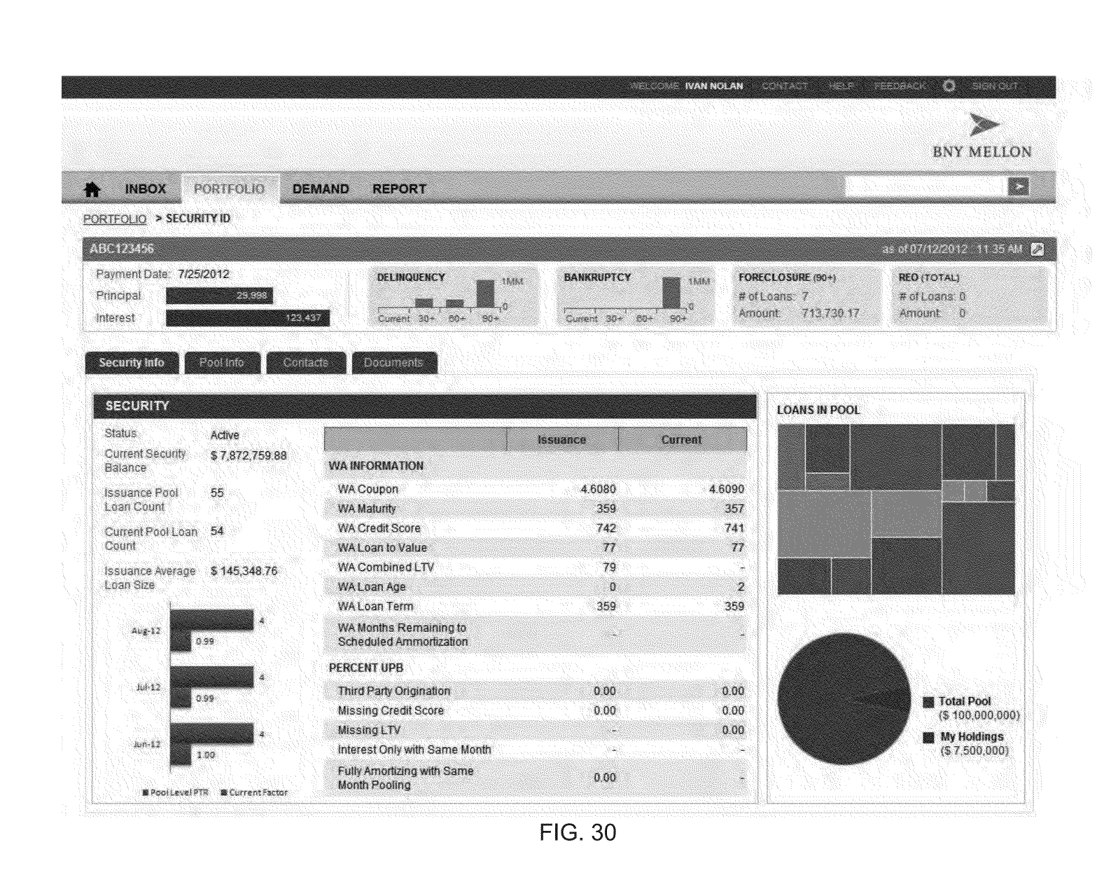

As shown in FIGS. 26-34, other securities may be configured to display their information according to other metrics. For example, FIGS. 26-29 illustrate displays for a single security ID, while FIGS. 30-34 illustrate displays for a government security. As shown, while some security displays may be similar, other representations may differ, to simplify access to information associated therewith. As an example, in FIG. 30, where there are a large number of loans in the pool, it may be appreciated that hovering over the graphical representation of loans in the pool, arranged to highlight their comparative sizes/values, may show overlaid information, including, for example, original UPB, current UPB, principal, and interest associated with each loan.

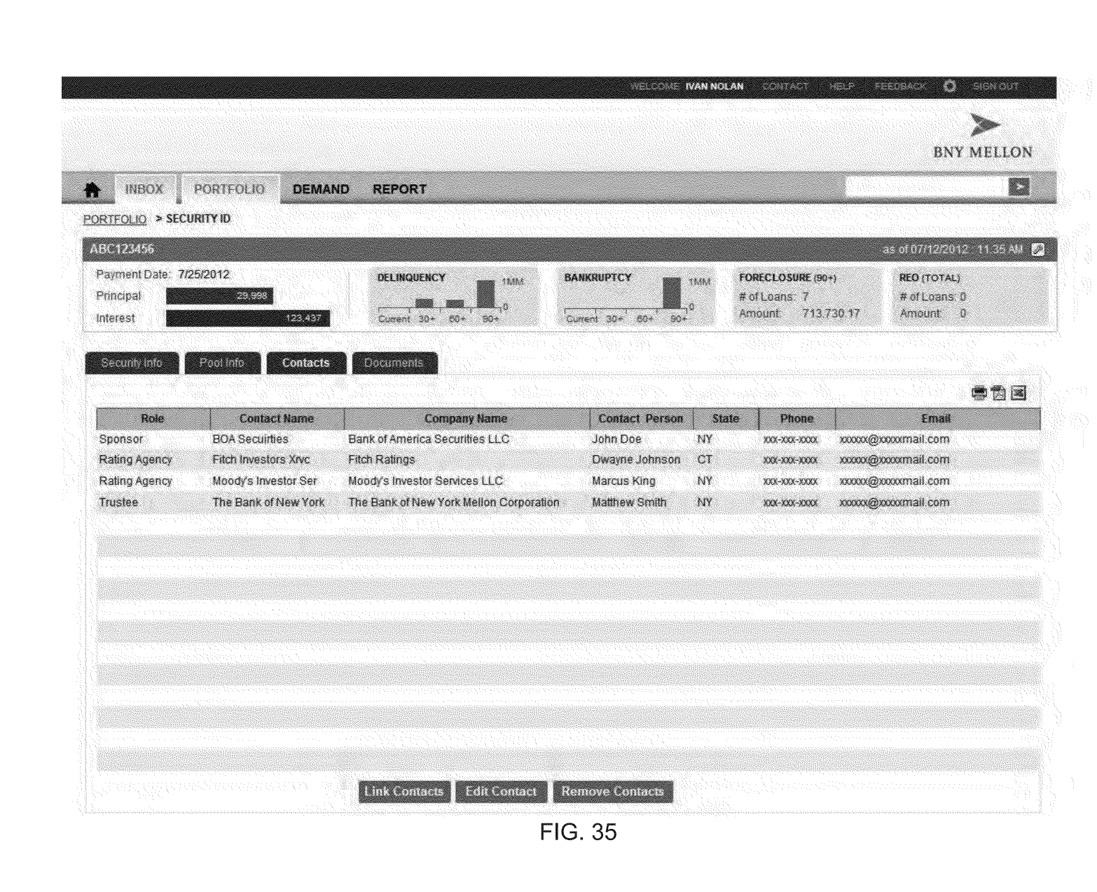

In some embodiments, contact information associated with a given security may be accessible from the security identification screens. As shown in FIG. 35, associated sponsors, rating agencies, trustees, or others may be provided. In some embodiments, the contact information may be linked to an e-mail program or other communications mechanism, to allow for ease of communicating with the contact regarding the security.

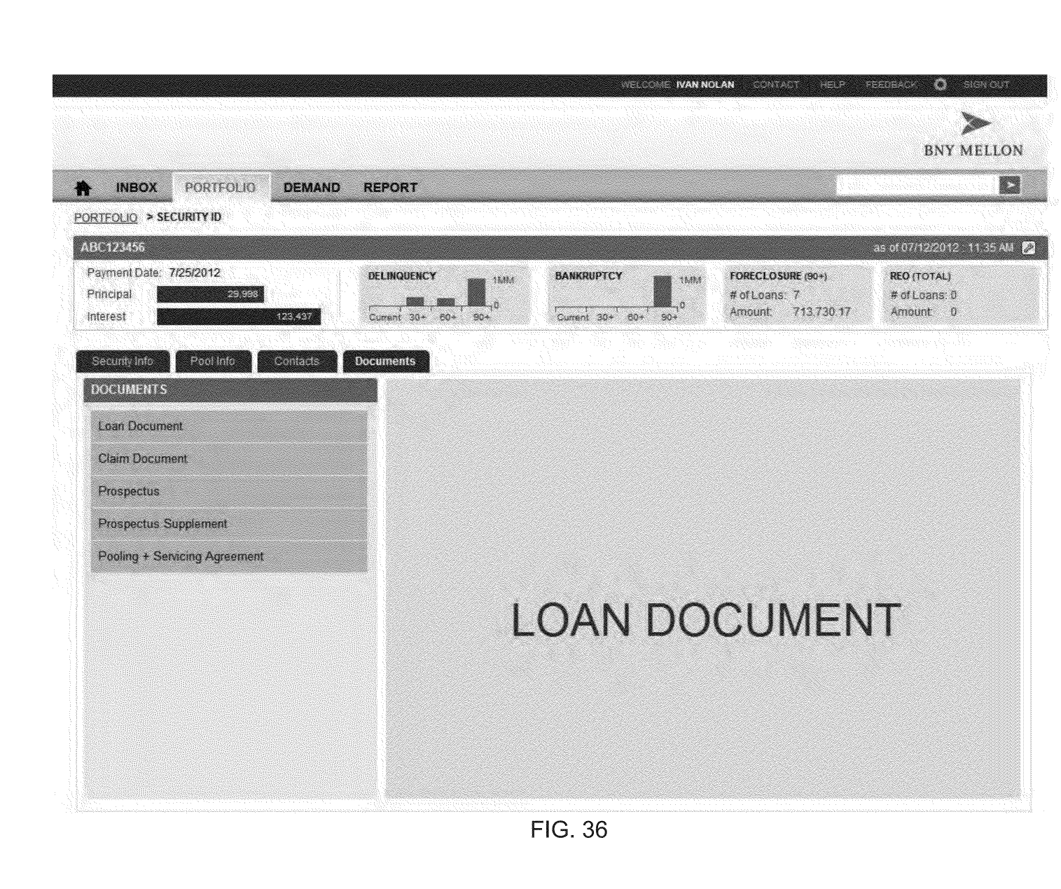

FIG. 36 illustrates that the portfolio menu may also allow for display of documents associated with the loan, including but not limited to the loan agreement, claim agreements, prospectuses, supplements, and pooling and service agreements.

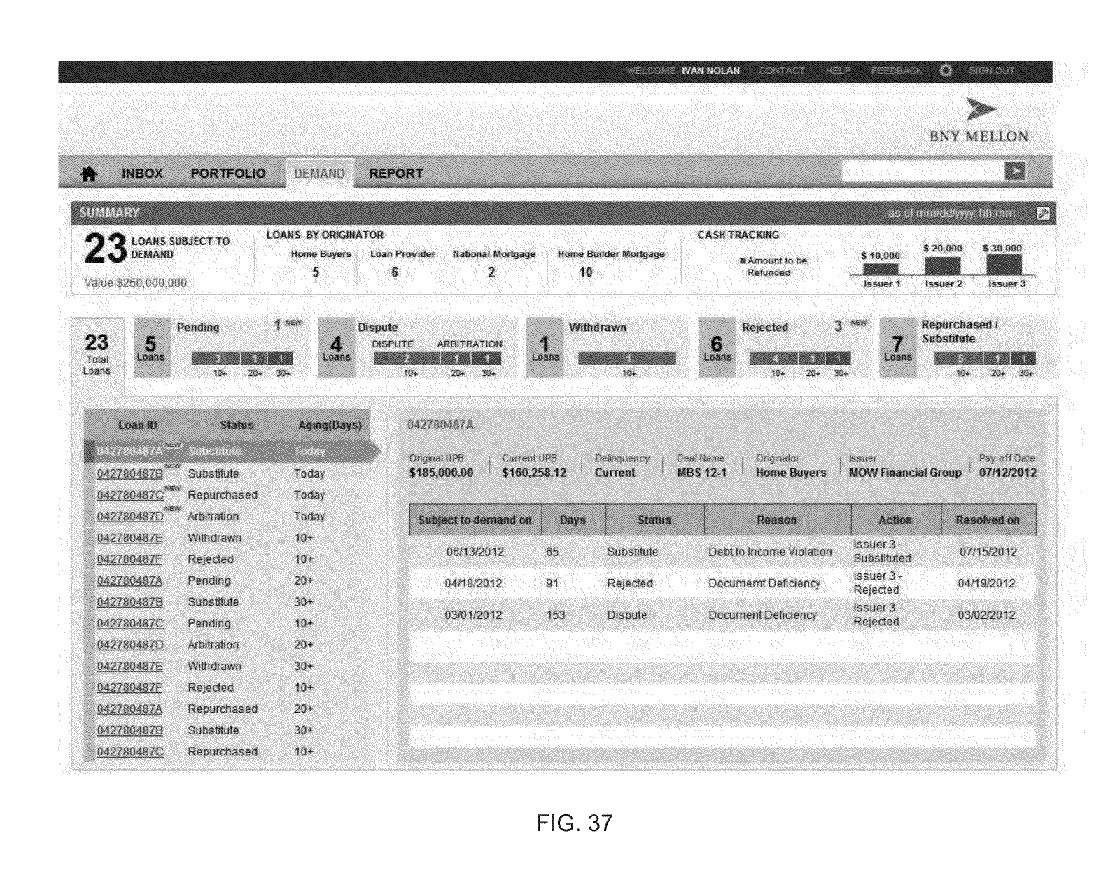

As illustrated in FIG. 37, the GUI of the utility may be configured to provide information to the investor 230 regarding loans subject to demand. Specifically, the subject loans may be identified, and details regarding the pending demand, or the existing demand, may be provided. Tracking information regarding pendency of demands, which loans are being disputed (or are being arbitrated), which loans have been withdrawn, which loans have been rejected, and which loans have been repurchased or substituted, may also be provided in an embodiment. In an embodiment the age since last action may be highlighted to emphasize which loans subject to demand are stagnating.

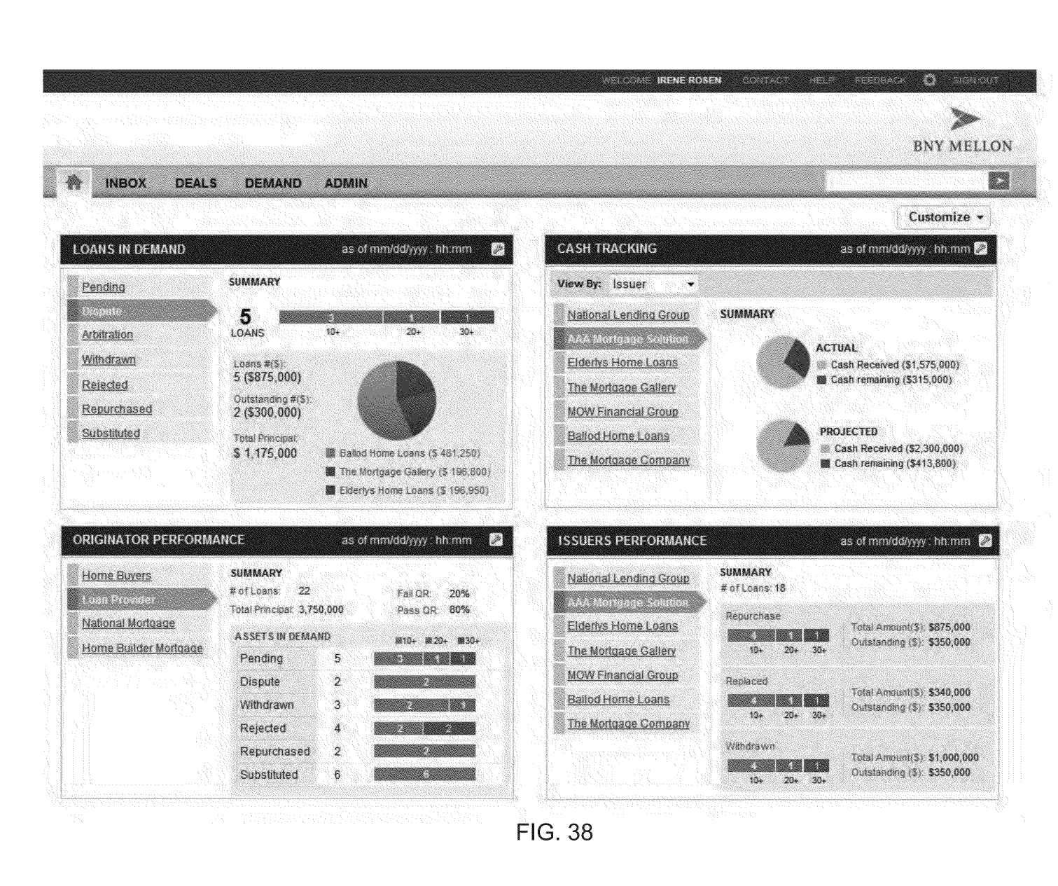

FIGS. 38-45 illustrate views of the GUI of the utility pertaining to the investor representative 340. It may be appreciated that the investor representative 340 may enforce standards set in documentation, and ensure accountability. Specifically, the investor representative 340 may communicate with responsible parties to pursue possible breaches of representations and warranties. Additionally, the investor representative 340 may track outstanding requests and their status, as well as money entering the deal on repurchased items. The investor representative 340 may also find loans that are potentially eligible for repurchase, and follow repurchase requests through to resolution, as well as ensure, on behalf of the investors 230, that deal covenants are being honored. In some embodiments of the infrastructure 100, the investor representative 340 may be able to monitor and identify loans eligible for repurchase, track the status of repurchase requests, take disputed items to arbitration if unable to settle matters, and reconcile funds sent into trust for repurchased loans.

FIG. 38 shows an embodiment of a dashboard home screen for the investor representative 340. As shown, the metrics provided therein may in some embodiments mirror some of those provided to the investor 230 (e.g., as shown in FIG. 15). In other embodiments, the home screen/dashboard may provide metrics associated with performance of the actionable duties of the investor representative 340, instead of monitoring duties associated with representation of the investor 230.

While the investor representative 340 may also have an inbox available through the GUI, it may be appreciated that the inbox may in some embodiments be similar to that of the issuer 260, or may be simpler, allowing for receiving and sending messages associated with performance of the duties of the investor representative 340. In some embodiments, the information provided through the task details in the inbox may be similar to that seen by the issuer 260, however include additional supporting information.

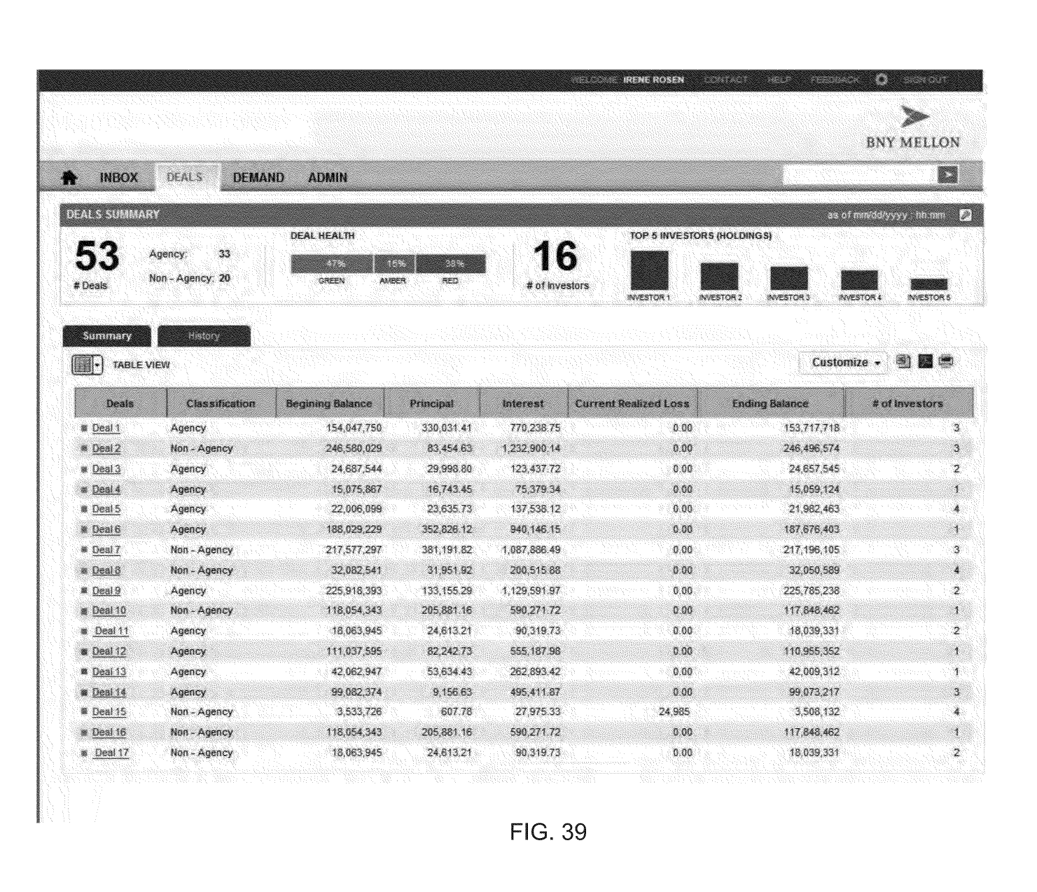

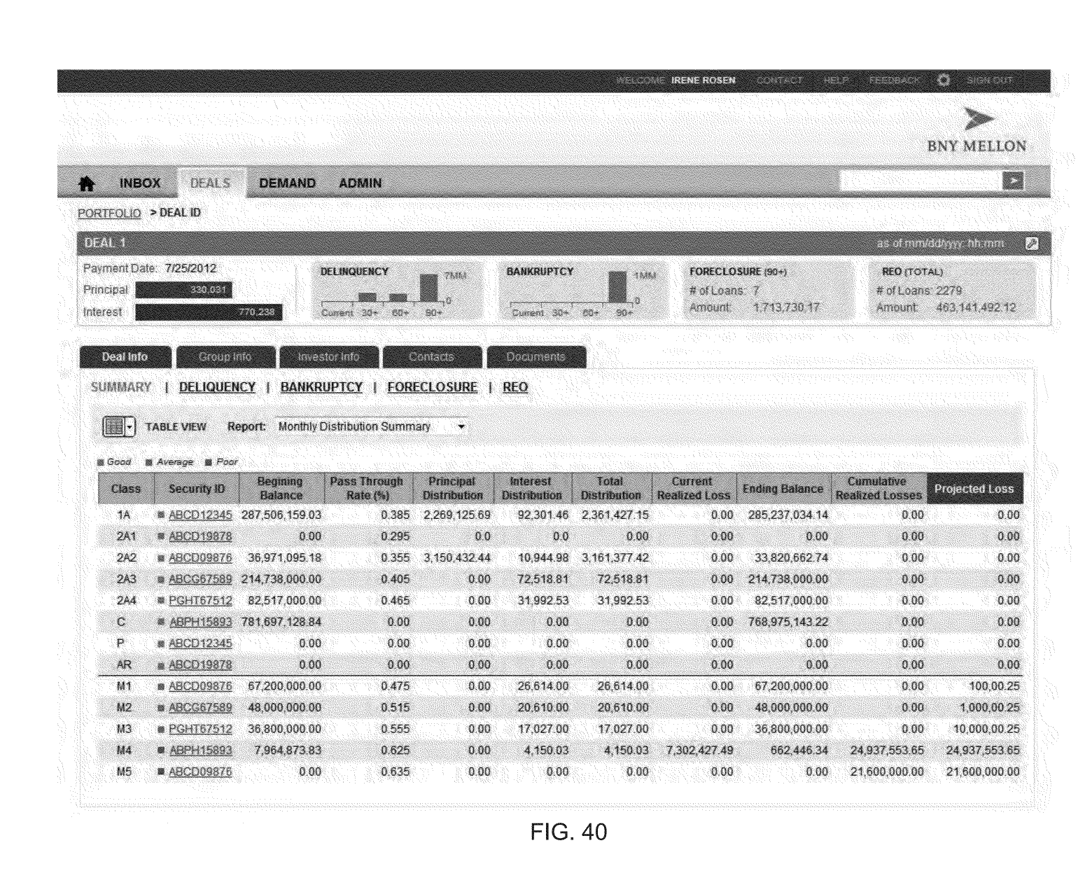

As shown in FIG. 39, the investor representative 340 may have access to a deals summary view, which may facilitate analysis of investments across associated investors. In an embodiment, the deals summary view may provide an overview of deal health (e.g., utilizing the Red Amber Green convention to display the results of the deal health analysis). By selecting a given deal, the deal summary information of FIG. 40 may be displayed. The deal summary information received by the investor representative 340 may include the securities associated with the particular deal, and selection thereof may present the security information such as is provided to other participants above.

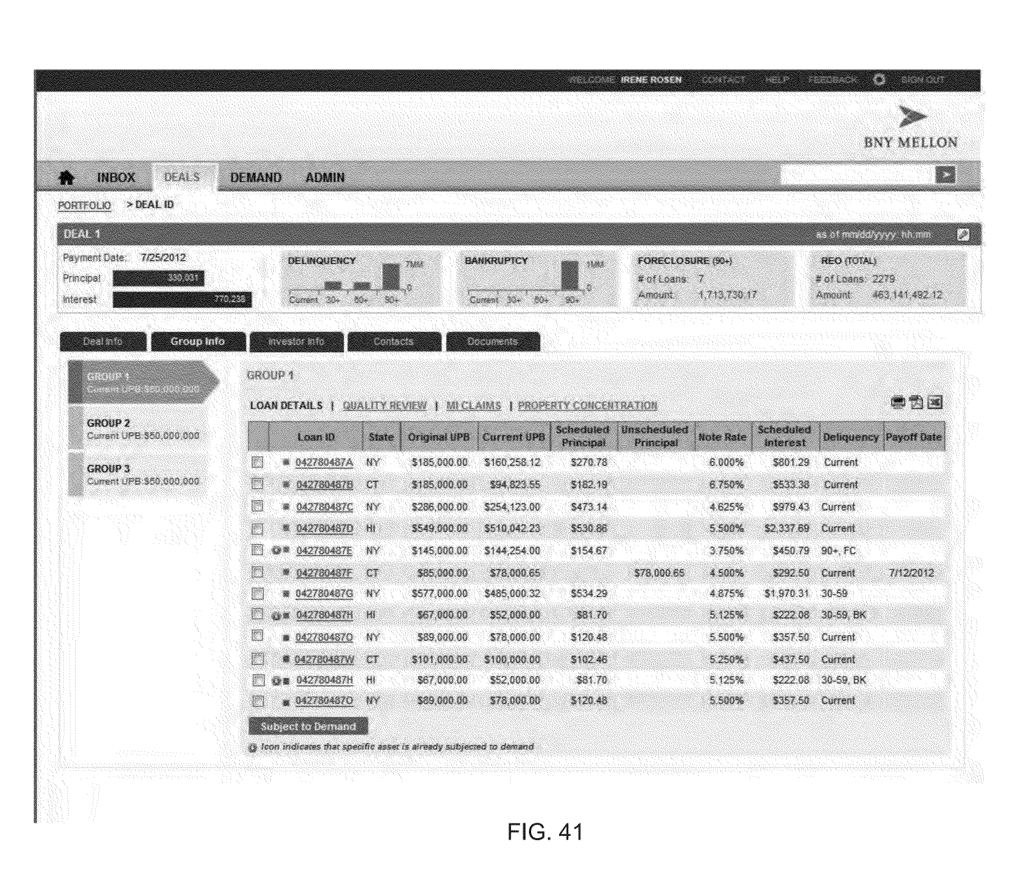

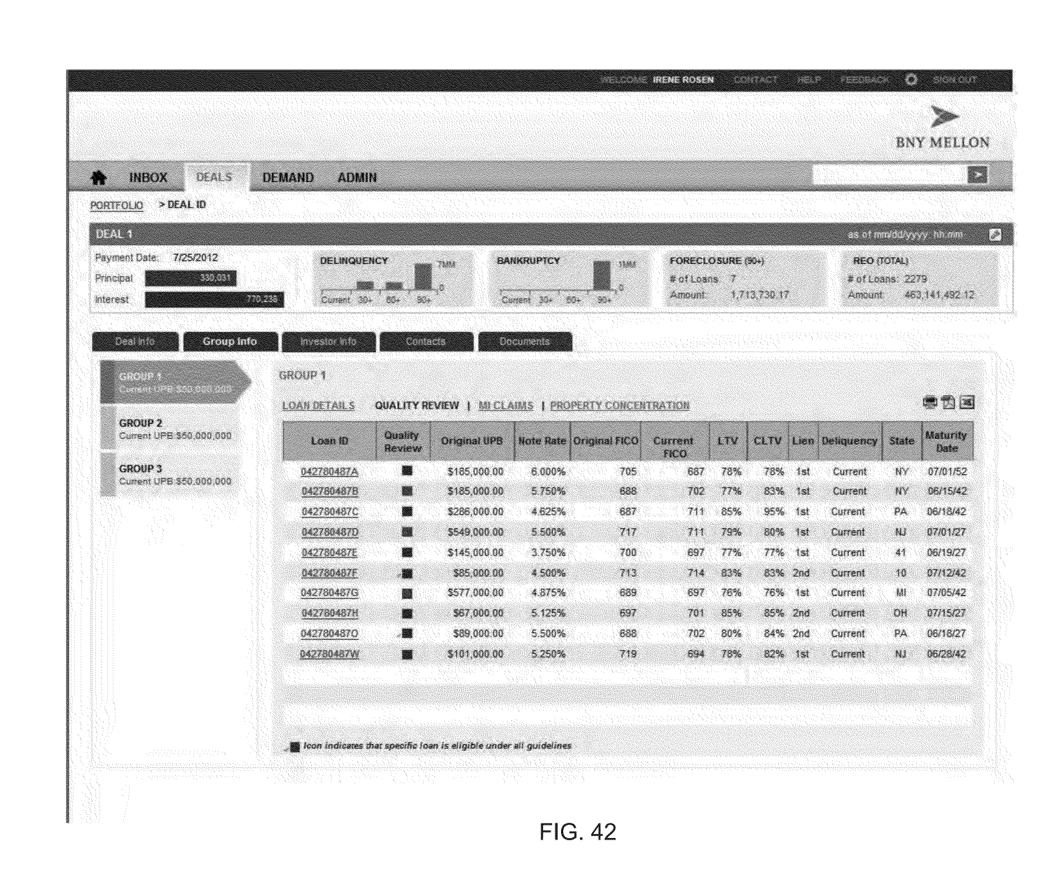

Group information may also be presented to the investor representative 340, such as by clicking Group Info from the Deal submenu. As shown in FIGS. 41 and 42, loan details and quality review information may be presented to the investor representative 340 for each group. It may be appreciated that mortgage insurance claims and property concentration, as described above, may additionally be presented to the investor representative 340.

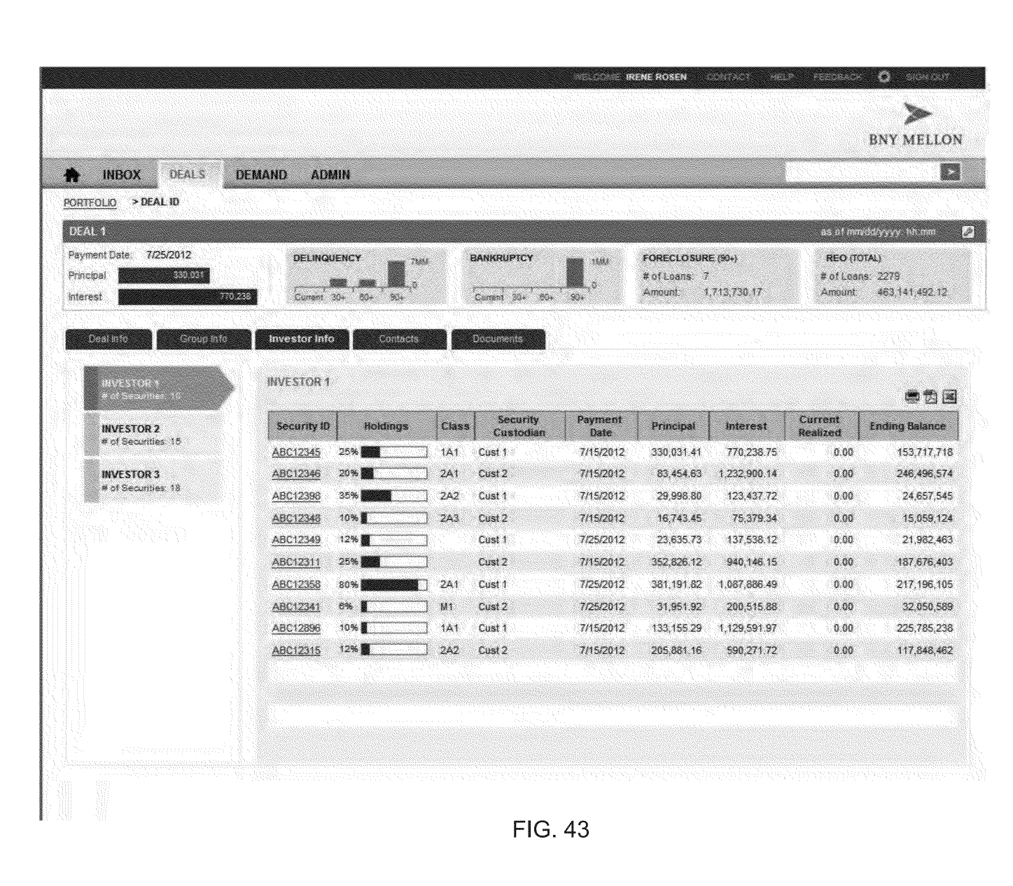

Investor information associated with the deal may also be presented to the investor representative 340, as shown in FIG. 43. In particular, the percent of holdings that a given investor has in a security may be displayed, as well as other financial metrics. While not illustrated again, it may be appreciated that in some embodiments contact information pertaining to the deal as well as deal documents may also be obtained through the “Contacts” and “Documents” tabs in the Deal submenu.

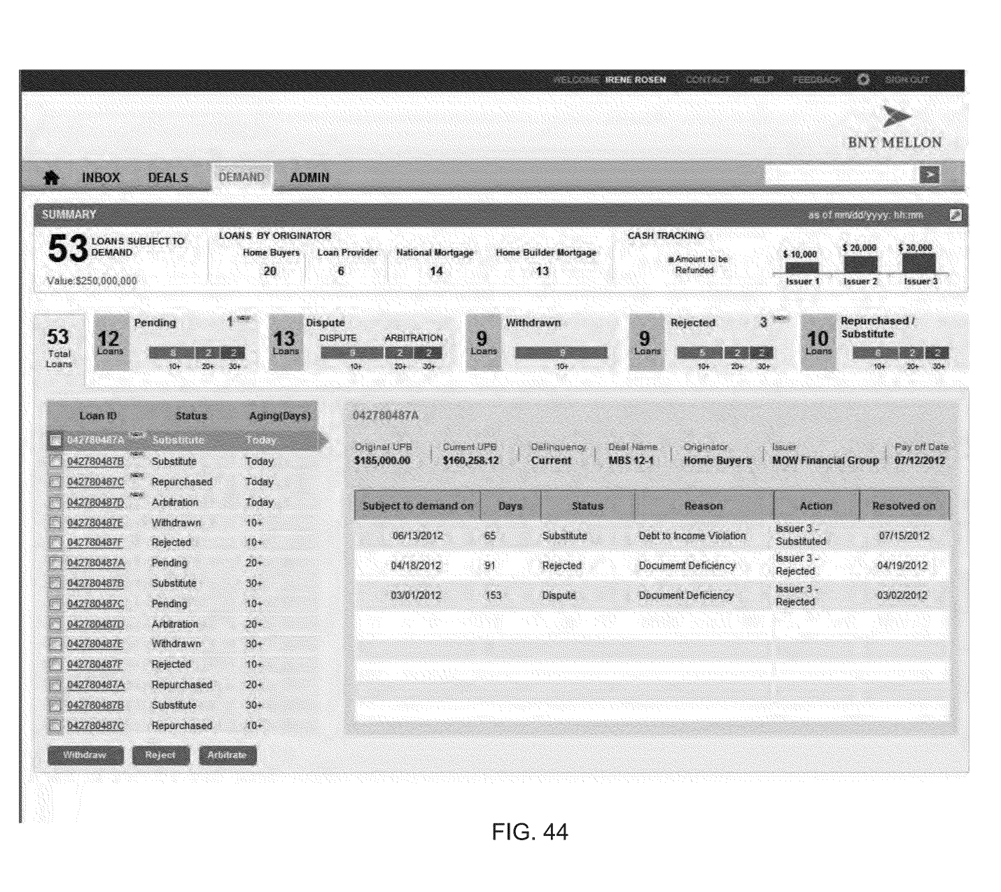

As shown in FIG. 44, the GUI of the utility may be configured to provide information to the investor representative 340 regarding loans subject to demand. Similar to the view of FIG. 37 for the investor 230, it may be appreciated that the subject loans may be identified, and details regarding the pending demand, or the existing demand, may be provided. Tracking information regarding pendency of demands, which loans are being disputed (or are being arbitrated), which loans have been withdrawn, which loans have been rejected, and which loans have been repurchased or substituted, may also be provided in an embodiment. In an embodiment the age since last action may be highlighted to emphasize which loans subject to demand are stagnating. It may be appreciated that where an investor representative 340 represents multiple investors 230, there may be added ability for the investor representative 340 to search by investor 230 to narrow the loans subject to demand that are presented in the demand screen.

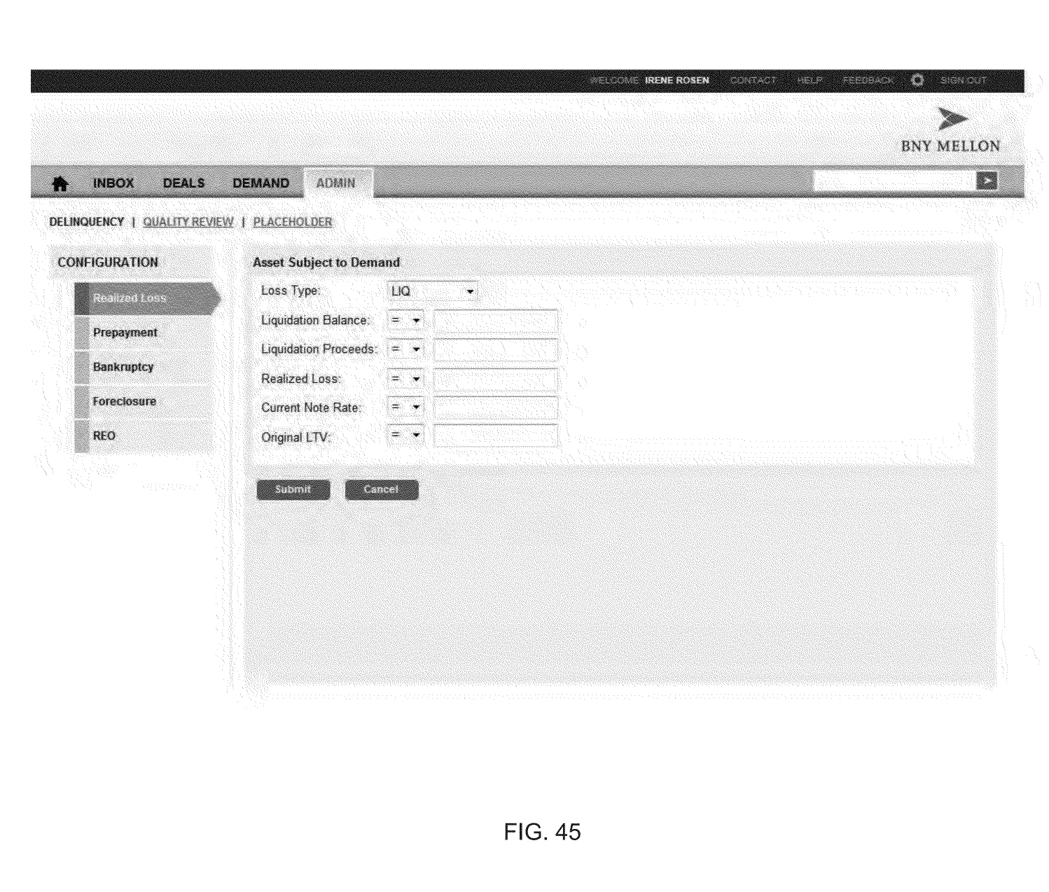

FIG. 45 illustrates an administration view for the investor representative 340. As shown, in an embodiment the investor representative 340 may modify or otherwise configure assets subject to demand. For example, the investor representative may establish that an asset having LIQ or MOD loss type, having defined characteristics, may be subject to demand. For example, in the illustrated embodiment, the administration view permits demand where the liquidation balance, liquidation proceeds, realized loss, current note rate, or original loan to value (LTV) selectively equals, is less than, or is greater than user defined values.

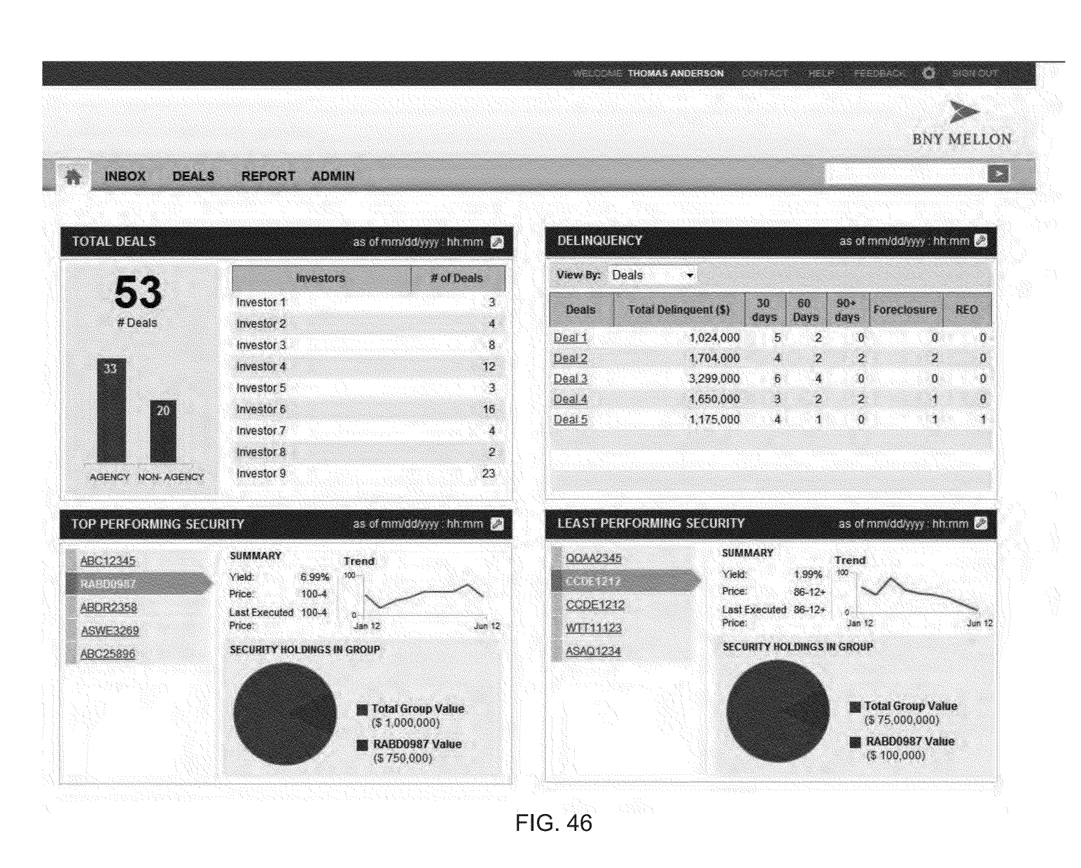

FIGS. 46-56 illustrate embodiments of views of the GUI associated with the transparency agent 350. It may be appreciated that the transparency agent 350 may provide portfolio views to issuers 260, investors 230, and program administrators to support risk assessment, counterparty exposure, and investment management processes. In some embodiments, the transparency agent 350 may be enabled to incorporate metrics such as performance data, independent pricing data, and current loan indicators into the portfolio views. The transparency agent 350 may therefore be enabled to aggregate information from various participants in the infrastructure 100 and sources associated therewith, which may be utilized by these and other participants, including for example, asset management 220. The transparency agent 350 may further create scorecards and dashboards according to various metrics to highlight performance in the infrastructure 100. As an example, in an embodiment the transparency agent 350 may report on affordable housing initiatives, by comparing actual loan attributes and performance to program requirements to gauge if the initiatives are meeting their goals. In addition, transparency agent 350 could capture emerging and new requirements like the risk retention elements introduced by recent regulatory actions. Investors 230 and regulators 320 alike may benefit from the assurance that the issuer 260 is maintaining the proper investment, while the issuer 260 may also benefit from an independent verification of their holdings. It may be appreciated that this example of a very specific deployment of the flexible reporting capabilities of the transparency agent 350 is only exemplary, and wider applications of such reporting might be realized in the private market.

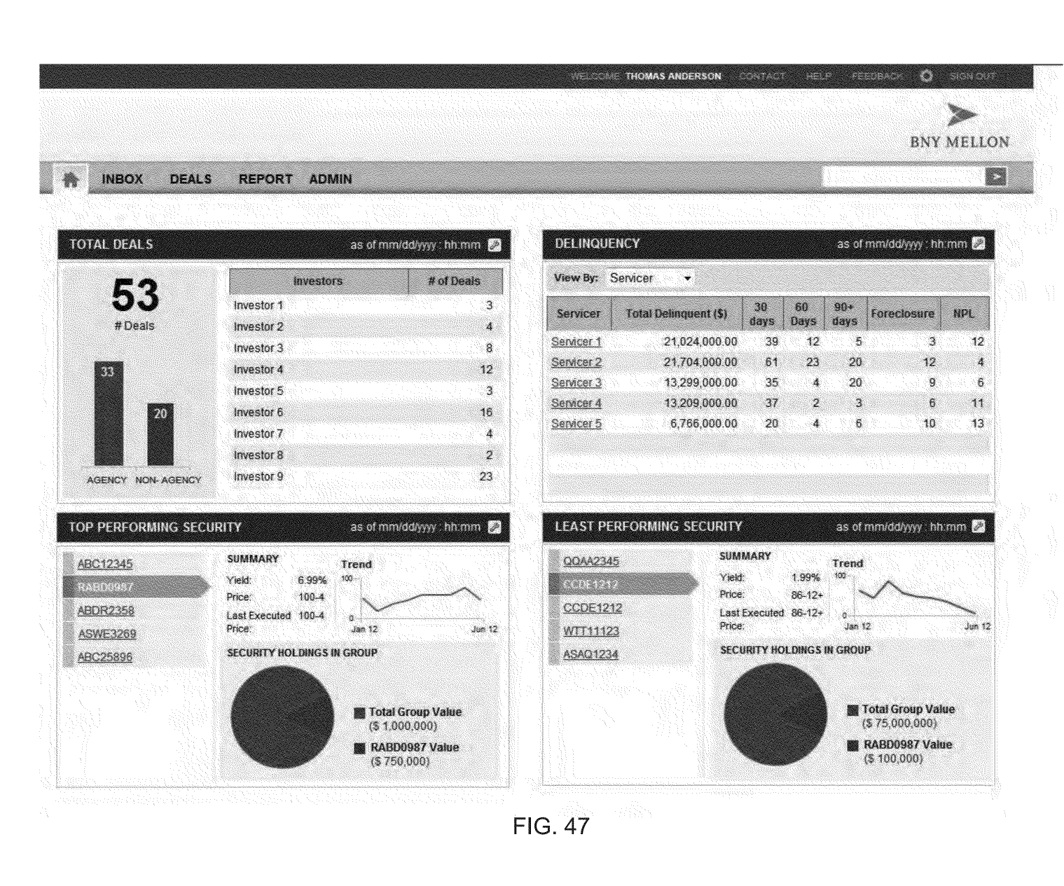

As shown in FIGS. 46 and 47, the homepage dashboard of the transparency agent 350 may include deal summaries, which may be broken down by investors 230. Analysis of the top performing securities and the least performing securities may also be displayed. Further, delinquency may be viewed either by deal or by servicer.

While the transparency agent 350 may also have an inbox available through the GUI, it may be appreciated that the inbox may in some embodiments be similar to that of the issuer 260, or may be simpler, allowing for receiving and sending messages associated with performance of the duties of the transparency agent 350.

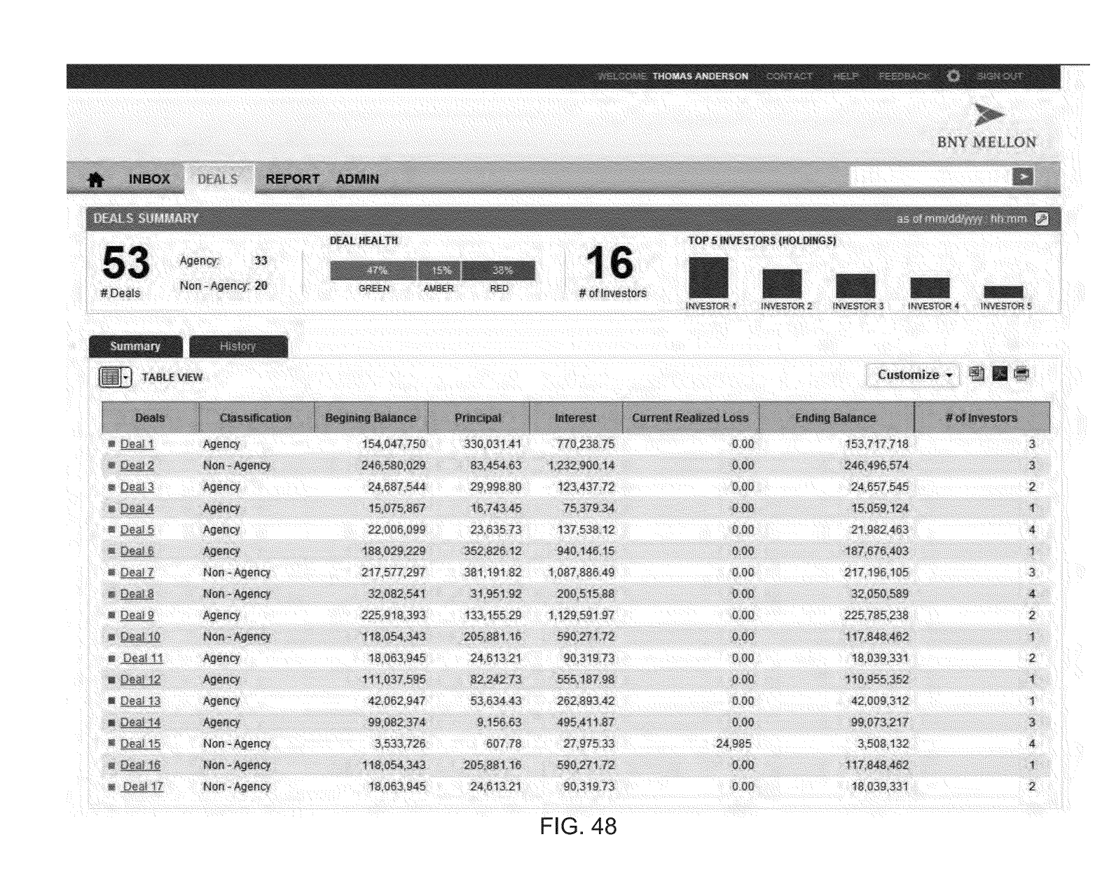

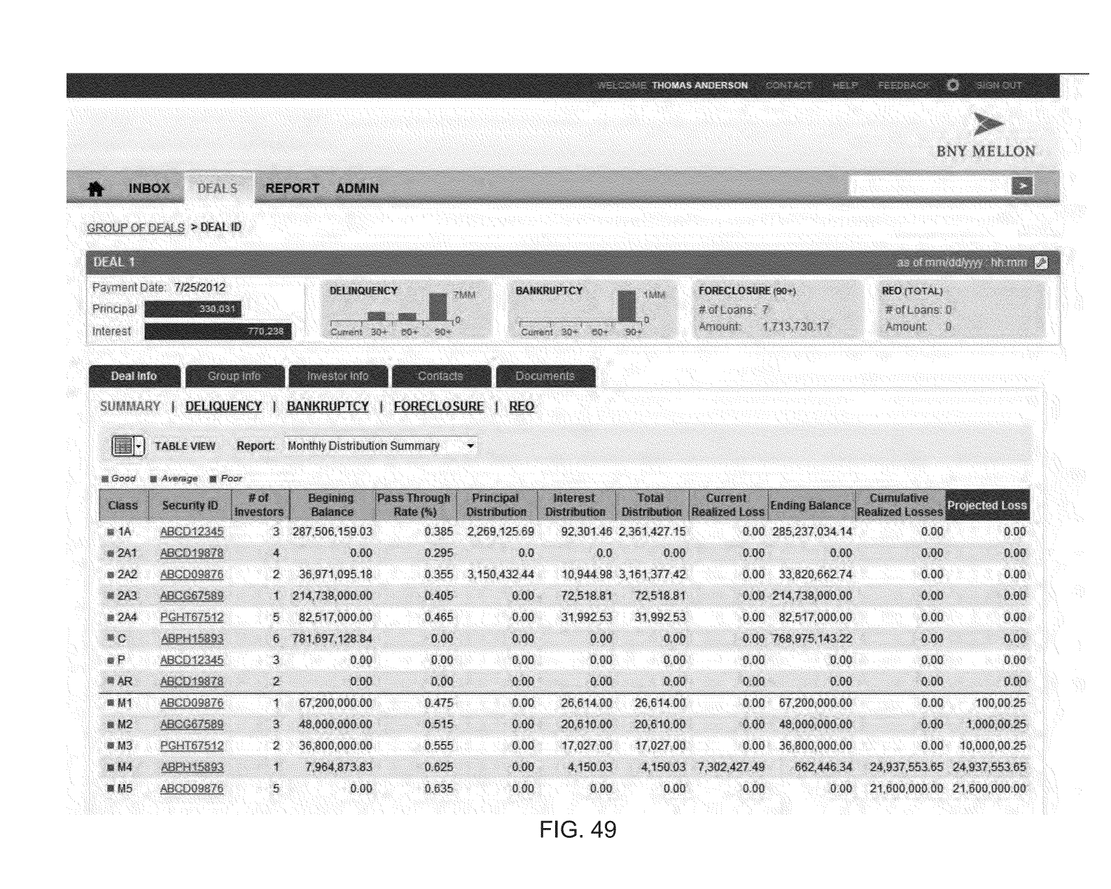

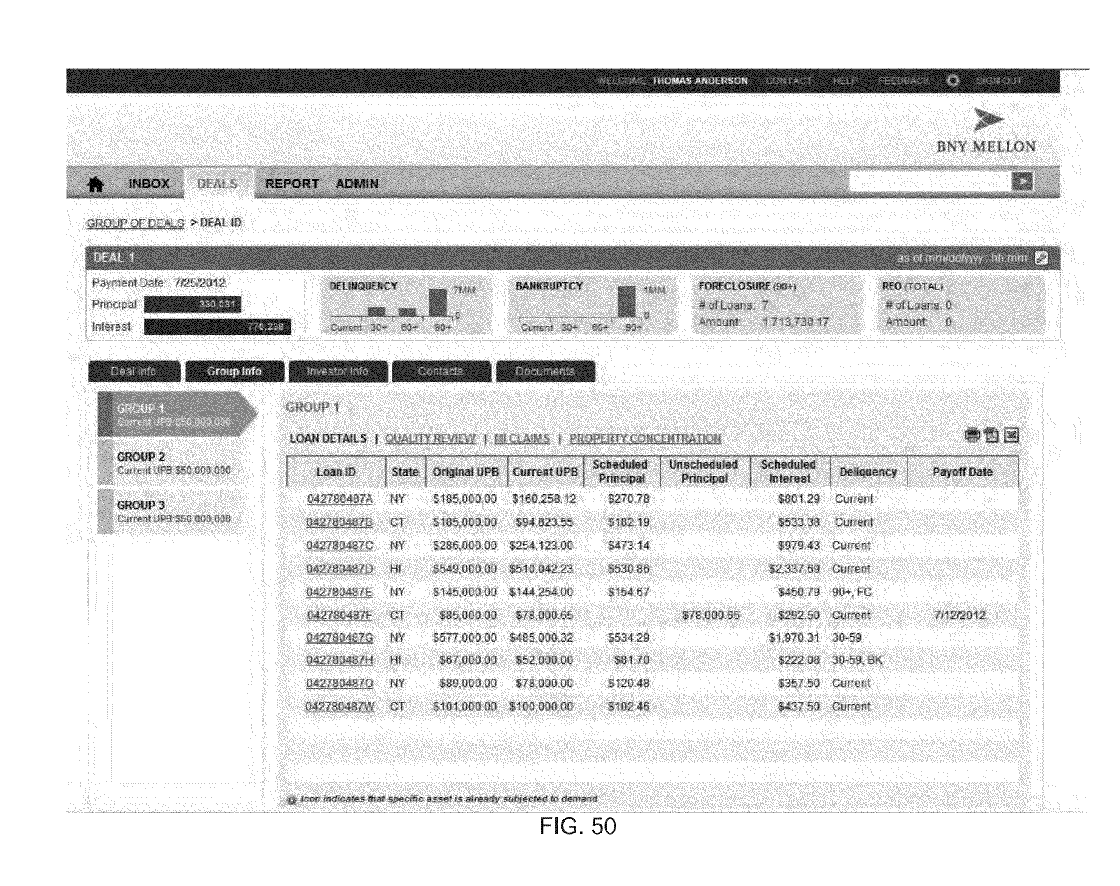

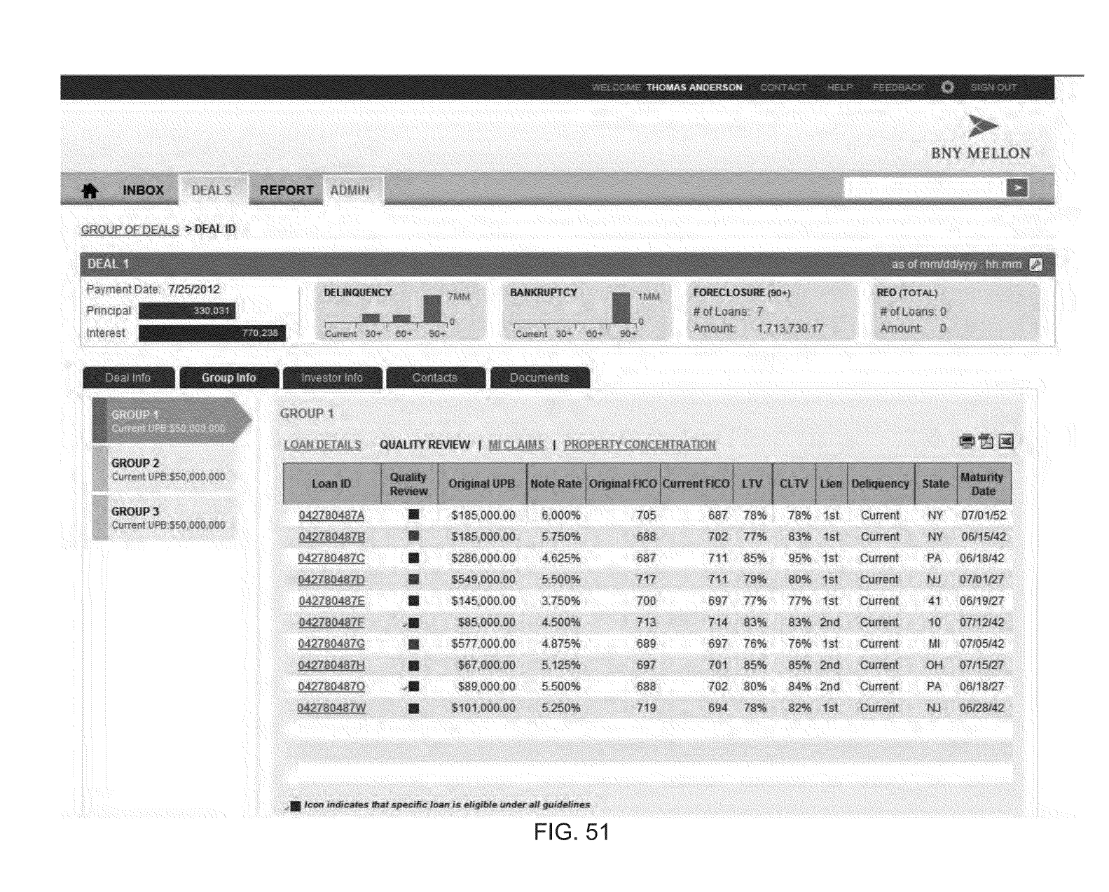

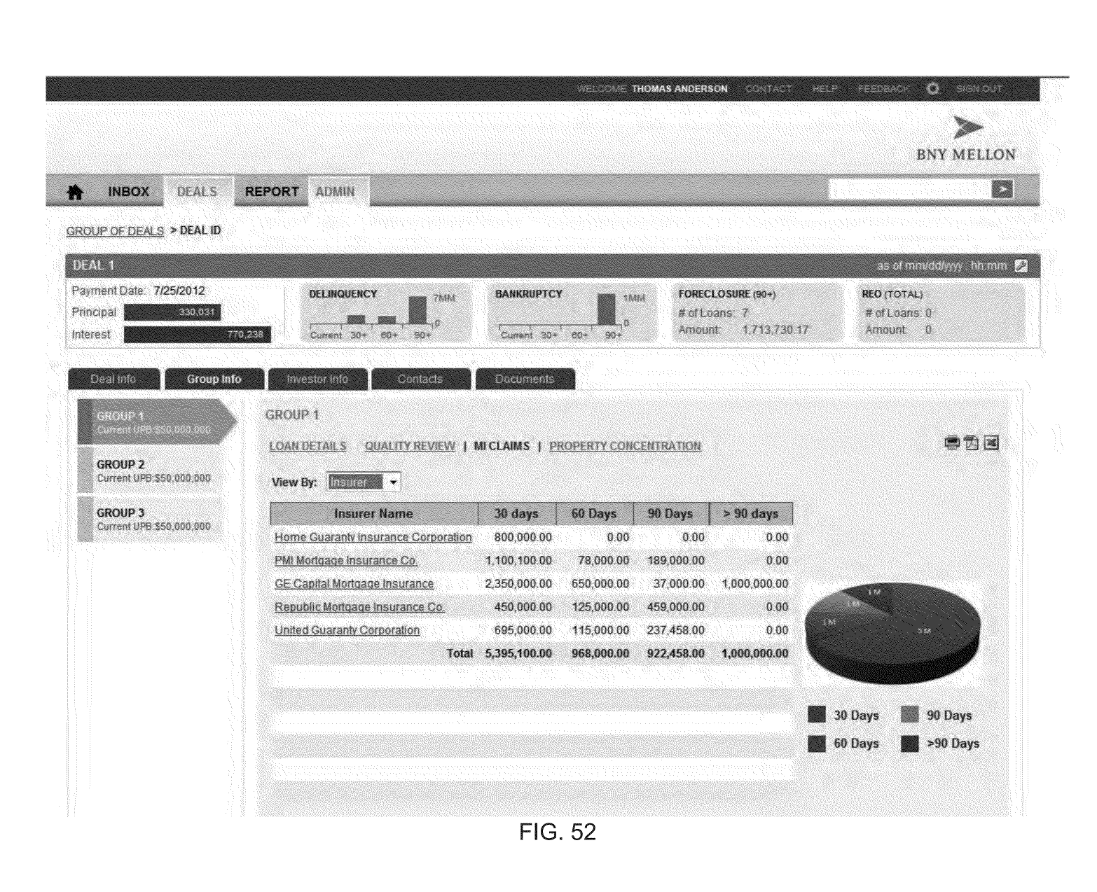

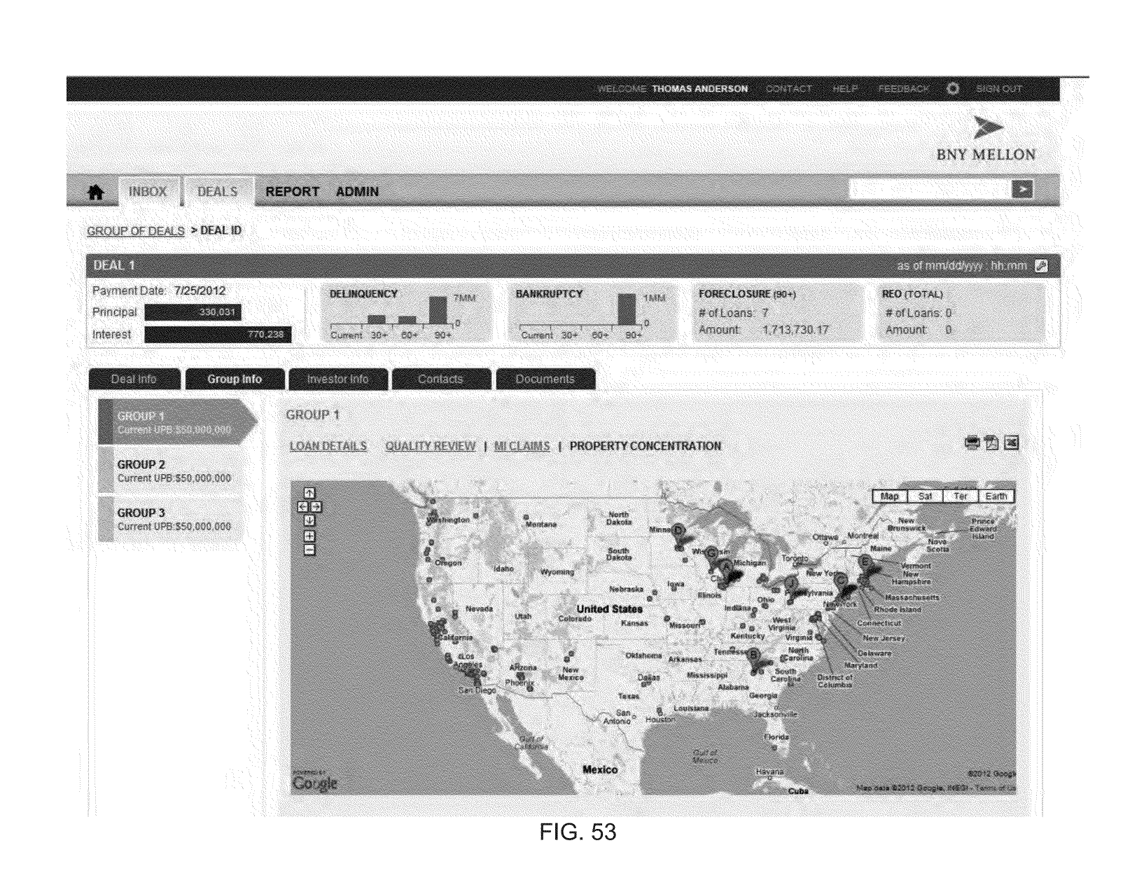

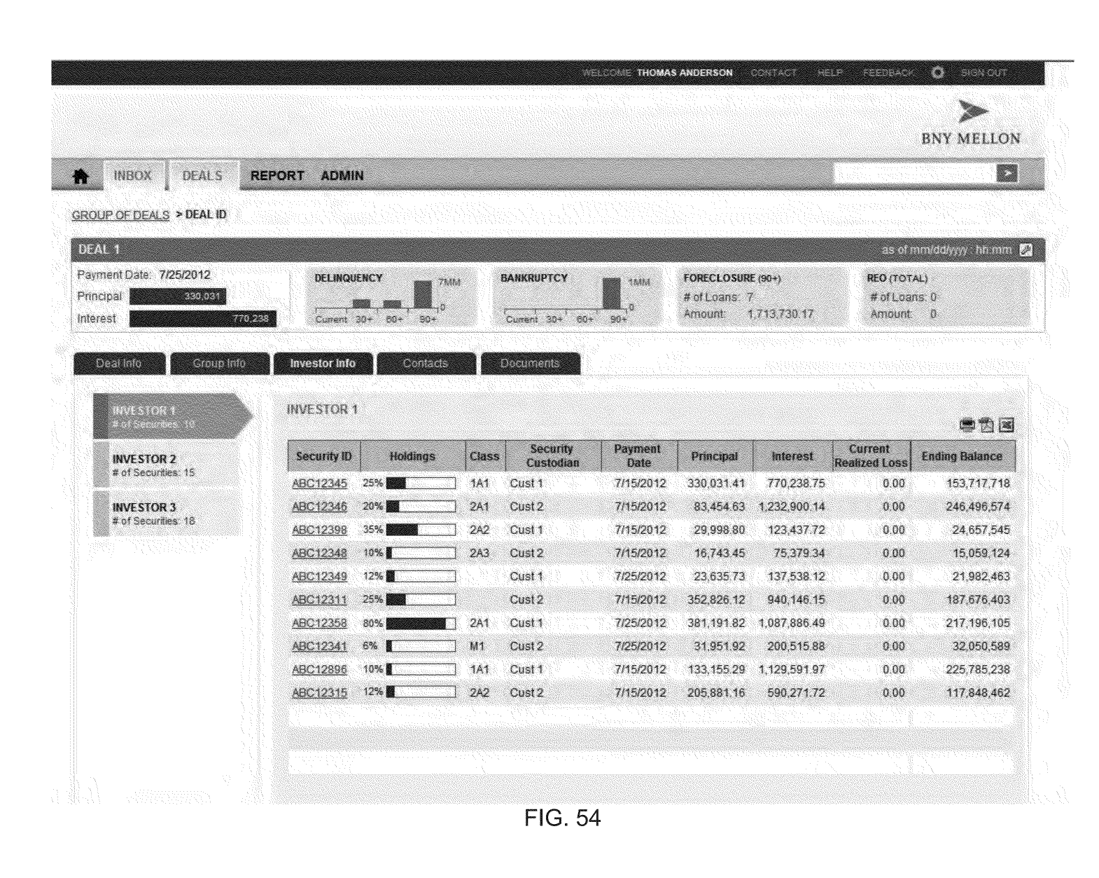

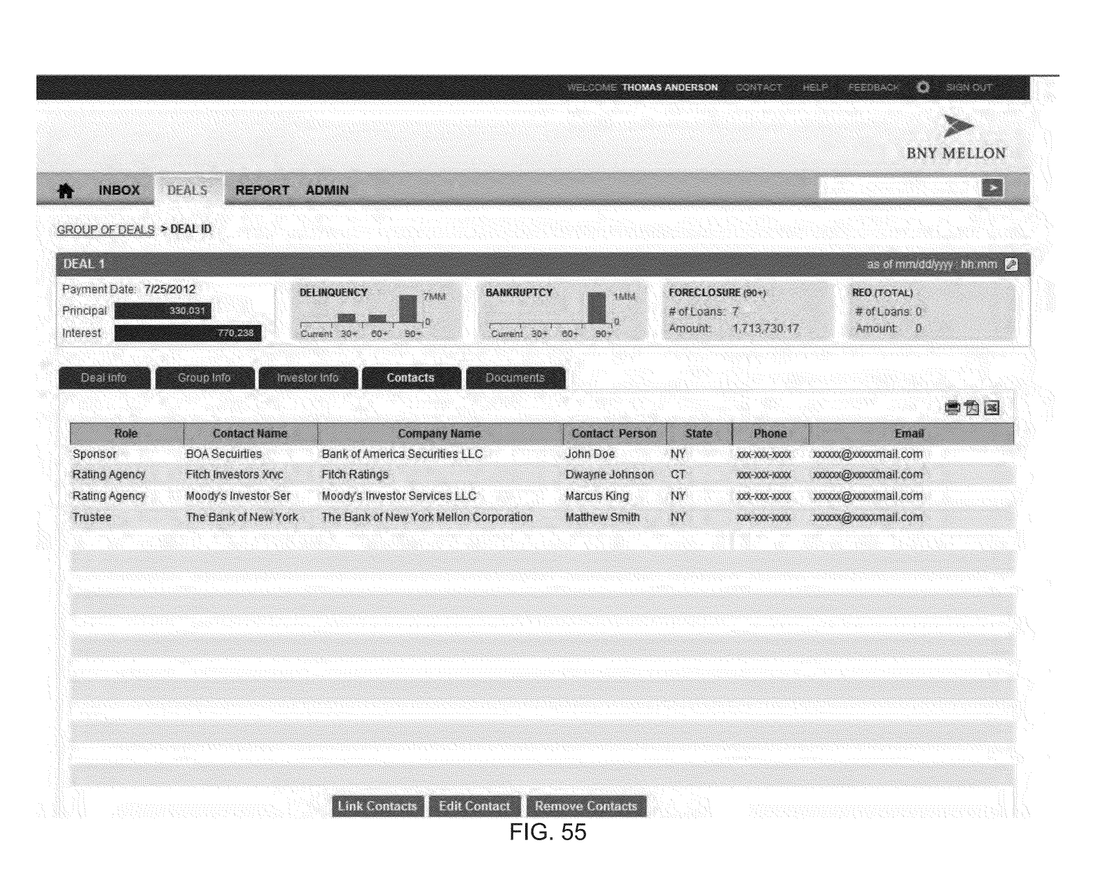

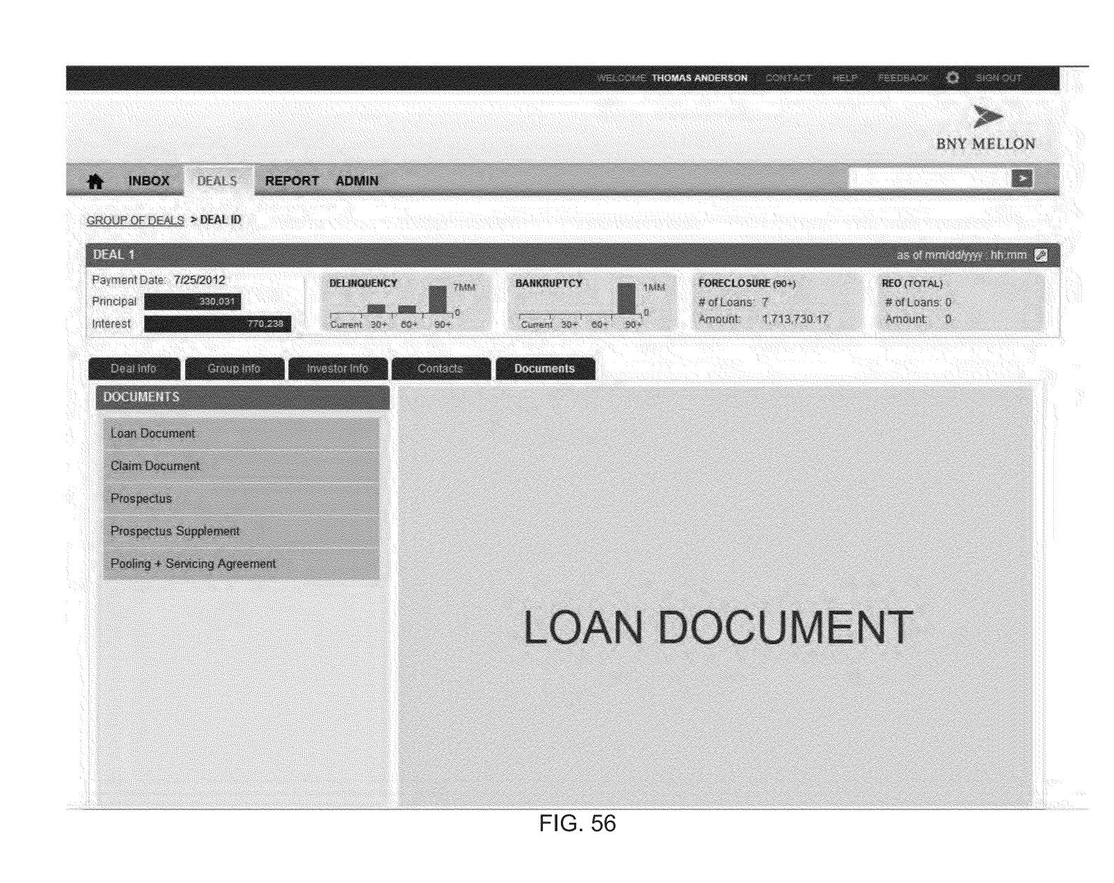

By selecting “Deals” from the main selection bar, the associated deals may be summarized, as shown in FIG. 48. It may be appreciated that the deals visible to the transparency agent 350 may be the same as those visible to the investor representative 340 (e.g., as shown in FIG. 39) in some embodiments. In other embodiments, where different investor representatives 340 and transparency agents 350 are responsible for different deals, the data presented to each may differ. By selecting a given deal, the securities associated therewith may be viewed by the transparency agent 350, as shown in FIG. 49. As shown, the securities information may again be similar to that shown to the investor representative 340 (e.g., as shown in FIG. 40) in some embodiments. Likewise, loan details in the group information, shown in FIG. 50, may be similar to that shown to the investor representative 340 in FIG. 41, however without an ability to denote that certain loans are subject to demand. It may be appreciated that the quality review, shown in FIG. 51, as well as the mortgage insurance claims shown in FIG. 52 and property concentration information shown in FIG. 53, may also be similar to those presented to the investor representative 340. As shown in FIGS. 54-56, investor information (FIG. 54), contact information (FIG. 55), and documentation associated with each deal (FIG. 56) may also be accessed by the transparency agent 350, again similar to what may be accessed by the investor representative 340, and other participants, as described above.

It may be appreciated that in some embodiments the utility coupled to the CDI 360 may provide other functions associated with the infrastructure 100. For example, in an embodiment the utility may comprise an issuance utility that may support management of new securitizations for the issuers 260 (e.g., both the agency and private market).

In an embodiment, a grouping component of the issuance utility may be configured to facilitate verification that loans being pooled for a security fit current market standards or guidelines. In an embodiment, such verification against market standards or guidelines may additionally or alternatively be available during a whole loan purchase or sale. In an embodiment, the grouping component may also allow the issuers 260 to see a portfolio of loans assigned thereto for securitization, purchase, or sale from various parties. The issuers 260 may therefore utilize the utility to determine which loans out of the pool of loans would be in a pool for securitization, purchase or sale. In an embodiment, the utility will facilitate the issuers 260 to match their records with the records of the custodian (e.g., the custodian 240), to ensure that the collateral is in place prior to issuance of the security or the whole loan purchase/sale.

In an embodiment, the utility may additionally or alternatively include an issuance component which may facilitate communication between the issuer 260 and a depositor for the issuance of securities and whole loan purchases/sales. In an embodiment, an agency issuer 260 may confirm loan delivery and validations on the files associated with the loan. In some embodiments, a private market issuer 260 may request an initial file status, and/or may obtain status updates over a period of time. In an embodiment, the agency issuer 260 may provide at issuance pool stratification disclosure via the utility. It may be appreciated that the private market issuer 260 may utilize the utility to obtain pre-issuance prospectus information in some embodiments.

In some embodiments, the utility may include a payment component, which may be configured to allow the agency's agent, a private market issue 260, or the agent of the private market issuer 260 the ability to release or instruct the release of payments to bondholders, stakeholders, or investors. In an embodiment, the utility may be configured to facilitate calculation of bond payments by the issuers 260. In an embodiment, the utility may facilitate verification of payment amounts due by the issuers 260. In some embodiments, the utility may be configured to facilitate reconciliation of received cash payment amounts on behalf of the trusts as they relate to the receipt of funds related to repurchased loans.

As described above, in some embodiments, the utility may be coupled to a CDI 360. Accordingly, in an embodiment, the utility may include a data warehouse/CDI component configured to allow information on individual loans to be stored prior to and/or following securitization and whole loan sales/purchases. In an embodiment, data and loan characteristics associated with pooling may be leveraged to provide detailed reporting on transactions and portfolios. In an embodiment, the data warehouse/CDI component may be configured to allow the issuers 260 to see grouping rules/requirements which may be stored in database storage associated with the data warehouse/CDI.

In an embodiment, the utility may be configured to support tracking of collateral for the issuers 260 (including agency and private market issuers). In an embodiment, tracking of collateral across various custodians 240 by the issuers 260 may be accomplished by one of a variety of components of the utility. For example, in an embodiment, the utility may comprise a reconciliation feature. In an embodiment, the utility may additionally or alternatively comprise a historical database. In an embodiment, the utility may additionally or alternatively be configured to track collateral files. Embodiments of each of these features are described in greater detail below. It may be appreciated that in some embodiments the components of the utility may be configured alternatively for basic or advanced users (e.g., providing enhanced functionality to the advanced users). For example, in an embodiment, the basic functionality may allow the issuers 260 (e.g., the agency and/or private market issuers) to use the system for intermittent (e.g., one-time) or scheduled reconciliation of the location of their collateral. In an embodiment, enhanced service may facilitate ongoing reconciliation and/or reporting of collateral by the agency and/or private market issuers 260.

In an embodiment, the reconciliation feature of the utility may be configured to facilitate reconciliation of collateral by issuers 260. In an embodiment, issuers 260 and custodians 240 may load their files into the utility (e.g., through the graphical user interface and via a computer network). Once the files are loaded, the issuers 260 may be able to execute a module to produce a report indicating discrepancies between the list of the issuer 260 and the list of the custodian 240. As an example, if the collateral is reported as being at a first custodian 240, but the list (or a similar generated report) of the first custodian 240 indicates that the collateral is not in the possession of the collateral, the utility may indicate the missing collateral or breaks as an exception. It may be appreciated that the missing or otherwise unmatched collateral may be caused by a number of reasons, including but not limited to the loan being indicated as having been released, the loan indicating having been paid in full, and/or the custodian 240 indicating that it is not presently and/or was never in possession of the collateral. In an embodiment, the issuers 260 may subsequently be able to reconcile discrepancies with the custodian 240, to attempt to locate the unmatched loan. In an embodiment, the utility may be configured so that the issuers 260 may generate reports on any frequency schedule, including but not limited to daily, weekly, monthly, quarterly, annually, and/or combinations or permutations thereof. In an embodiment, the utility may be configured to allow issuers 260 to request assistance reconciling loan files from other participants utilizing the utility, including, for example, the custodians 240.

As noted above, in an embodiment the utility may comprise (or otherwise link to) a historical database. It may be appreciated that the historical database may be configured to store each loan's movement from origination through loan disposition. In an embodiment, the database may store such data in a centralized location accessible by a plurality of parties utilizing the utility. In an embodiment, loans may be tracked by location as they are moved, so previous custodians 240 are identified. It may be appreciated that such tracking may establish a history of the loan beyond the loan's current location. In an embodiment, the historical database component of the utility may allow issuers 260 to see which custodian 240 currently possesses the loan, and which custodians 240 previously possessed the loan. Additionally, the database may store the iterations of loan identifiers assigned to the single loan throughout its lifetime, as conveyed to the utility. Additionally, issuers 260 may be able to filter the loans by custodian 240 vault locations. In an embodiment, the database might not provide detail about the quality of the loan (e.g., qualified mortgage (QM), qualified residential mortgage (QRM) or ability to repay qualifications). In other embodiments, such detail may be provided.

As further noted above, in an embodiment the utility may be configured to track components of the collateral file (e.g., mortgage notes). In an embodiment such tracking may be accomplished by aggregating reports delivered by the primary custodian 240 (e.g., detailing the state of the file). Such details may include indicating the file being complete, indicating documents needed for the file, documents needing to be updated, and so on. In an embodiment, the utility may produce a report for issuers 260 detailing missing documentation (e.g., as exceptions), so that the issuers 260 may work with the custodians 240 to reconcile and clear exceptions. In an embodiment, the utility may therefore provide a central location for issuers to track loan file exceptions and review securitization transactions.

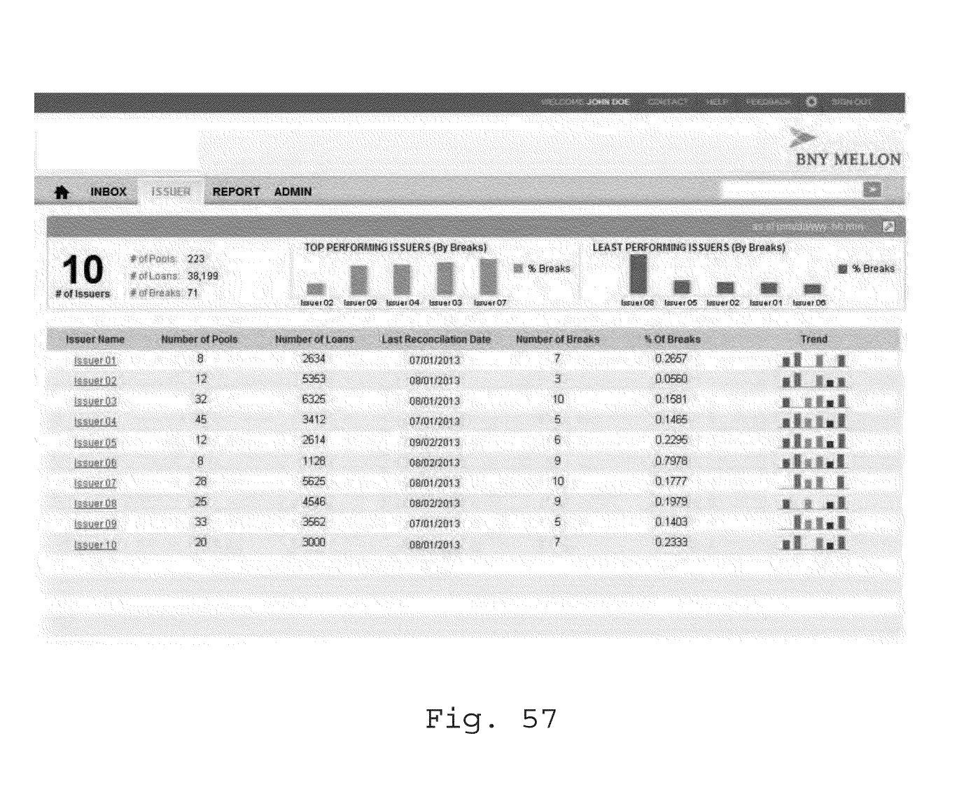

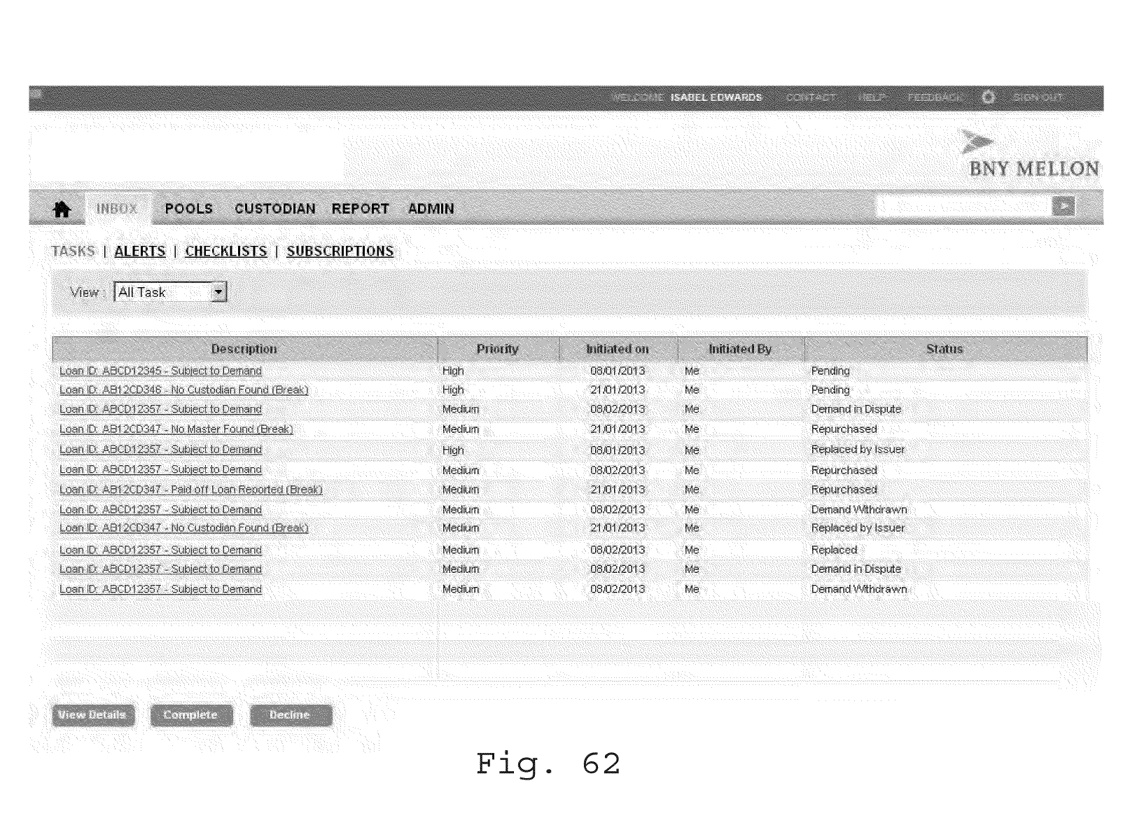

It may be appreciated that the functionality of the utility to facilitate engagement between custodians 240 and issuers 260, such as that described above, may be implemented through a graphical user interface provided over a computer terminal. Along with loan level messaging, printed reports can be produced or viewed over a computer terminal. FIGS. 57-61 depict various aspects of an embodiment of the graphical user interface associated with the custodians 240. Likewise, FIGS. 62-70 depict additional aspects of the graphical user interface which may be associated with the issuers 260 in some embodiments.

FIG. 57, for example, illustrates a user interface of the utility for a custodian 240, which shows a list of issuers 260 associated therewith. In an embodiment, analytical data associated with the issuers 260 may be presented, including data comparing the issuers 260 and/or data associated with each issuer 260. For example, in the illustrated embodiment of FIG. 57, performances of issuers are compared by breaks, while trend information for each issuer is also graphically depicted. As shown, the number of breaks along with the percentage of breaks compared to the total number of loans for each issuer may be listed. In an embodiment, the number of pools associated with each issuer may also be depicted, as well as the number of loans. Further, in an embodiment the last reconciliation date between the issuer 260 and the custodian 240 is also illustrated.

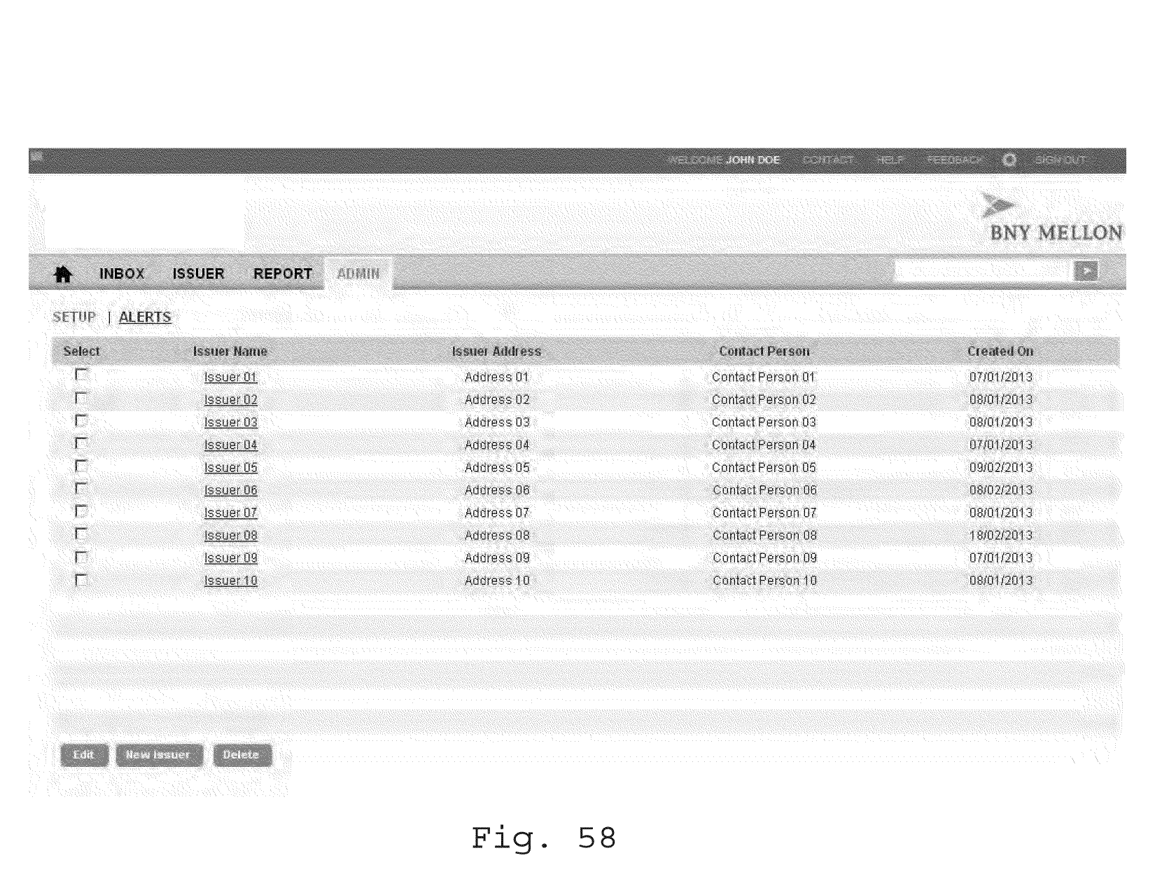

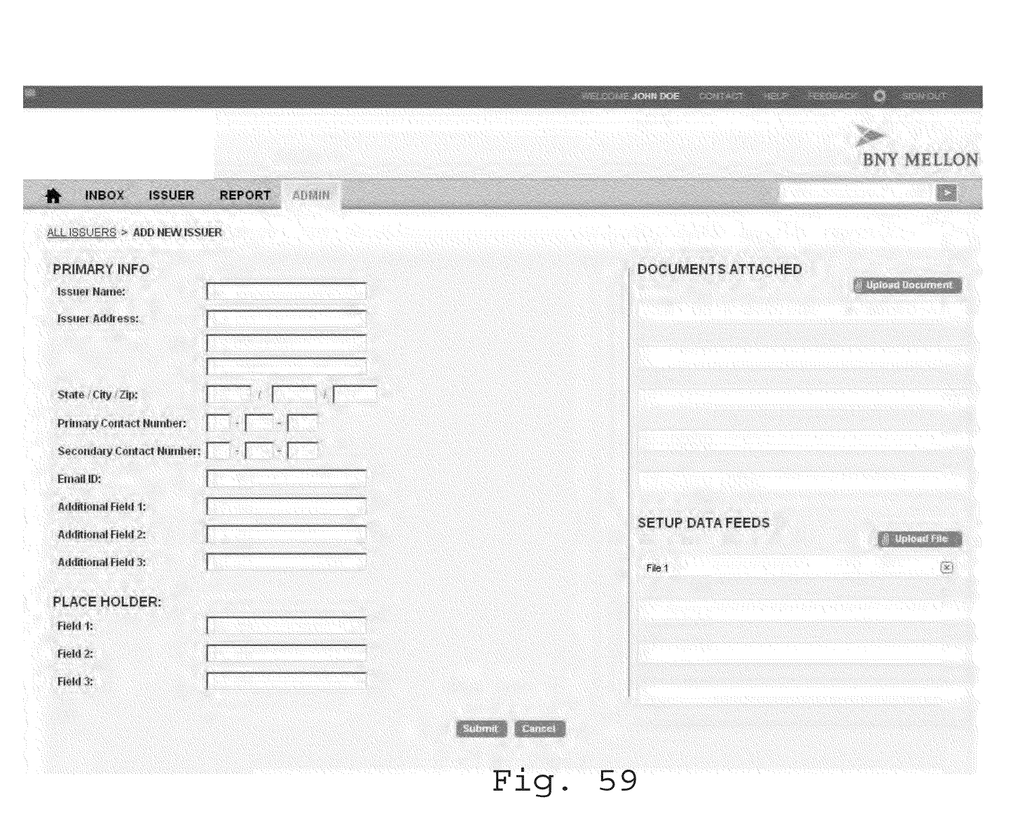

As shown in FIGS. 58 and 59, in an embodiment the administrator may administer the issuers 260 associated therewith. For example, in FIG. 58, an embodiment of an administration screen for the issuers 260 is depicted, where new issuers 260 can be added, and existing issuers 260 may be deleted. Additionally, information for selected issuers 260 may be edited, as shown. FIG. 59 shows an embodiment of a user interface depicting addition of new issuers 260. In an embodiment, selecting “New Issuer” or a similar interface element on the administration screen may bring up an interface such as that in FIG. 59. As shown, issuer information (including but not limited to names, addresses, contact numbers, and additional fields) may be filled in to add a new issuer 260 associated with the custodian 240. Additionally, documents and/or data feeds may be uploaded and associated with the issuer 260 being added. Additionally, this user interface can be used depicting addition of new custodians 240.

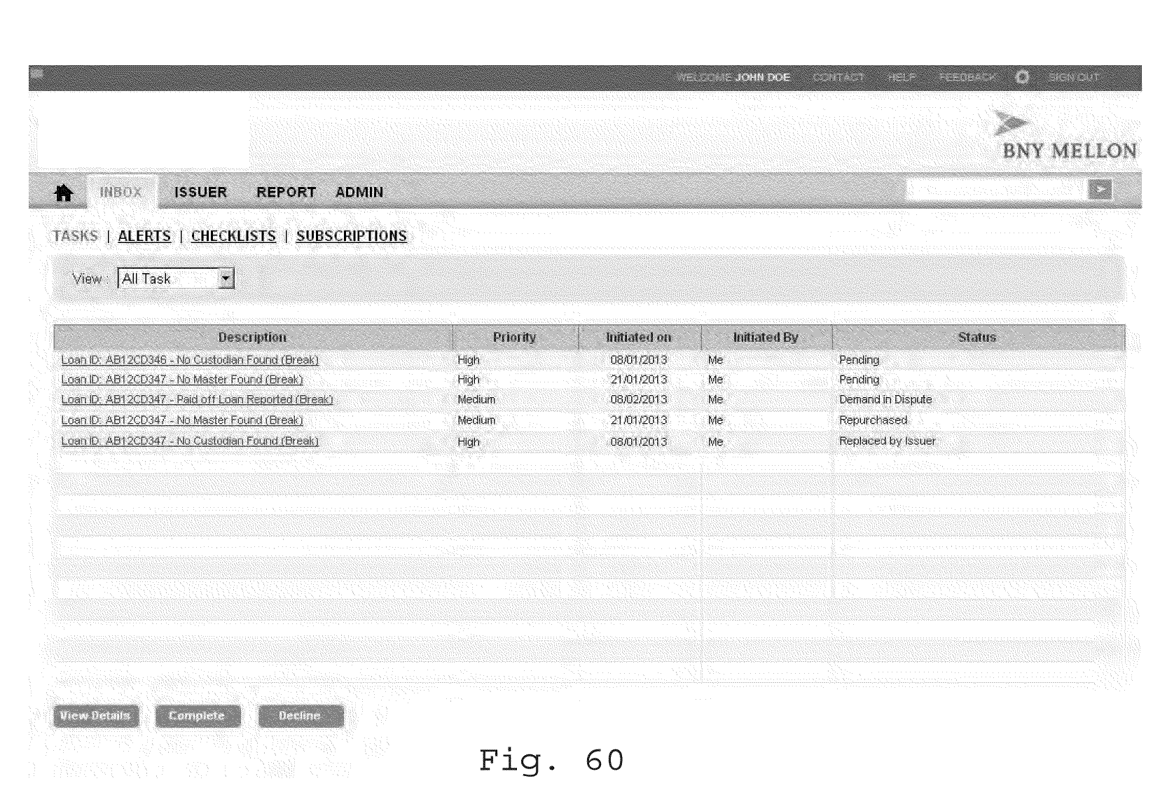

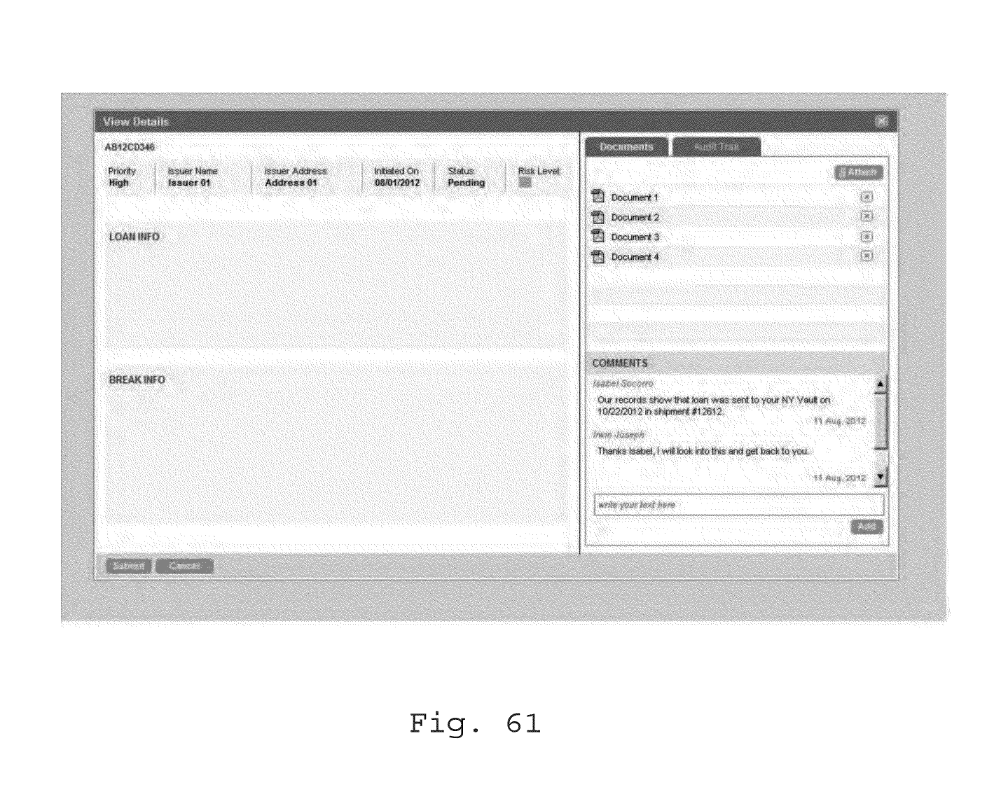

FIG. 60 depicts an inbox associated with the custodian 240, allowing the custodian 240 to receive details regarding breaks associated with the loans in custody. For example, in an embodiment, the inbox may describe the reason for the break (including, for example, custodians or masters not being found for particular loans, or the reporting or a loan being paid in full). As shown, in an embodiment the breaks may be prioritized, and the status of the action to be taken in connection with the loan listed as well. For example (but not exclusively), in an embodiment the loan may be replaced by an issuer, or the loan may be repurchased. These statuses and break descriptions are merely exemplary, and other tasks may be found in various embodiments. As shown in FIG. 61, in an embodiment selecting a particular task/break in the inbox may provide additional details regarding the break. For example, a risk assessment may be associated with the break. Further, comments from various participants associated with the break may be recorded and transmitted with the break information to the custodian 240. As shown, in some embodiments documents associated with the loan, which may facilitate resolution of the break, may be included with the break information, and may be viewed, added, and/or deleted by the custodian 240 during processing of the break.

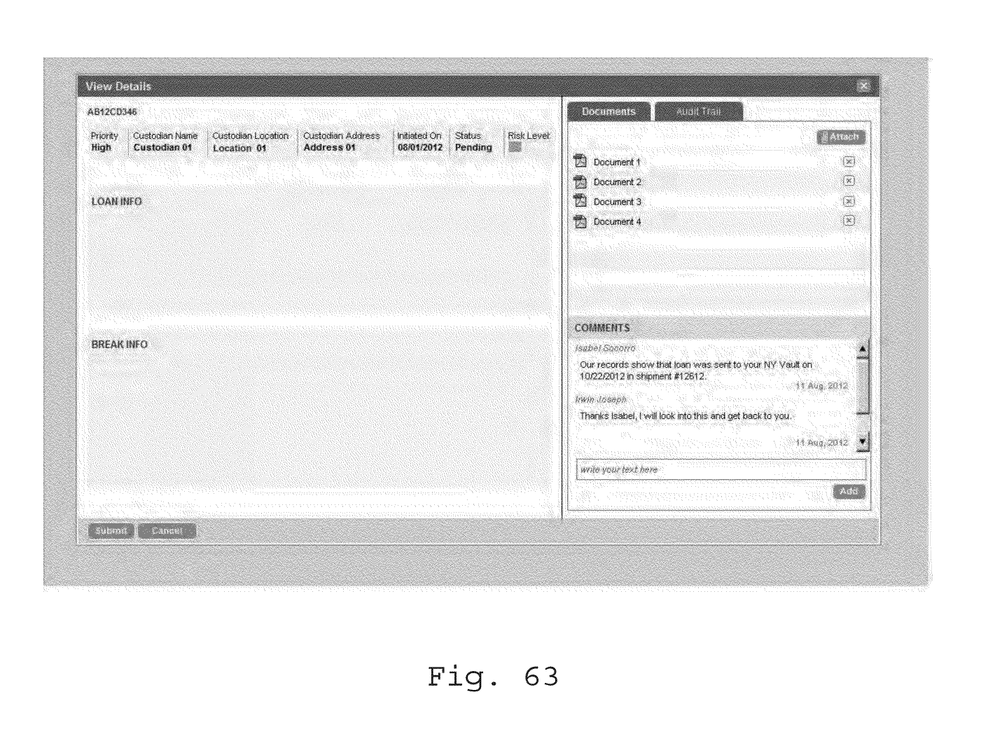

As noted above, FIGS. 62-70 illustrate embodiments of views associated with the issuers 260. Specifically, the views of FIGS. 62-70 may be associated with coordination between the issuer 260 and the custodians 240. For example, as shown in FIG. 62, an inbox associated with the issuer 260 may be similar to that described above for the custodian 240, showing the status of various loans, including for example, those with breaks associated therewith. Again, in an embodiment the tasks associated with each loan may be prioritized, and the status of the task/break may be displayed. As shown in FIG. 63, by selecting a task/break, additional details may be provided. In an embodiment, the details provided may be similar to that for the custodian 240, however providing information for the associated custodian 240 for the loan, instead of providing information for the issuer 260.

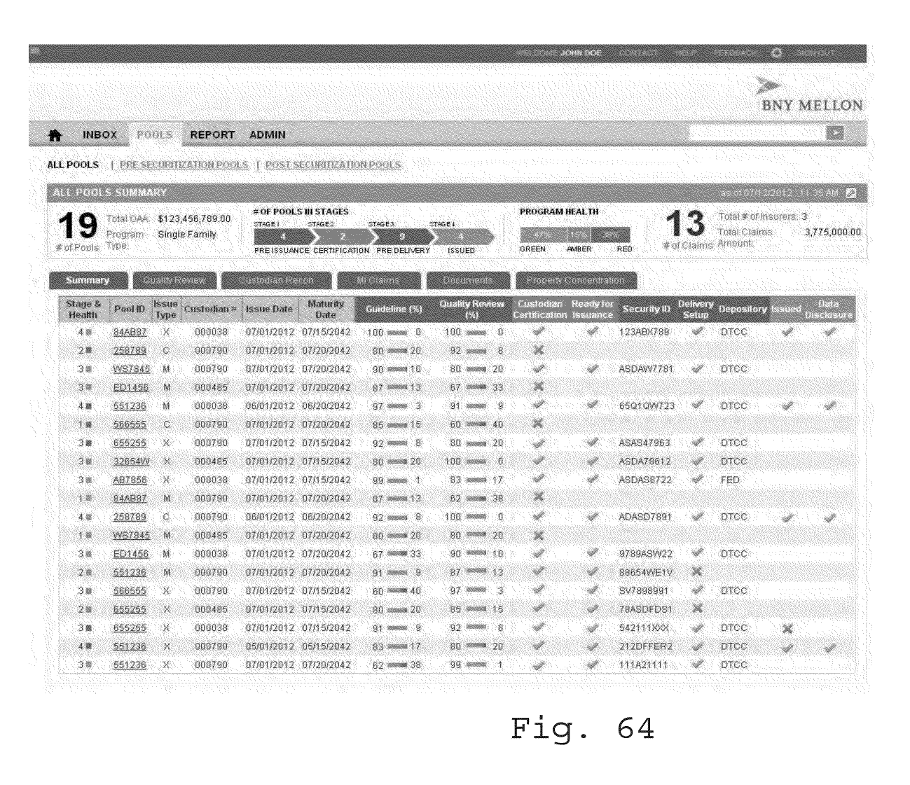

FIG. 64 illustrates a view of the utility for an agency issuer 260. As shown, the utility may list and detail the pools associated with the issuer 260 in a “pools” menu of the user interface. In an embodiment, information associated with each pool may be provided, including but not limited to a health/stage classification, and other associated data analytics. For example, in an embodiment, the stage may range from pre-issuance, to certification, to pre-delivery, to issued, while a health indicator may range from green to amber to red in terms of decreasing health. The health may be computed from a number of associated factors, including, but not limited to status of certification of the custodian 240, and the results of a quality review. As shown, in some embodiments summary information may be provided, including for example, aggregating the number of pools in each stage, and the percentage of pools having a given health. In some embodiments, the type of pool may be limited. For example, while FIG. 64 shows all pools, it may be appreciated therein that the pools may be limited in terms of analytics to pre-securitization pools or post-securitization pools. As further shown in FIG. 64, where the pools menu is for an agency issuer 260, claims information, as well as other advanced details, are depicted, which might be superfluous or unnecessary for other issuers 260.

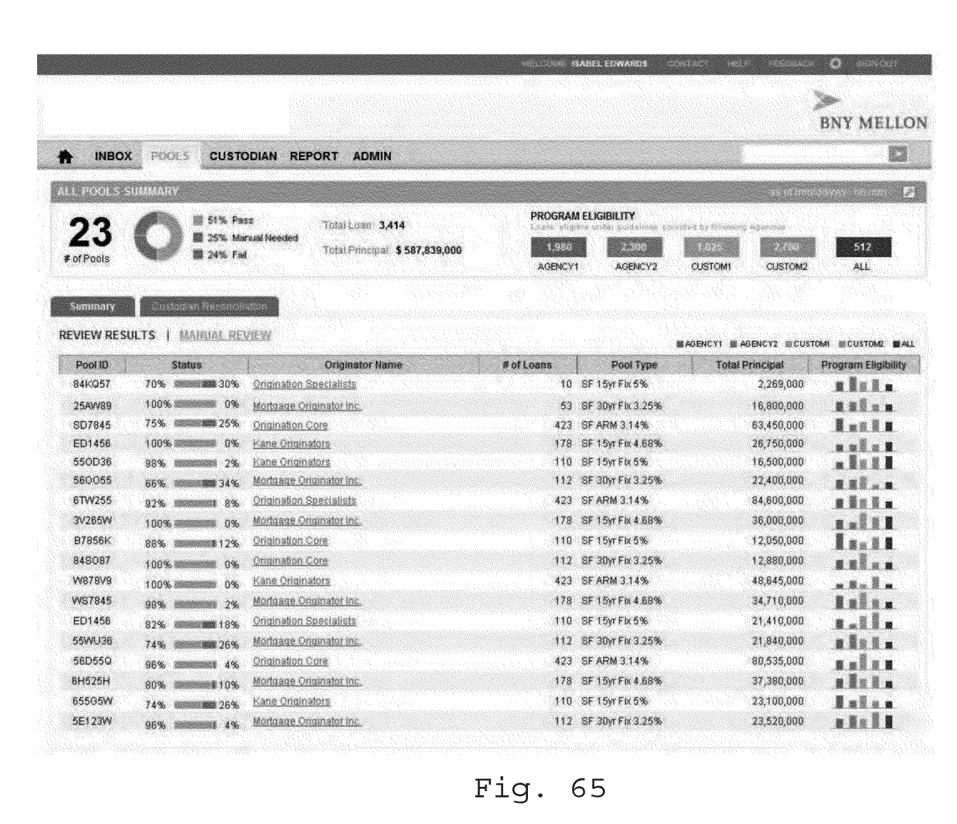

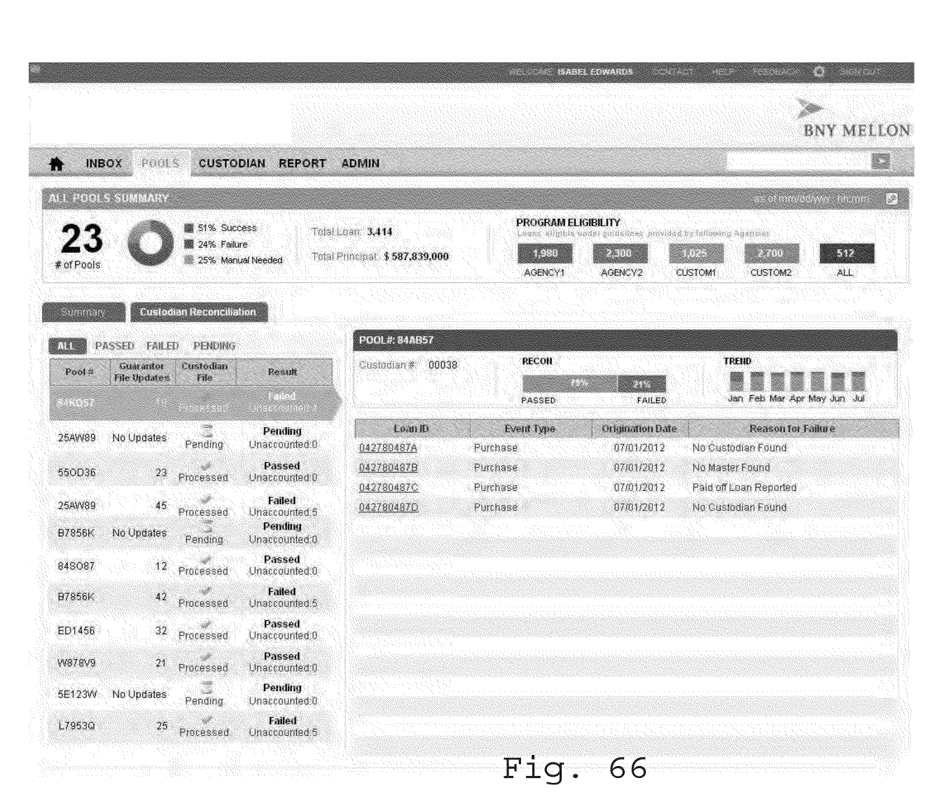

As an example, FIG. 65 illustrates an embodiment of a simpler pools menu for such other issuer 260. As shown, the pools may be summarized with details associated with the loan originators, the number of loans associated therewith, the type of loan (e.g., fixed or adjustable rate mortgage, with a term and interest rate), and the originator's loans' eligibility under agency guidelines. As shown, the success or failure of custodian reconciliation of the pools may be summarized, on the pools menu, as well as an indication of manual intervention desired for such reconciliation. In an embodiment, a custodian reconciliation menu may display the pools in a manner to facilitate reconciliation of the location of the note with the custodians 240. For example, as depicted in FIG. 66, selection of “custodian reconciliation” may depict the loans in the pool, and whether the loans therein have passed reconciliation or failed. Reasons for failure may be depicted. For example, in the view of FIG. 66, the failed loans have reasons for failure such as no custodian being found, no master being found, and the loan being reported as being paid off. In an embodiment, trend information regarding the reconciliation success is shown by month. In an embodiment, the issuer 260 may select each failed loan, to provide details to assist in reconciliation thereof.

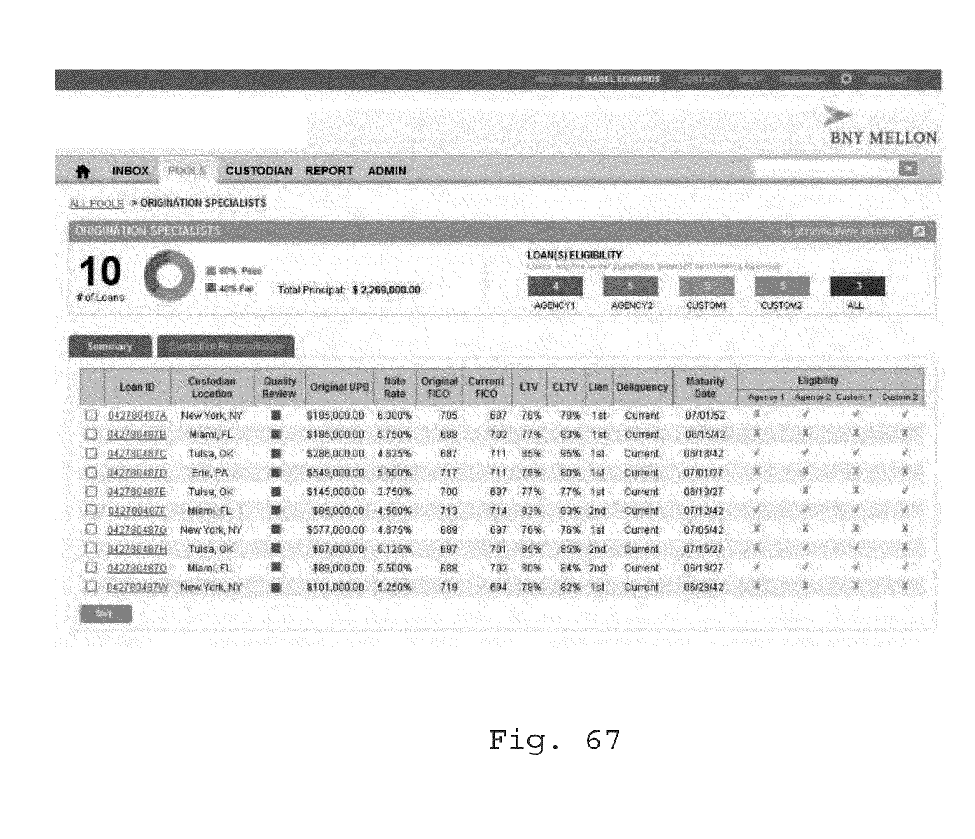

As shown in FIG. 67, in an embodiment selecting a particular originator may provide details of loans specific to that originator. For example, such a view may be accessed by selecting an originator name for a particular pool from the pools summary menu depicted in FIG. 65. In an embodiment, selecting the pool may illustrate details regarding the loans therein, including but not limited to information regarding the amount borrowed, interest rate, the original and current computed credit rating (e.g., FICO score), loan to value, lien number, whether the loan is delinquent, and so on. As shown, eligibility under guidelines provided for number of agencies may be illustrated. Additionally, in an embodiment the number of loans that pass or fail reconciliation may be summarized (e.g., with a 60% pass rate in the exemplary view of FIG. 67).

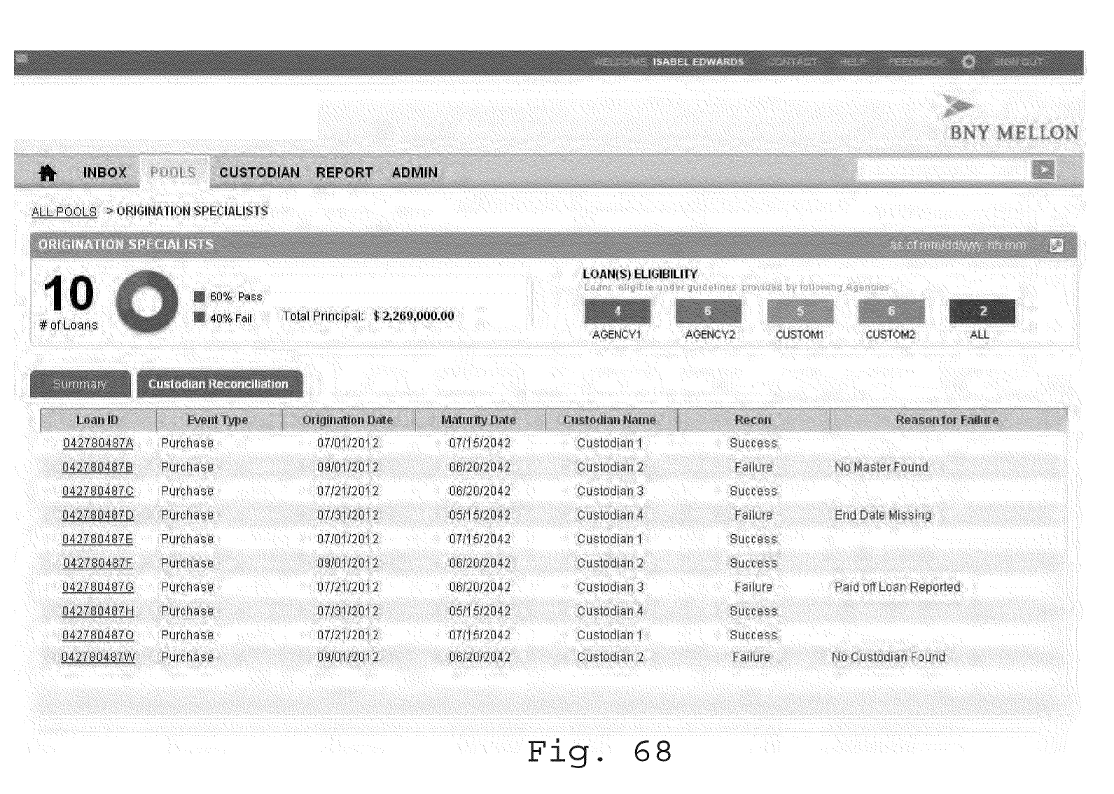

By selecting “custodian reconciliation” in the illustrated embodiment, the loans may be detailed in a manner that facilitates identifying the reason for failure, as shown in the embodiment of FIG. 68. For example, in the illustrated embodiment, where there is a 60% pass rate for the ten loans associated with the selected pool, those four loans that have failed are listed as having failure reasons such as no master found, end date missing, loan paid off, and no custodian found. These failure reasons are merely exemplary, and other failure reasons are possible. As shown, for custodian reconciliation, the loan ID, associated custodian name, and location may be concurrently listed. In an embodiment, the issuer 260 may select each failed loan, to provide details to assist in reconciliation thereof.

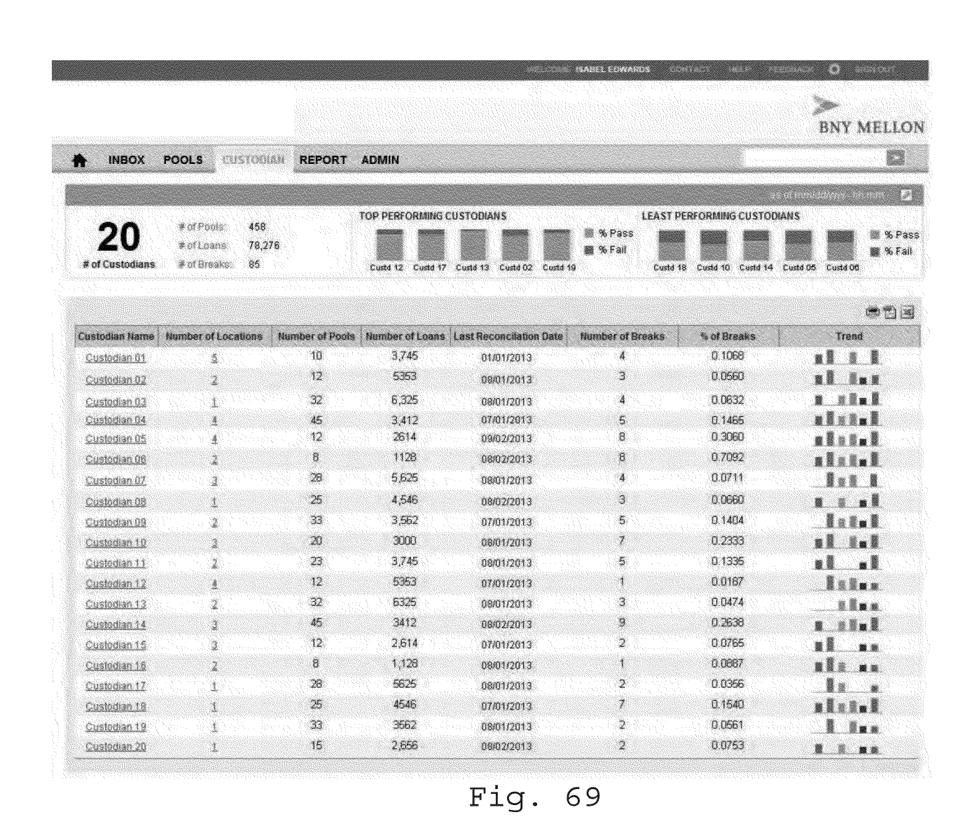

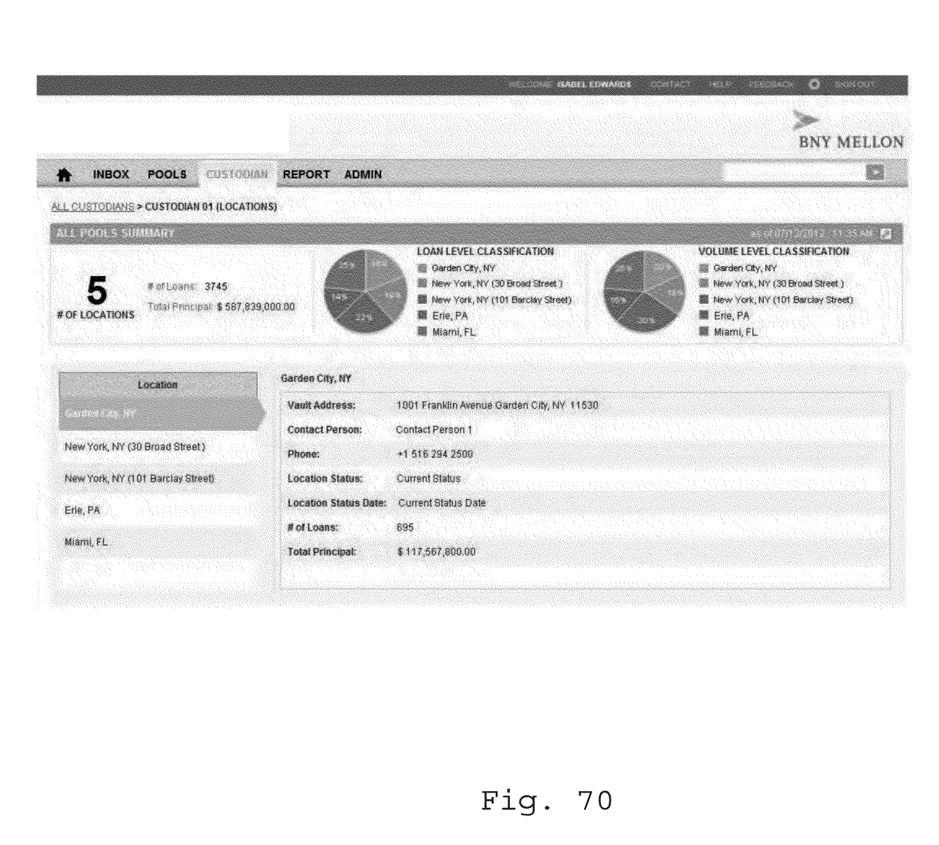

FIG. 69 depicts an exemplary view summarizing custodians 240 associated with the issuer 260. As shown, the number of pools, locations, loans, and breaks associated with each custodian may be summarized. Additionally, trend information associated with the custodians, as well as a ranking of top performing and least performing custodians based on percentage breaks may be summarized as well. In an embodiment, the issuer 260 may select a particular custodian 240 and view pools associated therewith (as illustrated in FIG. 70). In an embodiment, the pool information visible for a particular custodian 240 may be similar to that provided in the view of FIG. 66, however limited to the pools associated with that custodian, instead of all custodians. For example, the custodian view may detail the loan failures for a particular pool, and summarize a reason for the failure. By selecting the particular loan that has failed reconciliation, the issuer 260 may provide details to assist with and potentially repair the reconciliation of the loan to the custodian. As shown in the embodiment of FIG. 70, in some embodiments the pool information for a particular custodian 240 may show the number of locations associated with that custodian, and include contact information for that custodian 240 at each of a plurality of locations. Other information, including but not limited to the vault address, phone number, number of loans thereat, and total principal may be additionally or alternatively provided. In an embodiment, a summary of the custodian may include a total number of loans across locations, a total principal across locations, and/or classification data associated therewith. For example, in various embodiments, the percentage of loans at each location and/or the volume (e.g. of principal) at each location may be depicted.

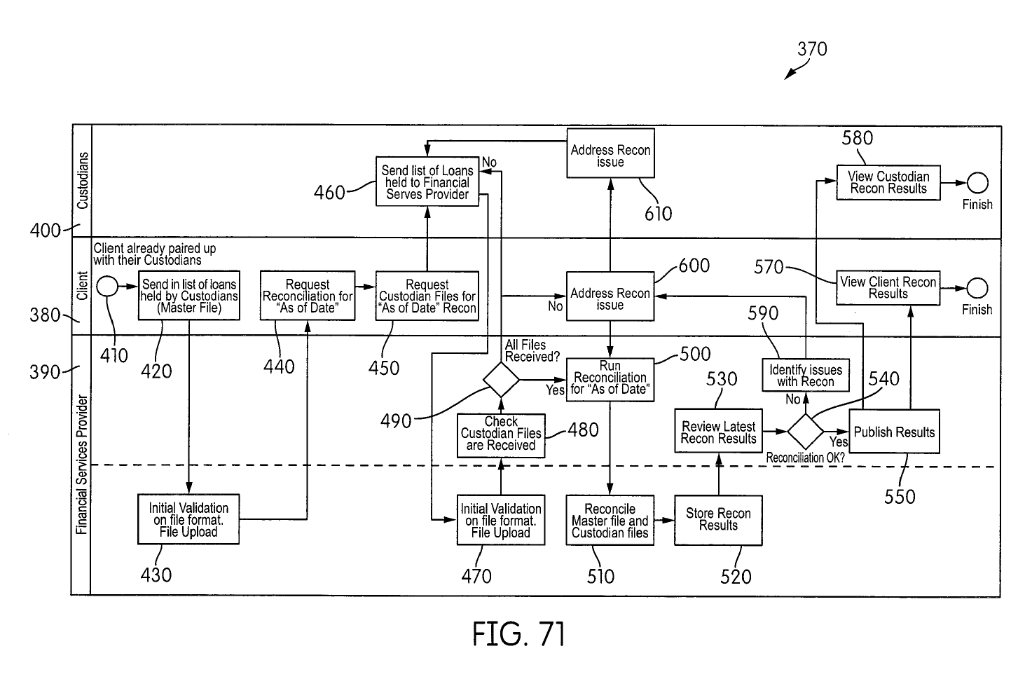

As indicated above, in an embodiment the utility may be configured to support the tracking of collateral for the issuers 260. Such tracking may be characterized as note tracking in some embodiments. While various user interfaces associated therewith have been described, it may be appreciated that such interfaces may direct a system, such as a computer system comprising one or more physical computer processors, to implement methods associated with the note tracking. FIG. 71 illustrates an embodiment of a method 370 for tracking loan data on behalf of a client 380. It may be appreciated that in an embodiment the client 380 may be any appropriate client of a financial services provider 390. In an embodiment, the client 380 may be one or more of the borrowers 110, the investors 230, or so on, as described above. For example, in some embodiments the client may be any aggregator of loans for securitization (including private label and government sponsored enterprises), servicer acquiring Mortgage Servicing Rights, owners, or investors. In an embodiment, the client 380 is a party owning an asset (e.g., the note/loan that may be tracked) managed by the financial services provider 390. In an embodiment, the asset is in the custody of a custodian 400. In some embodiments, the custodian 400 may be part of or otherwise associated with the financial services provider 390, while in other embodiments the custodian 400 may be independent from the financial services provider 390 (e.g., independently owned/managed). It may be appreciated that in an embodiment, the custodian 400 may be the custodian 240 as described above.

As indicated at 410 in FIG. 71, in an embodiment the client 390 may be paired with one or more custodians 400. Such pairing may be selected by the clients 380 and/or the custodians 400, or may be designated by the financial services provider 390. At 420 of method 370, the client 380 may send a list of loans held by the custodians 400 to the financial services provider 390. In an embodiment, this initial list of loans held by one or more custodians 400 may be considered an initial master file. The initial list may comprise records in the system of the client 380 along with the identity of the custodians 400 assigned to the loans. In an embodiment, the file may include one or more of the loan number, the custodian name, and the custodian identifier (e.g., custodian ID). In an embodiment, the client may also provide periodic transaction files with updates on the loans, such as new purchases, transfers, and/or terminations. In an embodiment, the files may be transferred from the client 380 to the financial services provider 390 by a secured file transfer protocol.

As shown at 430, in an embodiment the financial services provider 390 may perform an initial validation on the file format, which may ensure that the file is compatible with the system. In an embodiment, the system at the financial services provider 390 may be a note tracking system configured to track the location of a note, provide reconciliation functions and/or provide reporting functions. In an embodiment, the system of the financial services provider 390 may allow for uploading or receipt of the file once initial validation is complete. In an embodiment, the system at the financial services provider 390 may become a system of record for the client 380. It may be appreciated that in an embodiment, initial and ongoing records from the master client 380 may be loaded into a master tables database at the financial services provider 390.

In some embodiments, method 370 may continue at 440 with the client requesting reconciliation for a particular “as of” date, which may be received at the financial services provider 390. In an embodiment, the request (e.g., made on a first date) may be for a reconciliation report of the collateral of the client 380 as of a particular date (e.g., a second date) due to the client on a due date (e.g., a third date). It may be appreciated that the first, second, and third dates may be the same dates or different dates in various embodiments. It may be appreciated that the request may be sent to the custodians 400 requesting a list of the loans being held by the custodians 400 on behalf of the client 380. The request may be made by the client 380 to the custodians 400 directly, or may be made via the financial services provider 390. In an embodiment the request may include the as of date as well as the due date of the file. In an embodiment, the request may be made by electronic message, including but not limited to e-mail. In an embodiment, such an e-mail or other electronic message may be configured to be parsed by the custodians 400.

Once the request is received by the custodians 400, method 370 may continue at 460 with the custodians 400 sending a list of loans held associated with the client 380 to the financial services provider 390. In an embodiment, the financial services provider 390 may receive the list as a file via a secured file transfer protocol. In an embodiment, the file or subsequent files may contain custodian data such as a loan identifier. In an embodiment, the financial services provider 390 may receive ongoing feeds from the custodians 400 which may be loaded into a custodian table database (e.g., at a system of the financial services provider 390).

In an embodiment, the files from the custodian 400 may be run through an initial validation of the file format (e.g., prior to uploading/transfer of the files), as indicated at 470. In an embodiment, when the initial validation that the file format is acceptable is complete, the file may be uploaded to the system of the financial services provider 390 (e.g., the NTS system as described above). Following the upload, the system of the financial services provider 390 may check, at 480 that all appropriate custodian files have been received. If it is then determined, at 490, that all files have been received, then method 370 may proceed at 500 by running a reconciliation for the “as of” date in the files. In an embodiment, the reconciliation may run over night. In particular, as shown at 510, the data of the master file list of loans held by the custodians sent by the client 380 at 420 and received at 430 may be reconciled with the custodian files held by the custodians 400 that are sent to the financial services provider 390 at 460 and received at 470. In an embodiment, the reconciliation of specific loans (identified by identification number, for example) against expected custodians shows if the loan is present as expected, or if a break has occurred (e.g., where the loan is not found with the expected custodian). In an embodiment, matching to custodians in total may turn out loans that custodians are holding that do not have a match on the master client file. In an embodiment, if there is a matching of loan numbers, but at a different custodian than expected, a match across those discrepancies may be made to highlight instances where movement of collateral was not correctly captured by the client (e.g., loan ID matched, but incorrect custodian). Other types of matching are also possible in other embodiments. In an embodiment, the reconciliation at 510 may include loans additional to those in the master file, which may be reconciled against the custodian files. Such additional loans may be sent from the client 380, and may include new purchases, which may be added to the initial master file.

In an embodiment, the results of the reconciliation at 510 may be stored, at 520, within a database at the financial services provider 390. In an embodiment, each of the reconciliations may be listed as associated with both the client 380 and the custodians 400. It may be appreciated that the date of the reconciliation may additionally be recorded in the database. In an embodiment, the system of the financial services provider 390 may be configured to make available to the client 380 a certain amount of months of data (e.g., historical data, which may be located in a historical database). In an embodiment, older reports may be archived by the financial services provider 390 and may be selectively requested by the client 380.

In an embodiment, the financial services provider 390 may review the results of reconciliation at 530, to verify that the reconciliation at 510 was processed correctly without errors. Such verification may include, for example, determining if all custodians are listed, if the numbers sum to what was expected, and if data is not missing from the file. In an embodiment, if the reconciliation was run properly, as determined at 540, then method 370 may proceed at 550 with the financial services provider 390 publishing the results of the reconciliation. In an embodiment, the results of the reconciliation published at 550 may be viewed by one or more of the client 380 and the custodians 400. As shown in FIG. 71, the client 380 may view client reconciliation results at 570, while the custodians 400 may view custodian reconciliation results at 580, as described in greater detail below. In an embodiment, if it is determined at 540 that there are errors in the reconciliation, as indicated at 590, then the financial services provider 390 may identify those issues that exist in the reconciliation. In an embodiment, if the issues pertain to client files received from the client 380, then the financial services provider 390 may address the reconciliation issues with the client, as indicated at 600. In an embodiment, specific problems may be communicated to the client, or may be displayed for manual action. For example, in an embodiment, an e-mail exchange or telephonic contact may be prompted, between a user at the financial services provider 390 and a user at the client. In an embodiment, an electronic request for an alternate file (e.g., data file) may additionally or alternatively be transmitted. Once the client-associated issues are addressed and cleared, method 370 may return to 500, where the reconciliation is re-processed for the “as of” date. In an embodiment, if the reconciliation issues pertain to custodian files received from the custodian 400, then the financial services provider 390 may address those issues with the particular custodian 400, or custodians 400, as indicated at 610. In an embodiment, specific problems may be communicated to the custodian, or may be displayed for manual action. For example, in an embodiment, an e-mail exchange or telephonic contact may be prompted, between a user at the financial services provider 390 and a user at the custodian. In an embodiment, an electronic request for an alternate file (e.g., data file) may additionally or alternatively be transmitted. Once the custodian-associated issues are addressed and cleared, method 370 may return to 460, where the list of loans held by the custodian(s) 400 may be transmitted to the financial services provider 390. It may similarly be appreciated, with reference to the determination of receipt of custodian files at 490, that all files have not been received, method 370 may also return to 460, with the custodians 400 continuing to send the list of loans held to the financial services provider 390 (e.g., responsive to further requests thereof). Reconciliations may be re-processed for an as of date due to additional custodian files being received, or correction files to resolve identified issues. In an embodiment, those reports may override prior reports available on the graphical user interface, however historical reports may be reproduced if required (e.g., may be stored in the database for retrieval). It may be appreciated that in an embodiment the method 370 may allow for reconciliation to be run at a point in time, at the due date prior to all custodian files being received, and may be run again at a later point in time for the same “as of” date if all custodian files are received and the client wishes to run the process to capture the full portfolio. In an embodiment, a system running the method 370 may track when each custodian file was received, and run the reconciliation at the cutoff date. In an embodiment, if files are received after the cutoff date and the client wishes to process the request to capture the additional files, then the administrator may run a re-reconciliation.

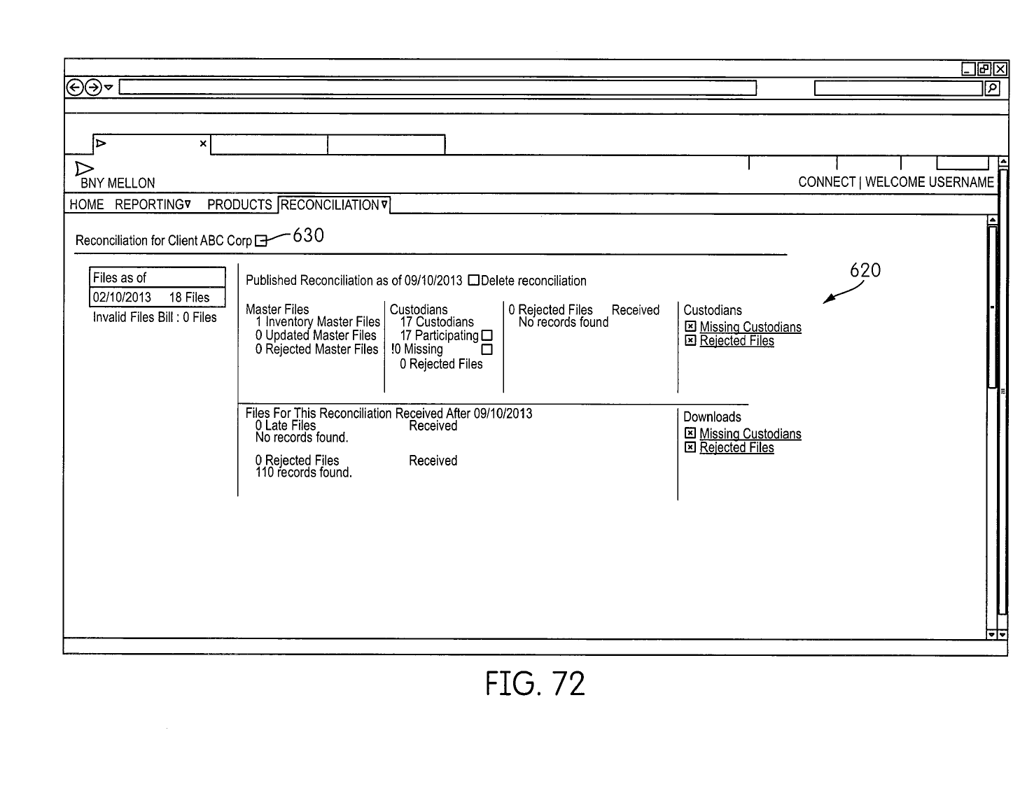

FIGS. 72-74B illustrate various views of a graphical user interface associated with embodiments of method 370. In particular, it may be appreciated that method 370 may be generally performed on one or more physical computer processors of a system at the financial services provider 390. Accordingly, it may be appreciated that steps associated with the client 380 or the custodians 400 may be facilitated by the financial services provider 390, including but not limited to the financial services provider 390 providing an interface configured to receive information or other inputs from one or more of the client 380 and the custodian(s) 400.

FIG. 72 illustrates an administrator screen 620 associated with an administrator user (e.g., at the financial services provider 400). In an embodiment, such a user may view published reconciliation, may delete one or more reconciliations, and may have access to the files received from the client 380 (e.g., at 430 of method 370) and/or from the custodian 400 (e.g., at 470 of method 370). In an embodiment, an administrator user may be able to view a list of missing custodians and rejected files (e.g., files rejected due to having an incorrect file format, as determined at 430 or 470, for example). In an embodiment, an administrator user may utilize an interface such as that of FIG. 72 to perform steps 480-610 of method 370. In an embodiment, the user interface may be configured so that an administrator user may select a client account that they which to review (e.g., by selecting a client from a list of clients, searching for a client, or so on). For example, in an embodiment, selecting a client indicator 630 may present the ability to change the associated client account that the administrator is accessing and able to administer.

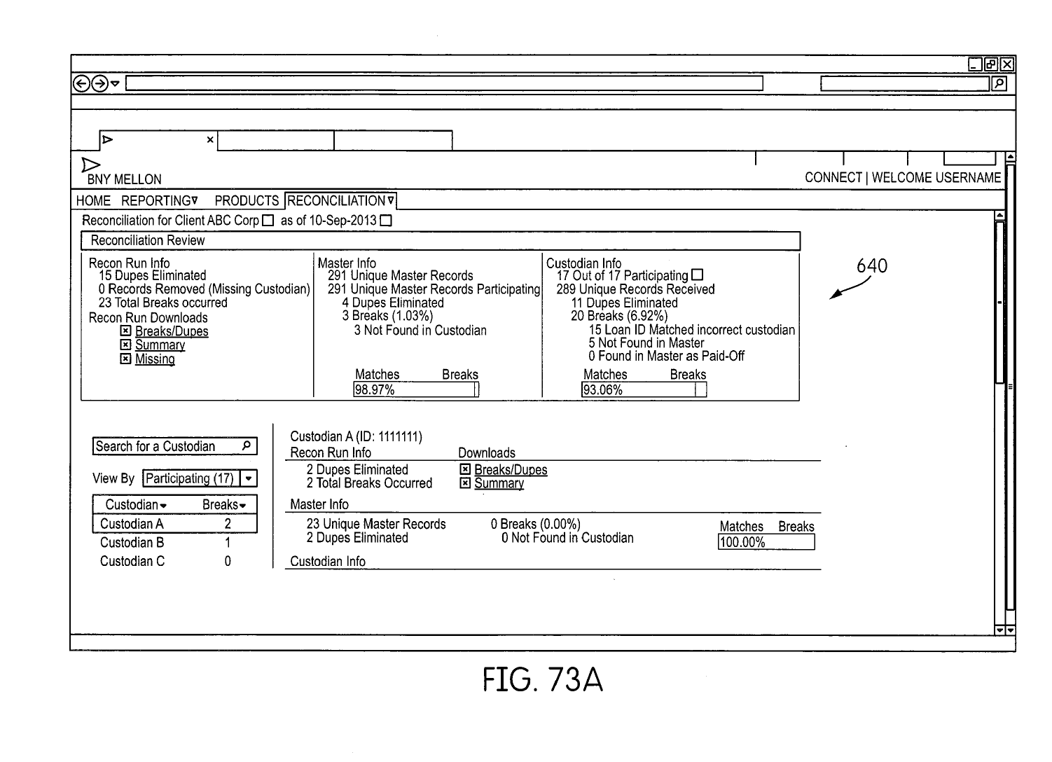

FIGS. 73A-B illustrate an embodiment of a graphical user interface 640 that may be provided by the financial services provider 390 to a client user, such as a user at the client 380. In an embodiment, the graphical user interface 640 may be configured so that the client user may review their reconciliation results for any reconciliation period. For example, the client user may select a date (e.g., by selecting the wrench next to the “as of” date in FIG. 73A), and then review a report associated therewith. In an embodiment, the client user may review details of the report as illustrated, and in an embodiment may export the data to their own system (e.g., exporting into a spreadsheet format). In an embodiment, the client user may view reconciliation results by custodian (such as custodians 400), as illustrated in FIG. 73B.

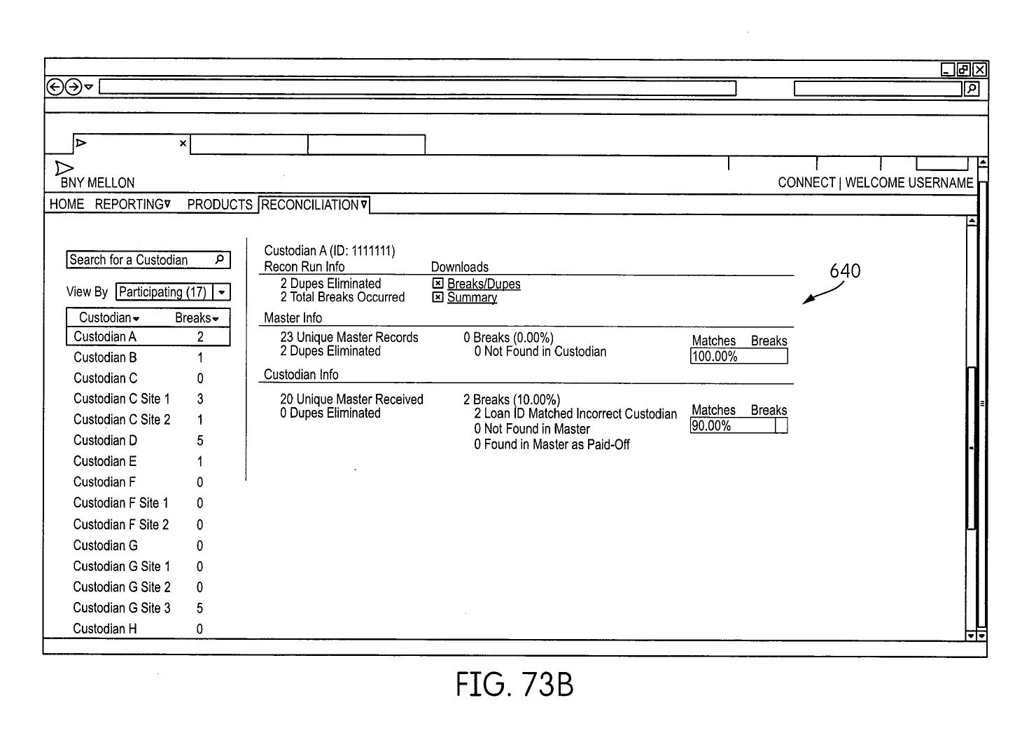

FIGS. 74A-B illustrate an embodiment of a graphical user interface 650 that may be provided by the financial services provider 390 to a custodian user, such as users at one or more of the custodians 400. In an embodiment, the graphical user interface 650 may be configured so that the custodian user may review their reconciliation results based on a selected client (e.g., the client 380). It may be appreciated that in an embodiment, if a custodian has more than one location, the custodian nay be able to see a breakdown of reconciliations by each location.

Those skilled in the art will appreciate that the embodiments described herein can be implemented using a server, computer, database, communications and programming technology, each of which implements hardware or software or any combination thereof. Embodiments of this disclosure may be implemented in the form of a computer program product on a computer-readable storage medium having computer-readable program code means embodied in any suitable computer-readable storage medium, including hard disks, CD-ROM, RAM, ROM, optical storage devices, magnetic storage devices, and/or the like.

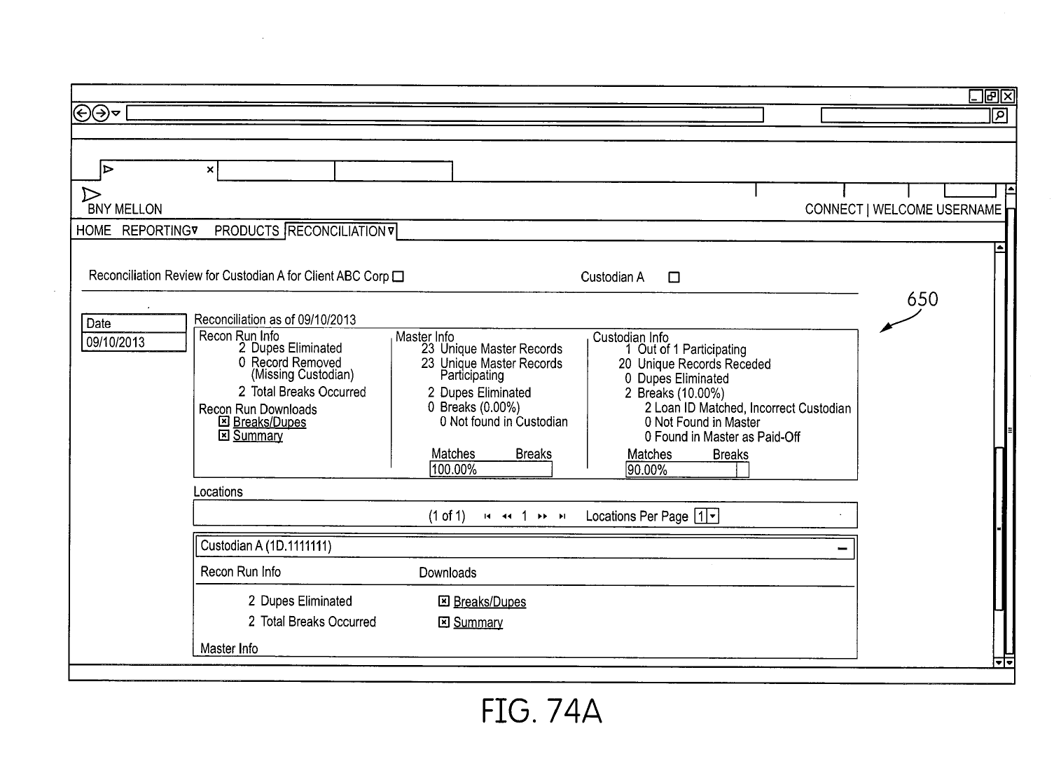

For example, FIG. 75 illustrates a high level block diagram of an exemplary computer system 660 which may be used to perform embodiments of the processes disclosed herein, including but not limited to process 370. It may be appreciated that in some embodiments, the system performing the processes herein may include some or all of the computer system 660. In some embodiments, the computer system 660 may be linked to or otherwise associated with other computer systems 660. In an embodiment the computer system 660 has a case 670, enclosing a main board 680. The main board has a system bus 690, connection ports 700, a processing unit, such as Central Processing Unit (CPU) 710, and a data storage device, such as main memory 720, storage drive 730, and optical drive 740. Each of main memory 720, storage drive 730, and optical drive 740 may be of any appropriate construction or configuration. For example, in some embodiments storage drive 730 may comprise a spinning hard disk drive, or may comprise a solid-state drive. Additionally, optical drive 740 may comprise a CD drive, a DVD drive, a Blu-ray drive, or any other appropriate optical medium.

Memory bus 750 couples main memory 720 to CPU 710. A system bus 790 couples storage drive 730, optical drive 740, and connection ports 700 to CPU 710. Multiple input devices may be provided, such as for example a mouse 760 and keyboard 770. Multiple output devices may also be provided, such as for example a video monitor 780 and a printer (not shown). In an embodiment, such output devices may be configured to display information regarding the processes disclosed herein, including but not limited to cash amounts, trade details, and so on. It may be appreciated that the input devices and output devices may alternatively be local to the case 670 and the computer system 660, or may be located remotely (e.g., interfacing with the computer system 660 through a network or other remote connection).

Computer system 660 may be a commercially available system, or may be proprietary design. In some embodiments, the computer system 660 may be a desktop workstation unit, and may be provided by any appropriate computer system provider. In some embodiments, computer system 660 comprise a networked computer system, wherein memory storage components such as storage drive 730, additional CPUs 710 and output devices such as printers are provided by physically separate computer systems commonly tied together in the network. Those skilled in the art will understand and appreciate the physical composition of components and component interconnections comprising computer system 660, and select a computer system 660 suitable for performing the methods disclosed herein.

When computer system 660 is activated, preferably an operating system 790 will load into main memory 720 as part of the boot sequence, and ready the computer system 660 for operation. At the simplest level, and in the most general sense, the tasks of an operating system fall into specific categories—process management, device management (including application and user interface management) and memory management.

In such a computer system 660, the CPU 710 is operable to perform one or more embodiments of the methods described above. Those skilled in the art will understand that a computer-readable medium 800 on which is a computer program 810 for performing the methods disclosed herein may be provided to the computer system 660. The form of the medium 800 and language of the program 810 are understood to be appropriate for computer system 660. Utilizing the memory stores, such as one or more storage drives 730 and main system memory 720, the operable CPU 710 will read the instructions provided by the computer program 810 and operate to perform the methods disclosed herein, such as process 370.

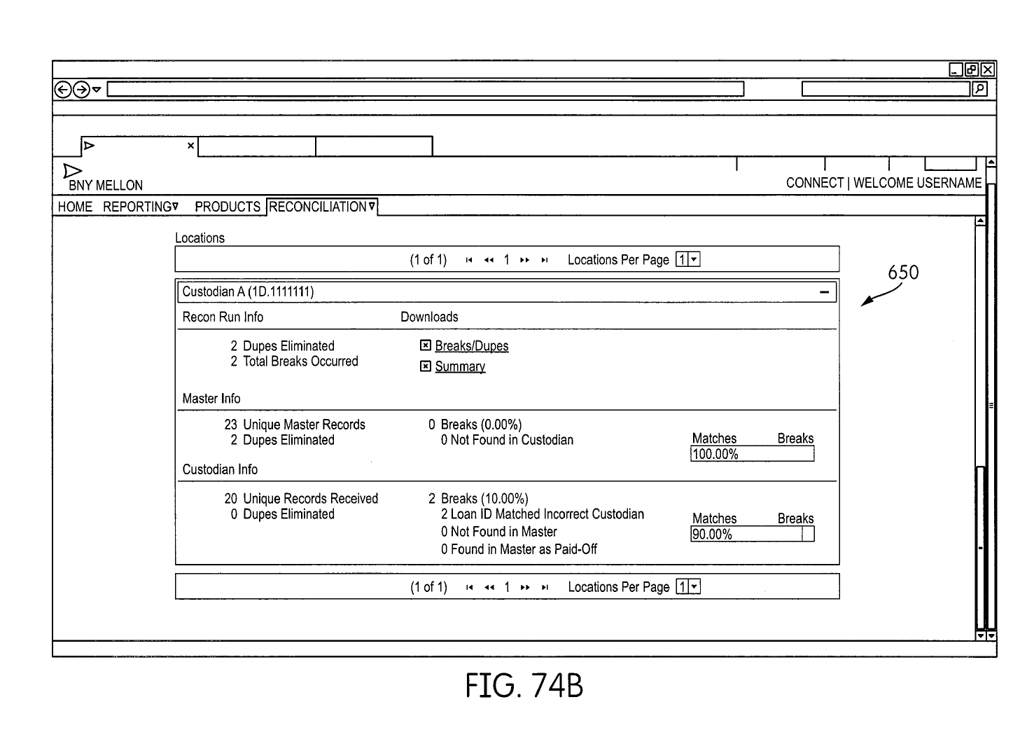

As shown in FIG. 76, in some embodiments the CPU 710 (either alone or in conjunction with additional CPUs 710) may be configured to execute one or more computer program modules 820, each configured to perform one or more functions of the processes described herein. For example, in the illustrated embodiment, at a CPU 710 operated by the financial services provider 390, a computer program module 820a may be configured to receive from the client 380 first loan data 830. In an embodiment, the first loan data 830 may include therein custodian information identifying one or more custodians 400 associated with one or more loans of the client 380. In an embodiment, the computer program module 820a may be configured to store the first loan data 830 in a database 840 associated with the storage drive 730. It may be appreciated that the storage drive 730 may be linked with the memory 720, and may be treated analogously depending on whether data is being retrieved or is being manipulated by the one or more physical computer processors 710. In an embodiment, the storage drive 730 may be linked to the CPU 710 via the system bus 690, through an internal or external network, or any other appropriate data link.

In an embodiment, one or more of the computer program modules 820 (e.g., the computer program module 820a) may be configured to receive a request from the client 380 to reconcile loan data. In an embodiment, the request may include a designated date as of which the loan data may be reconciled. It may be appreciated that in an embodiment the request may be received with the loan data 830, or may be received through a graphical user interface provided by the one or more physical computer processors 710.

In an embodiment, one or more of the computer program modules 820 (e.g., the computer program module 820a) may also be configured to receive loan data 850 from one or more custodians 400. For example, in the illustrated embodiment, the computer program module 820a is configured to receive loan data 850a from custodian 400a, and loan data 850b from custodian 400b. In an embodiment where the loan data 830 includes a custodian identifier, the custodian identifier may be used to select one of the loan data 850a and the loan data 850b, from the custodian 400a or the custodian 400b respectively. In an embodiment, the loan data 850 received from the custodians 400 may identify one or more loans associated with the client 380. In an embodiment, the loan data 850 received may also be associated with the designated date. It may be appreciated that in an embodiment the financial services provider 390 (e.g., via the computer program module 820a) may request the loan data 850 from the custodians 400 based on the request and/or loan data 830 received from the client 380. In an embodiment, the loan data 850 may also be recorded to the database 840.

As shown in FIG. 76, one or more of the computer program modules 820 may be configured to execute on the one or more physical computer processors 710 one or more computer program modules (e.g., computer program module 820b in the illustrated embodiment) configured to compare the loan data 830 and the loan data 850 received from the client 380 and the custodians 400 respectively. Such a comparison may be across custodians 40 to provide a holistic view of the portfolio of the client 380. In an embodiment, the computer program module 820b may be configured to identify discrepancies in the loan data 830 and the loan data 850. For example, where the loan data 830 indicates a loan being in the custody of custodian 400a, but that is not reflected in the loan data 850a received from the custodian 400a, such a discrepancy may be logged. In an embodiment, the comparing may comprise determining that each loan is accounted for. For example, some loans may be stated as being in the custody of the custodian 400, but may be listed as paid off by the client 380. In an embodiment, the discrepancy may be understood as a lack of a reciprocal acknowledgement of association of a loan between client 380 and custodian 400. In an embodiment, the computer program module 820b, or another computer program module 820, may match loan data across custodians to identify discrepancies within various vault/custody locations of the custodians. In an embodiment where multiple custodians 400 associated with the client 380 are queried with regard to their respective loan data 850, if the loan data 830 is identified as being associated with another custodian 400, then the association with that custodian 400 may be identified as well.

In an embodiment, one or more computer program modules 820, such as computer program module 820c in the illustrated embodiment, may be configured to transmit, via the one or more physical computer processors 710, one or more of a result of the comparing and an identified discrepancy from the comparing to one or more of the client 380 and the custodians 400. For example, as shown in the illustrated embodiment, client 380 has associated therewith an interface 860, which may be linked to an electronic display at the client 380, which may receive the result of the comparing and/or an identified discrepancy. Similarly, the custodians 400 may each have associated interfaces 870 (individually interface 870a and interface 870b for custodian 400a and custodian 400b respectively). It may be appreciated that the format configured for display may be any appropriate graphical or text format which may be interpreted by the interfaces 860 or 870 for displaying on the electronic display. For example, in one non-limiting embodiment, the format may comprise mark-up language (e.g., HTML or XML) and/or image files, which may be viewed via a web browser. Other formats, including but not limited to electronic document formats, may additionally or alternatively be provided, or may be made available for access by users at the client 380 or the custodians 400.

As shown in the illustrated embodiment, a network 880 may link the financial services provider 390, the client 380, and/or the custodians 400. In an embodiment, the network 880 may link individual systems and components within each of the financial services provider 390, the client 380, and/or the custodians 400. For example, where the financial services provider 390 comprises a plurality of processors 710, each of the processors 710 may be linked by the network 880. It may be appreciated that in an embodiment the network 880 may comprise internal network components and external network components, which may be linked to one another to form the network 880.

In an embodiment, any of the computer program modules 820 may be interfaced directly with the other computer program module 820. For example, while computer program module 820c configured to generate the output to the custodians 400 and the client 380 is shown as coupled to the computer program module 820a via the computer program module 820b, each of the computer program modules 820 may be linked to one another directly. Similarly, each of the computer program modules 820 may be linked to components of the computer system 660, including for example, the storage 730 and/or the memory. In effect, in an embodiment, a plurality of modules 820, operating over one or more CPUs 710, may cooperate with one another to perform the methods described herein.

Various embodiments herein are described as including a particular feature, structure, or characteristic, but every aspect or embodiment may not necessarily include the particular feature, structure, or characteristic. Further, when a particular feature, structure, or characteristic is described in connection with an embodiment, it will be understood that such feature, structure, or characteristic may be included in connection with other embodiments, whether or not explicitly described. Thus, various changes and modifications may be made to this disclosure without departing from the scope or spirit of the inventive concept described herein. As such, the specification and drawings should be regarded as examples only, and the scope of the inventive concept to be determined solely by the appended claims.

What we claim is:

1. A computer-implemented method of tracking loans on behalf of a client of a financial services provider, the method being implemented in a computer system of the financial services provider comprising one or more physical computer processors configured to execute one or more computer program modules, the method comprising:
storing, in a database associated with a memory device, first loan data, the first loan data being received from the client and comprising custodian information identifying one or more custodians associated with a loan of the client;
receiving, via the one or more physical computer processors, a request from the client to reconcile loan data as of a designated date;
storing, in the database associated with the memory device, second loan data, the second loan data being received from the one or more custodians and identifying one or more loans associated with the client and the designated date;
comparing, via the one or more physical computer processors, the first loan data and the second loan data, and identifying, via the one or more physical computer processors, any discrepancies from the comparing; and
transmitting, via the one or more physical computer processors, in a format configured for displaying on an electronic display of one or more of the client and the one or more custodians, one or more of a result of the comparing and an identified discrepancy from the comparing.

2. The method of claim 1, further comprising, prior to the comparing, and via the one or more physical computer processors, verifying that all second loan data to be received from the custodian has been received from the custodian.

3. The method of claim 2, further comprising, where not all second loan data has been received from the custodian at the time of the verifying, requesting additional second loan data from the custodian.

4. The method of claim 1, wherein the first loan data comprises a first loan identifier and a custodian identifier.

5. The method of claim 4, wherein the first loan data comprises a master file.

6. The method of claim 4, wherein the second loan data comprises a second loan identifier.

7. The method of claim 6, wherein comparing the first loan data and the second loan data comprises comparing, via the one or more physical computer processors, the first loan identifier received in the first loan data from the client with the second loan identifier received in the second loan data from the custodian, wherein the custodian is identified by the custodian identifier of the first loan data.

8. The method of claim 4, wherein the custodian identifier comprises one or more of a custodian name and a custodian identification number.

9. The method of claim 1, wherein the request from the client to reconcile the loan data as of the designated date further comprises a due date.

10. The method of claim 9, wherein the comparing is of first loan data and second loan data due by the due date.

11. A system for tracking loans on behalf of a client of a financial services provider, the system comprising one or more physical computer processors, at the financial services provider, the one or more physical computer processors configured to execute one or more computer program modules, the program modules being configured to:
store, in a database associated with a memory device, first loan data, the first loan data being received from the client and comprising custodian information identifying one or more custodians associated with a loan of the client;
receive, via the one or more physical computer processors, a request from the client to reconcile loan data as of a designated date;
store, in the database associated with the memory device, second loan data, the second loan data being received from the one or more custodians and identifying one or more loans associated with the client and the designated date;
execute on the one or more physical computer processors of the computer system, one or more computer modules configured to compare, via the one or more physical computer processors, the first loan data and the second loan data, and identify any discrepancies from the comparing; and
transmit, via the one or more physical computer processors, in a format configured for displaying on an electronic display of one or more of the client and the one or more custodians, one or more of a result of the comparing and an identified discrepancy from the comparing.

12. The system of claim 11, wherein the program modules are further configured to, prior to the comparing, and via the one or more physical computer processors, verify that all second loan data to be received from the custodian has been received from the custodian.

13. The system of claim 12, wherein the program modules are further configured to, where not all second loan data has been received from the custodian at the time of the verifying, request additional second loan data from the custodian.

14. The system of claim 11, wherein the first loan data comprises a first loan identifier and a custodian identifier.

15. The system of claim 14, wherein the first loan data comprises a master file.

16. The system of claim 14, wherein the second loan data comprises a second loan identifier.

17. The system of claim 16, wherein the one or more modules configured to compare the first loan data and the second loan data are configured to compare, via the one or more physical computer processors, the first loan identifier received in the first loan data from the client with the second loan identifier received in the second loan data from the custodian, wherein the custodian is identified by the custodian identifier of the first loan data.

18. The system of claim 14, wherein the custodian identifier comprises one or more of a custodian name and a custodian identification number.

19. The system of claim 11, wherein the request from the client to reconcile the loan data as of the designated date further comprises a due date.

20. The system of claim 19, wherein the one or more modules configured to compare the first loan data and the second loan data are configured to compare first loan data and second loan data of loans that are due by the due date.
